(19) United States
(12) Patent Application Publication
(10) Pub. No.: US 2026/0051022 A1
(43) Pub. Date: Feb. 19, 2026

(54) ARTIFICIAL INTELLEGENCE-BASED PROPERTY INFORMATION PROCESSING SYSTEM AND METHOD PINHOLE TRAINING

(71) Applicants: Nearmap US, Inc., Lehi, UT (US); Nearmap Australia Pty Ltd, Barangaroo NSW (AU)

(72) Inventors: Peter RICKWOOD, Barangaroo NSW (AU); Nagita Mehr SERESHT, Barangaroo NSW (AU); Adrian Stephen WILKINS-CARUANA, Barangaroo NSW (AU)

(73) Assignees: Nearmap US, Inc., Lehi, UT (US); Nearmap Australia Pty Ltd, Barangaroo NSW (AU)

(21) Appl. No.: 19/297,146

(22) Filed: Aug. 12, 2025

Related U.S. Application Data
(60) Provisional application No. 63/683,122, filed on Aug. 14, 2024.
(60) Provisional application No. 63/702,420, filed on Oct. 2, 2024.
(60) Provisional application No. 63/754,931, filed on Feb. 6, 2025.
(60) Provisional application No. 63/814,689, filed on May 30, 2025.
(60) Provisional application No. 63/837,973, filed on Jul. 3, 2025.

(51) Int. Cl. G06T 3/4046; G06N 3/045; G06N 3/0464; G06N 3/0895

(52) U.S. Cl. CPC G06T 3/4046; G06N 3/045; G06N 3/0464; G06N 3/0895

(57) ABSTRACT

A system and a method for generating semantic predictions corresponding to pixels of an input image by providing a first Convolutional Neural Network (CNN) and a second CNN, the first CNN having a selected sampling factor, s, and defining a mask that corresponds to a grid of pixels positioned s pixels apart from each other and centered on a single pixel of the grid of pixels, with an input image crop size based on the extent of the mask, and processing mage data shaped according to the input image crop to generate semantic predictions for pixels corresponding to the grid of pixel locations of the mask. The second CNN receives input image and generates semantic predictions for the input image that is at a higher pixel density than the mask.

### CROSS-REFERENCE TO RELATED APPLICATIONS

This patent application claims the benefit of U.S. Application 63/683,122 filed Aug. 14, 2024, U.S. Application 63/702,420 filed on Oct. 2, 2024, U.S. Application 63/754,931 filed on Feb. 6, 2025, U.S. Application 63/814,689, filed May 30, 2025, and U.S. Application 63/837,973 filed on Jul. 3, 2025, the entire contents of all of which are incorporated herein by reference.

### BACKGROUND

### 1. Field of the Disclosure

The present disclosure is related to retrieving and processing images. More particularly, the present disclosure is related to a system that utilizes Artificial Intelligence (AI) to automatically process retrieved from diverse data sources and generate AI attributes associated with the retrieved data.

### 2. Description of Related Art

Understanding a property's risk can be both costly and inaccurate. Traditionally, P&C insurers have depended on physical inspections to assess property risks and adjust claims. However, these inspections are expensive and time-consuming. This can lead to fewer inspections leading to overlooked risks, increased risks during renewal, and ultimately increased losses.

As different property risks escalate (e.g., risk of fire in the Western United States, risk of storm and water damage in the Southeast United States, risk of wind and hail damage in the Central United States, and the like) with changes in global climate conditions, exposure insurance companies face continues to increase. In some area of the Western United States, it is very difficult to even obtain fire insurance, and if it is obtainable, the cost is often prohibitive. Insurance companies often do not have a detailed understanding of individual properties individuals are seeking to insure and do not have the budget to employ the personnel needed to physically inspect each property on a regular basis. This lack of specific knowledge of a particular property coupled with large property losses in the geographic area of the property, incentivizes insurance companies to charge relatively high average rates to all property owners to offset the claims processed during the previous few years.

While insurance companies have increased their data collection efforts, these efforts have not resulted in or been focused on how to lower costs to the insured, but rather, have been focused on protecting insurance companies from losses. In other words, insurance companies have been collecting data to limit or eliminate properties from their portfolio that have an unacceptably high risk according to the company's evaluations.

Additionally, any information that the inspector collects is only a snapshot in time. As property conditions and characteristics change, property insights are quickly outdated. For properties on the insurance company's books, the only way to update the data is to send another inspector to perform additional inspections/surveys incurring escalated costs, which ultimately get passed on to policy holders.

In more recent years, aerial photography has been used to capture images that can be accessed and viewed remotely via a computer to assess a property. However, the diversity in data formatting has been a major issue as images are collected from many differing sources. Additionally, the processing load for processing numerous images of a property has been prohibitive, leading to lengthy processing delays as computers struggle to process these large data files, which have functionally made such systems impractical for certain commercial purposes. Still further, images can quickly become outdated providing an inaccurate view of the property later requiring the acquisition of additional imagery, which eats up additional processing resources.

The use of Artificial Intelligence (AI) can be leveraged to process images. However, many times systems face serious compatibility issues resulting in incoherent outputs. So, even if imagery is updated regularly and AI is utilized, such imagery can be difficult to analyze for a variety of reasons such as, property features being obscured (tree overhang), seasonal changes, difficulties in visually determining distances in an image, and the like.

Additionally, companies are increasingly looking for more comprehensive pictures of total property conditions with peril risk in an easy to use and understandable scoring system that is trustworthy and can be used by underwriters. Known systems neither provide for these needs, nor do they provide data that is fully customizable to a use case.

Accordingly, there is a need for a system and a method that overcomes, alleviates, and/or mitigates one or more of the aforementioned and other deleterious effects of prior art.

### SUMMARY

Accordingly, what is needed is a comprehensive system and a method for retrieving, processing, and analyzing aerial imagery of a property and other data that provides a user with a complete understanding of a current status of a property.

It is further desired to provide a system and a method that allows a user to obtain an up-to-date view of a property while simultaneously reducing the need for physical inspections of the property.

It is still further desired to provide a system and a method that retrieves image data obtained from a plurality of data sources in a plurality of formats and utilizes AI to generate AI attributes associated with the image data.

It is also desired to provide a system and a method that provides accurate and enhanced information about a property including the type, location, size, and confidence score of each AI detection.

It is also desired to provide a system and method that allows for customization of AI process outputs and facilitates analysis of generated AI attributes associated with features in imagery.

In one configuration, a system and a method are provided that facilitates 1) retrieval of diverse image data, 2) the processing of the image data using algorithms to generate a plurality of AI attributes, and 3) analyzing the processed data to provide improved confidence of conditions of a property based on an analysis of the AI attributes and confidence scores generated by the system.

It should be noted that while the structure, function and operation of the system is described in connection with the insurance industry, there are numerous applications for the system including, for example, the construction industry, facilities maintenance, property management, and the like.

To achieve the above-described functionality, the system provides an AI-derived risk analysis based on high-resolution aerial imagery that is updated on a regular basis. In one configuration, 130 or more AI-derived attributes are provided to ensure a comprehensive risk assessment. These can include, for example, but are not limited to, vegetation overhangs, detailed roof condition(s), vulnerability scores (i.e., wildfire, hurricane, flood, hail, wind), as well as predictors for extreme weather. The AI detections are converted into a Roof Spotlight Index and peril scores for complete understanding of the current status of the property. AI-derived risk analysis allows for virtual inspection of a property that takes minutes instead of weeks.

In one configuration, all AI detections are pre-processed to support rapid delivery speed via Application Programming Interface (API). Pre-processed insights also increase the system's loading speed and overall efficiency. In a pre-processed configuration, the AI model is applied to the appropriate inputs (e.g., aerial imagery) over a large geographical area prior to a user requesting specific data using the system. The AI attributes, scores, and other outputs are stored on a suitable database or storage system and are accessible by the system.

Pre-processed data can provide quality checks, improving the quality and reliability of detections. Additionally, the system can respond much quicker to an inquiry as the time to query the system does not include the time to process the various inputs (images, and the like) to generate the AI data used by the system. Furthermore, it may be more efficient to run the AI models over larger regions and larger sets of attributes including classes, labels, and detections, resulting in cost savings. Internally there are raster and vector layers for each of the different classes, indicating where the class is present. The system then generates attributes for a vector object of a particular class. In one example, attributes for a single roof (may be merged vectors of roof layer) include area, condition, type, and the like. Scores are then calculated for “features”, which are linked vector objects (e.g., a set of vector objects from a single roof). Scores are then calculated for features using attributes, vector and raster layers (e.g., RSI (roof score) from roof vectors, raster layer and attributes).

When a survey is performed, it can include numerous properties that are captured in a single survey. The system can run arbitrary portions of a survey from a single property to the entire survey at once. This allows for reuse the data from partial surveys without recomputing the same area twice.

AI outputs may be used by multiple applications to give further cost savings such as the insurance use case. Conversely an on-demand system may utilize AI to generate the required AI attributes for a specified local area (e.g., one or more properties or an extended region including one or more properties). The on-demand system may access various inputs to the AI model from a database (which may have been normalized) and may then input them into the AI model. Such an on-demand system may be advantageous, for example in terms of cost, depending on the expected number and the geographic spatial extent of queries to the system and the number of different applications relying on the AI outputs. Hybrid configurations are also possible that make use of pre-processed AI attributes where they are available and generate on-demand attributes in other regions where they are not available. Such hybrid configurations may also be capable of storing the AI attributes that are generated in a database to complement existing pre-processed AI data and to reduce costs of re-computing the AI attributes for subsequent system requests or alternative applications directed at the same geographical region. Other systems may use some pre-processed attributes and combine these with on-demand attributes generated from various data that may include some pre-processed AI intermediate data or attributes.

Also provided is highlighting of the AI detections on the user interface, which informs a user of the type, location, and magnitude of issues. Also provided are confidence scores of the AI detections and scores, or UI highlights the AI attributes and layers, which can again inform users of the type, location, and magnitude of any issues.

The system provides for a range of flexible AI processes catered to various aspects of property risk assessment. This includes providing customizable AI programming that fits different use cases and workflows.

In summary, the specific constraints, challenges and opportunities that are solved by the proprietary deep learning AI model architecture and training methodology are:
Need to achieve cost efficiencies by having a single model for all classes of interest. Specifically, the semantic segmentation model at the core of the system includes 130+output layers providing large-scale execution benefits.
Maximizing performance and labelling efficiency of individual classes (layers), through information sharing in the same model.
Achieving the best possible trade-off between using the highest resolution imagery (5-7 cm/pixel) and having a context of hundreds of meters of distance to successfully detect larger objects, given computational and memory availability.
A desire for sharp predictions to be able to separate close-by objects.

For this application the following terms and definitions shall apply:
The term “data” as used herein means any indicia, signals, marks, symbols, domains,
symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular type of network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

As used herein, the phrases “at least one”, “one or more”, “or” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

As used herein, the term “AI model” refers to a machine learning system that has been trained to recognize patterns in data and create detections from data.

In one configuration, a system for receiving and processing image data and non-imagery data relating to a property is provided comprising: a server having a storage and coupled to a network connection, said server adapted to be accessed by a user computer via the network connection. The system is provided such that the server has software executing thereon and comprises an Artificial Intelligence (AI) model, where the AI model receives image data associated with the property, and processes the image data to generate at least one image input vector associated with at least one layer of information relating to the received image data. The AI model also receives non-image data associated with the property and processes the non-image data to generate at least one non-image input vector associated with the at least one layer. The system is further provided such that the AI model combines the at least one image input vector and the at least one non-image input vector to generate preprocessed vector data relating to the property, which is saved on the storage. Finally, the server is adapted to receive a query from the user computer related to the property, wherein the server accesses the preprocessed vector data and generates property condition information associated with the property and is accessible by the user computer in response to the query.

In another configuration, a system for receiving and processing image data and non-imagery data relating to a property to determine a property condition is provided, the system comprising: a server having a storage and coupled to a network connection, the server adapted to be accessed by a user computer via the network connection, the server having software executing thereon and comprising an Artificial Intelligence (AI) module. The system is provided such that the AI module receives image data associated with the property, the AI module processes the image data to generate at least one preprocessed image input vector associated with at least one layer of information relating to the received image data, and the AI model receives non-image data associated with the property, which is saved in the storage. The system is further provided such that the server is adapted to receive a query from the user computer related to the property, the AI model processing the non-image data to generate at least one non-image input vector associated with the at least one layer, and the AI model combining the at least one preprocessed image input vector and the at least one non-image input vector to generate processed vector data relating to the property. The system is provided such that server generates property condition information associated with the property based on the processed vector data, which is accessible by the user computer in response to the query.

In still another configuration, a method of generating semantic predictions corresponding to pixels of an input image is provided executing on a computer having a network connection, the method comprising the steps of: providing a first Convolutional Neural Network (CNN) by: selecting a sampling factor, s, defining a mask that corresponds to a grid of pixels positioned s pixels apart from each other and centered on a single pixel of the grid of pixels, and defining an input image crop size based on the extent of the mask. The step of providing the first CCN further includes: defining a first CNN that processes image data shaped according to the input image crop to generate semantic predictions for pixels corresponding to the grid of pixel locations of the mask, receiving a training image comprising image pixels, and generating a training image crop according to the input image crop size. The step of providing the first CCN still further includes: receiving target semantic labels for the training image, generating a grid of target semantic labels for the training image crop corresponding to the grid of pixels of the mask, and processing, using said first CNN, the training image crop to generate a grid of output semantic predictions for the training image crop corresponding to the mask pixels of the training image crop. Finally, the step of providing the first CCN includes: determining a difference between the target semantic labels and the output semantic predictions and adjusting parameters of the first CNN to reduce a difference between the target semantic labels and the output semantic predictions. The method of generating semantic predictions further includes: providing a second CNN according to weight tensors and an architecture of the first CNN, the second CNN including modified convolution layers, wherein a stride of a last convolution layer is reduced by dividing a scaling factor f, and all convolution layers after the last convolution layer are dilated by multiplying the scaling factor f. Finally, the method of generating semantic predictions includes: receiving with the second CNN the input image that comprises pixels, and generating with the second CNN semantic predictions for the input image that is at a higher pixel density than the mask.

The above-described and other features and advantages of the present disclosure will be appreciated and understood by those skilled in the art from the following detailed description, drawings, and appended claims.

### DESCRIPTION OF THE DRAWINGS

FIG. 1 is a block diagram of the AI-based property risk assessment system according to one configuration of the disclosure.

FIG. 2 is a block diagram of the AI process model training according to the process of FIG. 1.

FIG. 3 is a functional block diagram illustrating the process of the AI-based property risk assessment system according to FIG. 2.

FIG. 4 is a flow diagram illustrating the processing of feature maps according to the process of FIG. 2.

FIG. 5 is a screen shot illustrating a small object of interest on a roof according to the process of FIG. 2.

FIG. 6 is a flow diagram for a multi-resolution model for feature extraction according to the process of FIG. 2.

FIG. 7 is a flow diagram for a hybrid resolution model for feature extraction according to the process of FIG. 2.

FIGS. 8-10 illustrate reliability curves before and after calibration Roof (FIG. 8), Construction Site (FIG. 9) and Gable roof shape (FIG. 10) according to the process of FIG. 2.

FIG. 11 is a flow diagram showing a hybrid resolution model with calibration layers added to the model according to the process of FIG. 2.

FIGS. 12A-12C are screen shots showing comparison of imagery (FIG. 12A), raster pixel probabilities (FIG. 12B) and vector features (FIG. 12C) for tree canopy according to the process of FIG. 2.

FIG. 13 is a screen shot illustrating some property characteristics including building structures and roof conditions according to the process of FIG. 2.

FIGS. 14-18 are screen shots illustrating some property characteristics, objects and various risks according to the process of FIG. 2.

FIG. 19 is a screen shot illustrating vulnerability scores and claim predictors according to the process of FIG. 2.

FIG. 20 is a screen shot illustrating AI damage classifications and detections according to the process of FIG. 2.

FIG. 21 is a screen shot illustrating roof conditions, objects and characteristics according to the process of FIG. 2.

FIG. 22 is a screen shot illustrating property attributes according to the process of FIG. 2.

FIG. 23 is a screen shot illustrating cars and other various features associated with a property to be identified according to the process of FIG. 2.

FIG. 24 is a screen shot illustrating AI-generated outputs based on analysis of data associated with FIG. 23.

FIG. 25 is a screen shot illustrating construction on a property to be identified according to the process of FIG. 2.

FIG. 26 is a screen shot illustrating AI-generated outputs based on analysis of data associated with FIG. 25.

FIG. 27 is a screen shot illustrating vegetation types on a property to be identified according to the process of FIG. 2.

FIG. 28 is a screen shot illustrating AI-generated outputs based on analysis of data associated with FIG. 27.

FIG. 29 is a screen shot illustrating Risk Indicators according to the process of FIG. 2.

FIG. 30 is a screen shot illustrating Natural Perils according to the process of FIG. 2.

FIG. 31 is a screen shot illustrating Enhanced Building Footprints according to the process of FIG. 1.

FIGS. 32A-32C are screen shots illustrating how buildings can be obscured in retrieved images (FIG. 32A), the processing of the imagery (FIG. 32B) and the finalized data showing the rooflines (FIG. 32C) according to the process of FIG. 2.

FIG. 33 is a screen shot illustrating buffer zones and displaying calculations according to the process of FIG. 2.

FIG. 34 is a series of screen shots illustrating tree and roof overlaps used for AI semantic segmentation training and prediction according to the process of FIG. 2.

FIG. 35 illustrates two screen shots of the interface for the AI model allowing for viewing/filtering of an entire portfolio of properties according to the process of FIG. 2.

FIGS. 36 and 37 are screen shots illustrating filter properties, for export and to view aggregates according to the process of FIG. 2.

FIGS. 38-44 are screen shots illustrating an entire portfolio of properties where the system allows for viewing portfolio accumulations by Key Performance Indicators according to the process of FIG. 2.

FIG. 45 is a process flow diagram of the AI-based property risk assessment system including pipeline architecture suitable to generate geospatial data for the estimation of roof age data according to the process of FIG. 1.

FIGS. 46A and 46B are process flow diagrams illustrating the object parcel clipping sub-process of FIG. 45.

FIGS. 47A and 47B are image feature embedding subprocesses according to FIG. 45.

FIG. 48 is a process flow diagram showing the overall architecture for roof age according to FIG. 45.

FIGS. 48A-FIG. 48E illustrate the subprocesses of the roof age process according to FIG. 48 in greater detail.

FIG. 49 illustrates the types of data used in determining roof age according to FIG. 48.

FIG. 50 illustrates the evidence types in determining roof age according to FIG. 48.

FIG. 51 illustrates several evidence types for roof installations detected via imagery according to FIG. 50.

FIG. 52 illustrates several evidence types for roof installations detected by various evidence types according to FIG. 50.

FIG. 53 illustrates when no installation date can be provided based on the type of evidence according to FIG. 50.

FIGS. 54A and 54B illustrate data provided to a user for each evidence type according to FIG. 50.

FIG. 55 illustrates common use cases and filters according to the process of FIG. 48.

FIG. 56 is a process flow diagram illustrating the Meta Algorithm of FIG. 45 in greater detail.

FIG. 57 is a process flow diagram illustrating the three modes of operation depending on imagery coverage according to the configuration of FIG. 56.

FIG. 58 illustrates a timeline creation of various image captures for a property where there are comparisons of the roof including no change and change according to the configuration of FIG. 56.

FIG. 59 illustrates the beginning of a timeline creation including data for a property and noting the installation date according to the configuration of FIG. 56.

FIG. 60 illustrates a timeline including data for a property and noting permit data and assessor data according to the configuration of FIG. 56.

FIG. 61 illustrates a timeline including data for a property and noting permit data and assessor data including an installation date and based on a single imagery model according to the configuration of FIG. 61.

FIG. 62 is a block diagram of the AI-based property risk assessment system adapted for use with insurance underwriting and adjustment according to FIG. 1.

FIG. 63 is a flow diagram of the data processing and formatting of the various data used by the system according to FIG. 63.

FIG. 64 is a flow diagram illustrating the gathering of data from various data sources to be used by the system according to FIG. 63.

FIG. 65 is a flow diagram of the system for insurance underwriting according to FIG. 63.

FIG. 66A is a flow diagram illustrating a prompt entered to the AI module and a bad SQL being generated, which must be addressed by the AI module.

FIG. 66B is a flow diagram according to FIG. 66A illustrating multiple bad SQLs being generated and addressed by the AI module.

FIG. 66C is a flow diagram illustrating pipelining by the AI module using multiple tools.

FIG. 66D is a flow diagram illustrating pipelining according to FIG. 1C and showing the delay caused by each tool.

FIG. 66E is a flow diagram according to one configuration of the invention illustrating tool chaining.

FIG. 67 is a block diagram of one configuration of the system for gathering the property information and modeling of property detections.

FIG. 68 is a screen shot illustrating the logging of AI module chains according to the configuration of FIG. 67.

FIG. 69 is a screen shot illustrating adding a dataset where the feature facilitates saving a trace according to the configuration of FIG. 68.

FIG. 70 is a screen shot illustrating a mechanism for managing datasets and adding individual spans to the dataset each span including an input and an output that are added to expected_output fields of the dataset item according to the configuration of FIG. 67.

FIG. 71 is a screen shot illustrating the spans one level above the Generation spans according to the configuration of FIG. 67.

FIG. 72A is a screen shot illustrating a final dataset item that varies based on which span is added according to the configuration of FIG. 67.

FIG. 72B is a screen shot illustrating dataset items edited directly via LangFuse UI according to the configuration of FIG. 67.

FIGS. 73 & 74 are flow diagrams for workflows for managing datasets and adding individual spans to the dataset according to the configuration of FIG. 67.

FIG. 75 is a screen shot illustrating a landing page for the system according to the configuration of FIG. 67.

FIG. 76 is a screen shot illustrating the landing page for the model with several prelisted data categories according to the configuration of FIG. 75.

FIG. 77 is a screen shot illustrating the landing page for the model with a series of additional data categories according to the configuration of FIG. 76.

FIG. 78 is a screen shot illustrating a query according to the configuration of FIG. 67.

FIG. 79 is a screen shot illustrating a response of the model showing how the system tries to provide an answer to the query according to FIG. 78.

FIG. 80 is a screen shot illustrating that the previous plan did not work and a new plan is generated by the AI module to try and answer the query according to FIG. 78.

FIG. 81 is a screen shot illustrating a bar graph that answers the query according to FIG. 78.

FIG. 82 is a screen shot illustrating additional information with key observations from the data according to the answer provided in FIG. 81.

FIG. 83 is a screen shot illustrating an example of querying properties with the AI module according to the configuration of FIG. 67.

FIG. 84 is a screen shot illustrating the answer to the query according to FIG. 83 and includes additional information relating to key observations.

FIG. 85 is a screen shot illustrating a query requesting the model to create a visual graph for roof score distribution according to the configuration of FIG. 67.

### DETAILED DESCRIPTION

While human detection and labeling has often been seen as the ability to set “truth” as to detections in an image, it was found that the AI system exceeded human detection. The AI-supervised data set that was processed by the AI model exceeded 1.77 million images of human expert labelled data distributed throughout coverage in multiple countries, and throughout the full capture history, right through to more recent surveys. Images are typically 100-200-meter sided squares, with locations chosen via three sampling methodologies including:
Population Weighted: Seed locations selected to match the population distribution of each of the countries of operation (Australia, USA, New Zealand, Canada), with some additional randomization.
Adaptive Sampling: An iterative process, in which the AI model run on whole system surveys has measures of uncertainty and novelty computed, and sample locations chosen in these areas. One example is entropy on an AI Layer.
Custom Sampling: Various methodologies to select likely locations for a class, based on other AI Layers, or external data sources. For example, construction crane labelling jobs sampled from locations of known construction sites via the Construction AI Layer.

Training, Validation, Calibration and Test sets were chosen as a randomized set of geographic areas to ensure that, for example, training and test set labeling jobs are reasonably spatially separated. This prevents data leakage through time (labeling jobs in the same location for different imagery dates are always allocated to the same set) and place (overlapping and adjacent labeling areas are most frequently allocated to the same set). The cell size for this separation is a zoom 16 tile, approximately 614 meters on a side.

During initial testing of the system, over 3 million square kilometers of imagery were run through the full stack (i.e., deep learning, processing, and data set creation). The process was executed on a single Kubernetes cluster (on EKS) running nearly 10,000 machines in parallel (most of which were GPUs) producing a couple of petabytes of output data. It was expected that the process would take 8 weeks, but it was concluded in 10 days. After multiple rounds of intensive labelling review, it was found that the system provided very high accuracy including, for example: swimming pool detections with a 99.7% overall accuracy, and an fl score of 98.3%; solar photovoltaic panels detections with a 99.9% accuracy, and an fl just shy of 99%; and trees detections with a 97% accuracy, and an fl of 98.3%, despite the ambiguous middle ground between a tree and a shrub. Even on shingle roofs where only very subtle texture elements on the scale of 10-20 cm distinguish them from tile roofs the accuracy reached 97%, and an fl over 98%. These are just a few of the layers generated and are provided as a sample of the accuracy of the AI-generated data.

These incredibly accurate detections are critical to various industries where accuracy of information is key, such as in the insurance industry. The viability of the insurance industry depends on the ability of companies to make good decisions on the properties that are insured and the rates these companies charge policy holders. However, their decisions are only as good as the information they have about the properties.

The following terms are used with respect to the system and various methods described herein.

Features: a “model” of something that exists in the world. These can be: “discrete” like a roof, a power pole, or a swimming pool; or “connected” like vegetation, drivable surface, water body.

Geometries: a digital representation of a feature—may be a 2D Point, Line, or Polygon, or a 3D model such as that produced by CAD. It may represent: A single point in time (i.e., a polygon drawn on a single image); or Be the digital representation of the feature for a timeline (i.e., derived from multiple images from multiple dates of the same thing in the world).

Attributes: meta data attached to either Features or Geometries. Attributes can be: At a point in time (e.g., the amount of staining on a roof at that time, the condition of the roof at that time, the dirtiness of a swimming pool) For a time range (e.g., the ID of the feature that persists over time, the height of a building, the pitch of a roof, the type of roof material) An event (e.g., the installation date of a roof, the construction date of a building, damage resulting from a post cat event) A trend or rate of change at a point in time (e.g., the rate of change of Roof Score Index) A prediction of the future (e.g., the remaining life of a roof, the likelihood that a roof is replaced in X years).

Parent/child relationships: features are related to one another based on their ontological relationship. For example, a roof staining feature is a child of a roof feature. The ontology allows for loose relationship definitions. For instance, a roof often is a child of a building, but you can have roofs that are not on buildings (for example a covered bus stop) or solar panels are often children of roofs but may also be standalone on the ground. Roof Age is a one “event” attribute. Additional attributes include first trend attributes like roof condition attributes such as staining and rusting, as well as Rate of Change of Roof Score Index. First prediction attributes include roof replacement likelihood and remaining life years of a roof. New time range attributes include stable roof/building ID (an ID that persists over time), roof shape & material, and existing 3D attributes. New event attributes include damage classification from a post catastrophic event.

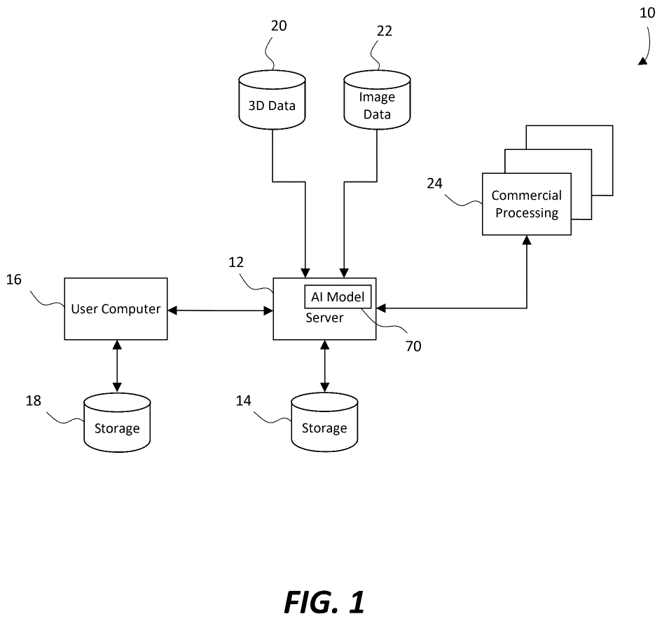

Referring now to FIG. 1, a block diagram of the AI-based system 10 for processing and analyzing data received from diverse data sources for the generation of AI attributes associated with the retrieved data is provided. The system includes a server/computer 12 that has an AI model 70 executing thereon. The server/computer 12 has a storage 14 and is accessible by a user computer 16 via a network connection, which also includes a storage 18.

Two data sources, 3D data 20 and image data 22 provide data to server/computer 12 to be received, processed and analyzed by AI model 70. Also illustrated is commercial processing 24, which can comprise one or many computers that can be rented to handle data processing for AI model 70.

User computer 16 can comprise a computer used by any person or entity accessing data from server 12. For example, user computer 16 can comprise a computer used by an insurance company looking to obtain data on a property or can comprise a policy holder's computer looking to obtain information on their own property.

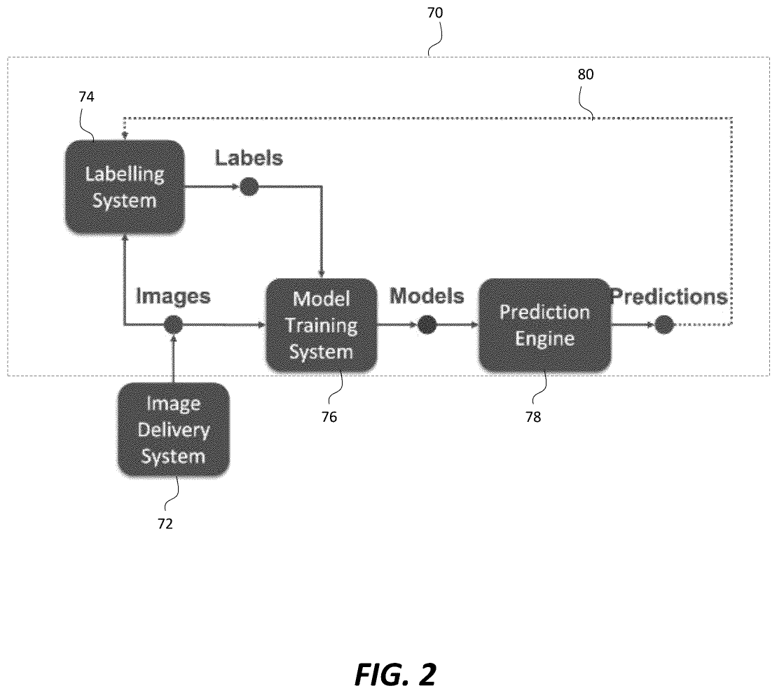

FIG. 2 is a block diagram illustrating Algorithmic Systems architecture.

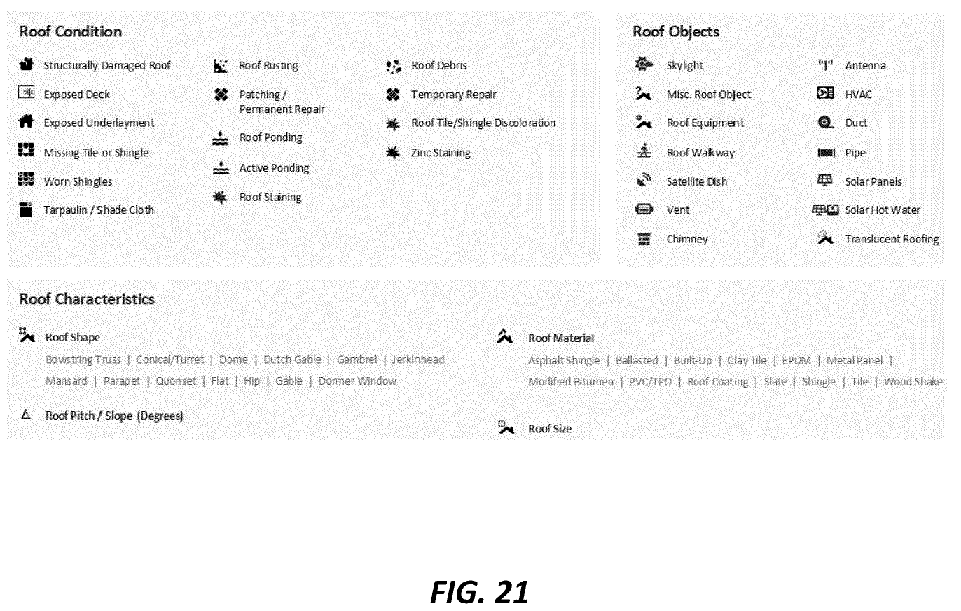

Algorithmic Systems of the AI represent the way algorithms, data pipelines, geospatial processing engines and feedback loops produce data products for end customers to consume. FIG. 21 describes the main algorithmic components, the method in which they are processed to produce a final data product, and other systems that form part of the AI system. It involves core systems to deliver images, label data, train models, and run predictions. Images, Labels, Models and Predictions form data assets, and there is a critical feedback loop as predictions are used at scale to drive further labelling.

The Imagery Delivery System 72 allows imagery products to be utilized as follows:
To display imagery for an area in the Labelling System
To provide imagery in an area for the Model Training System
To provide imagery on whole surveys for the Prediction Engine

Imagery used has been primarily the 2D webtile imagery from the Tile API, however it also includes other visual and structural (3D) products:
An internal Source Oblique API has been used for labelling and model training. This provides access to multi-view images from a range of different angles.
The 3D textured mesh produced via structure-from-motion from imagery (as used for 3D visualization. Ortho imagery).
True Ortho, Digital Surface Model (DSM), and Digital Terrain/Elevation Model (DTM/DEM) tile-based APIs derived from the 3D textured mesh.

The AI relies on a fully proprietary Labelling System 74 frontend and backend. Utilizing much of the same software architecture and functionality as the customer facing Map Browser tool, the expert labelling team interacts with visual and structural content to attach human expert annotations to geospatial locations and points in time. The Labelling System 74 also includes tools and systems for reviewing and editing labels, displaying ontology and labelling instructions, continual quality assurance of labelling, and creation of new labelling jobs for particular tasks at particular times/locations.

The backend Labelling System 74 then converts these human expert labels and data from the Imagery Delivery System 72 into training data sets for supervised machine learning tasks.

The Model Training System 76 enables the training and evaluation of proprietary deep learning models against human expert labels. It leverages both a managed cluster of dedicated Graphics Processing Unit (GPU) training hardware, and a cloud-based machine learning (ML) model training platform, to train models on either a single node, or multi-node training for greater speed. Model training experiments are tracked and managed using the weights & biases platform, and the resulting model architectures and weights are stored for deployment and management by the Prediction Engine 78.

The Prediction Engine 78 executes a directed acyclic graph (DAG) of computational steps-beginning with the core deep learning “base model” and ending with an aggregation step that produces vector tiles and other metadata associated with each imagery survey (the “HD Vector Map”). This AI data product is then served up in a variety of ways (APIs, offline data set deliveries and visualization tools), that often perform real time manipulation of the data, and execution of additional geoprocessing steps and models at time of customer request.

The Prediction Engine 78 has been executed on surveys comprising millions of square kilometers of high-resolution imagery, producing billions of polygons (vector features) and petabytes of output data.

The initial feedback loop 80 from the Prediction Engine 78 to the Labelling System 74 improves the quality of the semantic layers. The Canary system produces a range of statistics on every survey processed by the Prediction Engine 78, including entropy for each semantic segmentation layer to indicate model uncertainty, spatial co-occurrence of various AI Layers, and report generation allowing survey level QA of anomalies to determine whether the system was behaving within expected statistical parameters. This information is used to sample new locations and tasks for the expert labelling team, to focus on increasing the volume of human expert labels for every observed corner case of errors.

A typical semantic segmentation dataset includes a set of images and the corresponding pixel-wise annotation of the classes of interest. Semantic segmentation is commonly done using a fully convolutional neural network with zero padding of the convolutions at borders. The model (e.g., a Convolutional Neural Network) is trained using a loss function that calculates the similarity of the output of the network \hat{P}ₜ with the corresponding labels \hat{Q}ₜ in the training dataset. Semantic segmentation models include:
A feature extractor, also called an encoder, that maps the input/to a tensor of feature maps [symbol] . A typical feature extractor generates a feature map tensor \hat{m}ₗ with a few thousand channels but at a reduced spatial resolution compared to the input.
An up-sampler (e.g., bilinear interpolation), or a learned decoder, or a combination thereof, that generates [symbol] based on [symbol] , where [symbol] has the same resolution as the input image.
A classifier head that maps the up-sampled feature maps [symbol] to the final per-pixel and per-class probabilities \hat{P}ₗ. The per-pixel classification is commonly done using a depth-wise 1 ×1 convolution followed by a Sigmoid function.

Where the Prediction Engine 78 operates on entire surveys of imagery, producing an edge-to-edge vector map of results, there are several features, models and operations that are calculated on small areas (such as, property polygons) at customer request. These include:
The Rollup API: When provided with a polygon of area up to 1 sq km, the rollup API performs a series of operations including filtering out small, low confidence, low fidelity, and peripheral objects (on the boundary). It then summarizes by providing net confidence scores (of at least one object), counting objects, selecting a primary object, and providing attributes related to it.
Roof Condition Summary Score: Available in the Roof Condition Assessment product, this is a real-time model that takes input from the HD vector map, and summarizes the physical condition of the roof, by considering all roof condition layers, and roof material layers.

Pipelines are executed automatically by an internal software module associated with the AI model. The standard AI pipeline (that executes on vertical imagery) is deliberately queued up with, for example, a 7-day lag, to allow for initial publish/republish of imagery to occur (and may then execute several days thereafter). The damage detection pipeline (which produces data for a software module associated with disaster areas) polls for new surveys (e.g., every 15 minutes) on a periodic basis. Surveys then execute much more quickly where multiple surveys may automatically run simultaneously within set time periods (e.g., 2 hours). Time will vary depending on survey size, as well as other factors such as computational availability.

The core architecture of the AI model described above is the map data produced by pipelines operating at scale on whole surveys worth of imagery. In addition, a range of real-time models are run such that, when a request is made (in an application or an API), additional algorithmic steps are performed to produce an answer for the user. This is neatly separable as an architecture, as it allows independent models to be developed and deployed in a way that benefits from the heavy, efficient precomputed maps, and allows the flexibility of faster, lighter computational work. This includes damage classification scores, risk and vulnerability scores, roof condition scores also known as roof spotlight index (RSI), and the like.

The AI model further includes a single deep learning model, trained to operate effectively and efficiently at ultra-high resolution, large scale, and producing over 130 individual semantic layers of output. In essence, it “paints pixels with meaning”, converting each (red, green, blue) pixel of Zoom 21 input imagery, to an equivalent “semantic” pixel comprising over 130+individual class probabilities. It should be noted that while the AI model handles 130+ layers, virtually any number of individual layers and individual class probabilities can be used by the system as greater granularity is achieved.

Efficient and accurate computer vision on imagery covering millions of square kilometers requires rethinking of network architectures and approaches to training/inference that have been developed for fixed-size imagery. Some innovations to enable this include:
a method of training deep convolutional neural networks used for semantic segmentation called “pinhole training”.
a new hybrid resolution architecture that further increases the receptive field and hence the context that is used in prediction (without sacrificing fine-scale information).
a retrofitting method that provides the flexibility of trading off prediction resolution with memory/compute efficiency without the need for retraining.

The AI system uses these proprietary techniques to simultaneously predict 130+independent semantic segmentation classes on a large 3249×3249 crop of zoom 21 (7.5 cm/pixel) imagery. It does this using just one predict call to a single model that takes less than 4 seconds on an AWS g4 instance. The 130 classes of interest include a large variety of objects, defects, and surface classifications. The proprietary techniques enable us the best trade-off between using the highest resolution imagery and having a context of hundreds of meters of distance to successfully detect larger objects, given limited computational and memory availability.

There is a strong correlation between the neighboring pixels in a typical image. For example, if a pixel represents a patch of a “Roof”, it is quite likely that the adjacent pixels are also “Roof”. Only at the edges of an object do neighboring pixels have a different classification. The expected probability of a pixel having a True label (for a class of interest) when there is another True pixel at the distance of 32 pixels can be calculated. At the distance of 32 pixels, P (1|1)>0.5 for most classes. A typical semantic segmentation training calculates the loss for every pixel in the image. However, the loss from adjacent pixels is strongly correlated.

Semantic segmentation in remote sensing is different to ‘standard’ semantic segmentation settings because there is no fixed image size: images are stored as tiles of a single (practically) infinitely large image covering the whole earth. This difference is important: the achievable receptive field of a model is upper bounded not by image size but by memory. At inference time, it is desirable to predict as large an area as possible for fixed cost/GPU-memory/FLOPS.

Due to limited system and GPU memory, at inference, the model predicts on a single image tile at a time, and predictions are stitched together to form the predictions for a larger region of interest. Adjacent patches overlap, so that the stitching algorithm can achieve seamless stitching by either averaging overlapping predictions from adjacent patches or cropping a border around predicted outputs (i.e., clipping predictions near the edges of the output), or a combination of these two methods.

There are a wide variety of applications that benefit from an AI-based solution. Some applications require detecting very small objects or defects such as detecting the base of a TV antenna or detecting damaged asphalt in aerial images such as vertical or nadir images. Some other applications may require detecting water bodies or land cover classification over a large area. In some cases, to achieve the highest accuracy, the architecture of the AI model and the resolution of the input images are tailored to the target use case.

At the core of the AI system is a single multi-label semantic segmentation model that targets a large variety of use-cases across insurance, government, and commercial industries. The AI model architecture used is tailored for detecting many classes corresponding to objects of various sizes. Addressing all use cases with a single model significantly reduces the inference cost. Some classes also provide a useful context for other classes, such that learning those classes jointly in a single model improves accuracy. The accuracy benefit of multi-task learning is often more dominant when the training dataset contains a relatively smaller number of labelled samples for some of the classes of interest. Multi-task learning improves performance by introducing an inductive bias to prefer features that are common across multiple classes. However, hyper-parameter tuning and selecting a good early stopping point becomes harder when the model includes a large variety of classes and (often consequently) a very unbalanced dataset.

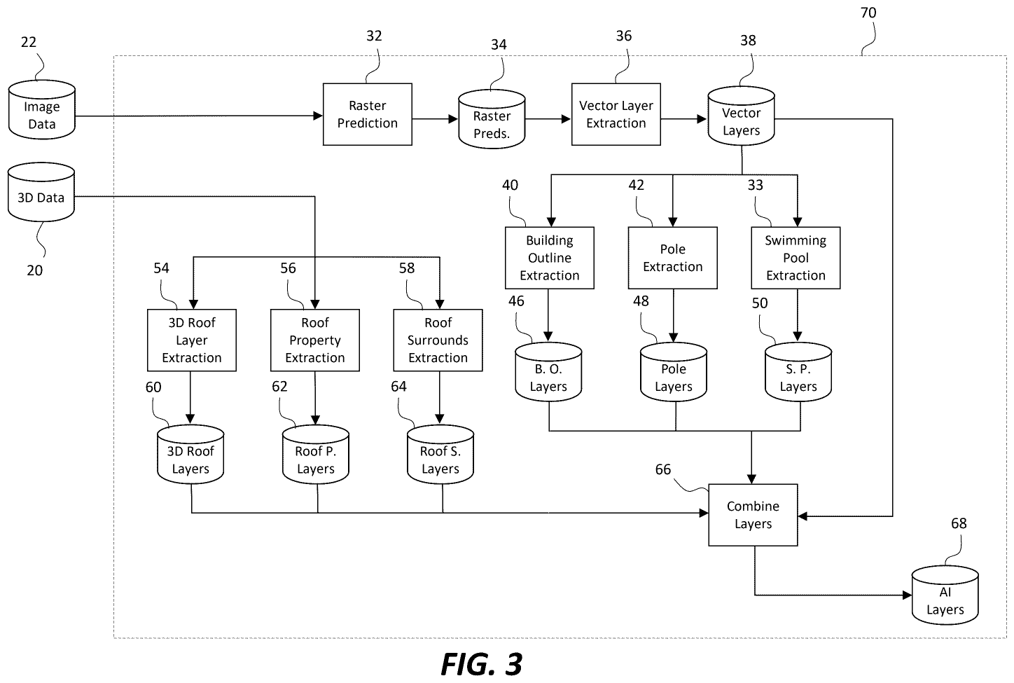

Referring now to FIG. 3, a flow diagram is illustrated for AI model 70 showing how data is obtained, processed, and stored. FIG. 3 outlines the function of pre-processing data including (but not explicitly named) attributes. While not all processing blocks are shown, the main processing blocks are illustrated. It starts with the execution of the deep learning model in the Raster prediction 32 block and finishes with the completed HD vector map of data with all feature classes and their attributes processed on whole surveys with data aggregation or All layers 68 block at the end. It will be noted that layers and attributes are generated based on pre-processing functionality, whereas scores are later derived from the preprocessed data.

Image data 22 is input to Raster prediction 32. Raster predictions 34 are then saved and input to Vector layer extraction 36. Vector layers 38 are then saved. Vector layers 38 are various input to Building outline extraction 40, Pole extraction 42, and Swimming pool extraction 44. It should be noted that these extraction modules (Building outline 40, Pole 42, and Swimming pool 44) are just a few of the many extraction modules available to AI model 70. Each of Building outline extraction 40, Pole extraction 42, and Swimming pool extraction 44 function to extract their identified vector layers that are saved as Building outline layers 46, Pole layers 48, and Swimming pool layers 50.

Also illustrated in FIG. 2 is 3D data 20 that is input to 3D Roof layer extraction 54, Roof property extraction 56, and Roof surrounds extraction 58. Each of Roof layer extraction 54, Roof property extraction 56, and Roof surrounds extraction 58 function to extract their identified layers that are saved as Roof layer layers 60, Roof property layers 62, and Roof surrounds layers 64.

All of Building outline layers 46, Pole layers 48, Swimming pool layers 50, Roof layer layers 60, Roof property layers 62, and Roof surrounds layers 64 are input to Combine layers 66, which outputs AI layers 68. As stated previously, just some of the extraction modules are illustrated in FIG. 2, whereas many extraction modules associated with many layers can be used by AI model 70. The AI layers 68 are then saved in storage 14 for later use and analysis.

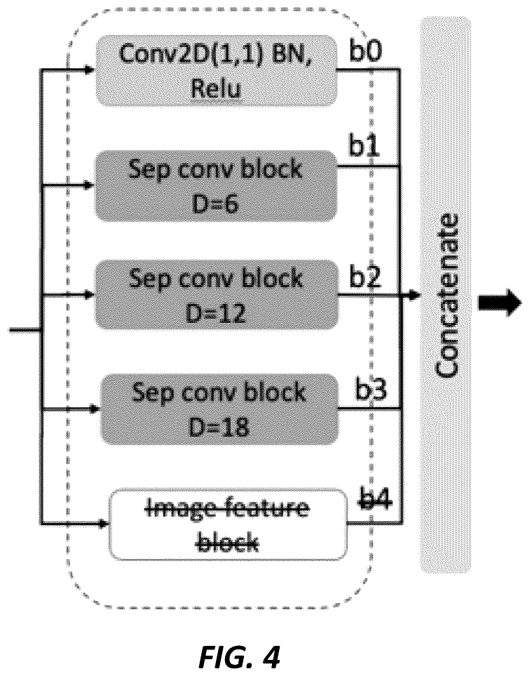

Referring now to FIG. 4, semantic segmentation models calculate a per-pixel loss [symbol] (pᵢⱼ, qᵢⱼ) between the model's prediction pᵢⱼ and the ground-truth labels qᵢⱼ for every input/label pixel ij. For a single input image, the size of the matrix P. (containing the model's prediction pᵢⱼ for all points) is W×H×N where N is the number of classes in the model. As an example, consider a model at FP16 resolution with an input size of 896×896 pixels, 100 output classes, and a batch-size (Stochastic Gradient Descent (SGD) and all the optimization techniques that are based on SGD use a group of input samples, called a mini-batch) of 10. In such a model, the size of the tensor \hat{P}ₗ is around 1.5 GB, and at least two (for forward and backward passes) tensors of this size are required to calculate the weight update. The up-sampled feature maps (i.e., tensor [symbol] ), has a substantial memory footprint as well. In the exemplary model above, even if the number of feature maps in [symbol] is reduced to 128, the tensor [symbol] is about 1.9 GB, and similar to \hat{P}ₗ, at least two tensors of this size are needed for training. Even when the reduced FP16 resolution is used, the exemplary model above needs about 6.8 GB of GPU memory just to store the two copies of \hat{P}ₗ and [symbol] for forward and backward passes. It should be noted,
Up-sampled feature maps need a substantial amount of GPU memory; and.
the size of the tensor \hat{P}ₗ linearly increases with the number of output classes N and can be substantial for a model with large input and many output classes.

To avoid the limited GPU memory becoming a bottleneck as the number of classes in the model are increased, a technique is provided that is referred to as “pinhole” training. As shown in FIG. 4, pinhole training uses a simplified form of the AI model architecture during training and avoids up-sampling the feature maps and/or the need for a decoder, while still producing pixel-level predictions. In pinhole training, the class probabilities are calculated directly from the reduced resolution feature maps tensor [symbol] . For every pixel in [symbol] , the feature encoder is considered as a function that generates a feature vector of length h from an input area that is centred on that point. The input area corresponding to each point in [symbol] is called the effective receptive field of the feature encoder. To be able to generate sharp masks from the reduced resolution feature maps, extra care must be taken to align the feature maps with the sparse output labels. A “pinhole” model thus makes sparse high-resolution (pixel-level) predictions at dramatically reduced memory cost.

Common feature encoders such as ResNet or the xception based encoder use strided convolutions to reduce the spatial size of the feature maps. To be able to use a uniform rule for aligning feature maps with labels, pinhole training imposes an additional constraint on the size of the input. If the feature encoder is reducing the size of the feature maps by a factor of s, [symbol] can be considered as feature maps of a sparse set of points that are s pixel apart; however, for the feature maps to align properly with the dense input, the dimensions of the input must be a multiple of s plus 1; i.e., W and H must be

$$W = s \times {k}_{1} + 1$$

$$H = s \times {k}_{2} + 1$$

The feature extractors that are commonly used in semantic segmentation reduce the spatial resolution by a factor of s=16.

An additional benefit of this technique is that labelling can also be simplified. For some classes with complex borders, such as, ‘roof rusting’, ‘leaf-off vegetation’ or ‘damaged asphalt’ drawing pixel-perfect polygons around the objects or defects of interest is complex and very time-consuming for human labelers. On the other hand, labeling a set of sparse points on a fixed grid speeds up the labeling task and improves the per-pixel accuracy of the labels.

Besides reducing the use of GPU memory required for training, pinhole training also provides the advantage that the sparsity of the predictions can be modified post-training. Specifically, a different architecture with the desired tradeoff between sharpness and computational cost can be created for inference without the need for any additional training. To halve the sparsity of the predictions, the last convolution layer that is using a stride of 2 is modified to a dense convolution with a stride of 1. This will double the output resolution of that layer, and all the subsequent layers. To be able to reuse the weights, we double the dilation of all subsequent convolution layers. Specifically, non-dilated convolution layers are changed to a dilated (i.e., atrous) convolution with a dilation rate of 2; the dilation rates of all subsequent atrous convolutions are also doubled. This process of modifying the architecture and trading computational complexity with the sparsity of the predictions is referred to as “retrofitting”. Once the model is retrofitted to the desired sparsity, to generate predictions with the same resolution as the input, the final feature maps are interpolated using corner-aligned bilinear interpolation. It is important to note that this retrofitting procedure does not alter the function computed by each convolution block-it simply increases the (spatial) density of convolution blocks, with no reduction in (per-pixel) accuracy and no re-training required.

The GPU memory footprint of a model is substantially higher at training compared to inference. To reduce the overhead that is needed for seamless stitching of the predictions at inference, predicting on a larger input compared to the input size that was used for training is utilized. To achieve this, the model must be a fully convolutional architecture and the operations such as, global pooling must be avoided. Atrous convolution and an encoder based on Xception blocks are used. Also used is atrous spatial pyramid pooling (ASPP); however, as shown in FIG. 4, image level pooling in ASPP module is avoided so that the input size can be changed at inference.

In practice, image crops of size 865×865 (or 881×881) for single resolution training) are used. At inference, to be able to perform post-prediction multi-zoom pyramiding, predictions for an output block of 8×8 zoom 21 tiles (i.e., 2048×2048 pixels at zoom 21) using a single predict call on the model are generated. An additional border of 600 pixels on each side is also added to the input image and is cropped before stitching the predictions. In summary, while the model is trained on images of size 865 ×865, the model used at inference takes images of size 3249×3249 pixels.

As noted previously, it is desirable to detect a wide variety of objects and surface types in aerial images all using a single model. To detect small objects such as a missing shingle on a roof, or the base of a light pole we would like to predict at a high resolution, but to detect large uniform objects like the roof of large commercial warehouses, bodies of water, or large agricultural lands, it is desirable that the effective receptive fields of the convolutions cover a large area on the ground, as often having the edge of the object in the receptive field of the convolution is crucial for accurate detection. Some of the highest value attributes (e.g., the material and condition of an object) push the limits of the available imagery in terms of leveraging fine-scale texture and other details.

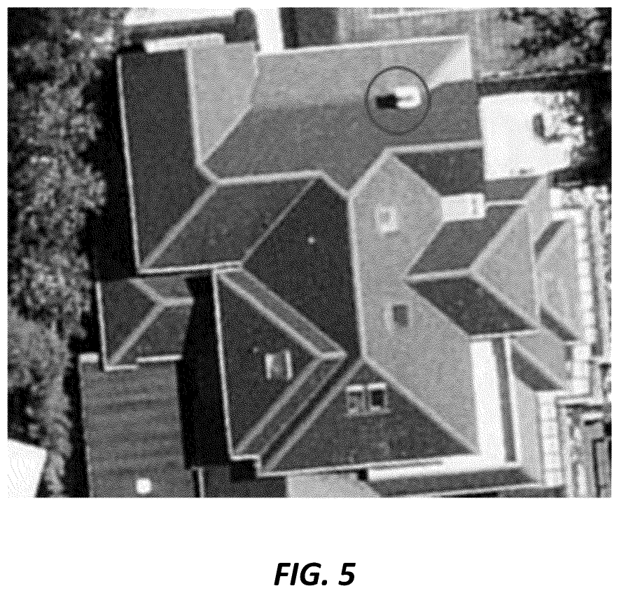

FIG. 5 is an example of a small object of interest. This small object often takes only a few pixels at zoom 21 resolution (i.e., at zoom 21, the ground sampling distance of each pixel is about 7.5 cm). As can be seen from FIG. 5, it is hard to reliably classify these pixels as roof, without having the context of the edges of the roof.

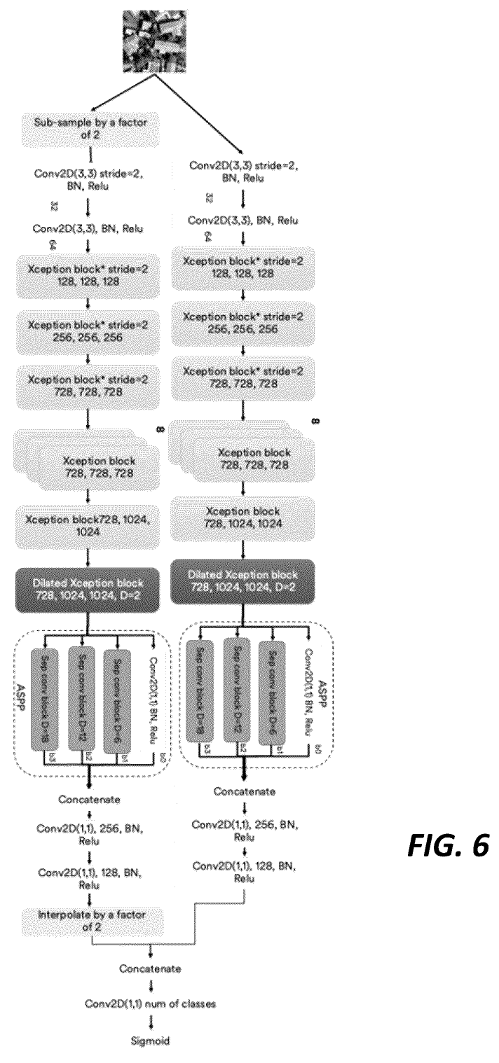

The effective receptive field of the feature extractor defines the available context. To further increase the receptive field (and hence the available context), a multi-resolution architecture is represented in FIG. 6 is used. The 2^{nd} branch has a similar architecture to the first branch; however, the input is sub-sampled by a factor of 2 at the start, and the final feature maps are up-sampled using corner-aligned bilinear up-sampling. Sub-sampling the input, increases the effective receptive by the same factor. The proposed hybrid architecture further reduces the depth of the feature maps from each branch to 128 using a 1 by 1 Conv2D layer before depth-wise concatenating all the feature maps. Note that FIG. 6 shows the architecture used during “pinhole” training. At inference, the spacing of the sparse predictions could be reduced, and the concatenated features are up-sampled to the input resolution using corner-aligned bilinear interpolation, before mapping the feature maps to per-class logits and normalizing the logits using the Sigmoid function.

To align the feature maps of the second branch (with sub-sampling) with the feature maps of the first branch and input, for pinhole training a hybrid resolution model, the dimensions of the input must be a multiple of 2s plus 1; i.e., W and H must be

$$W = 2 s \times {k}_{1} + 1$$

$$H = 2 s \times {k}_{2} + 1$$

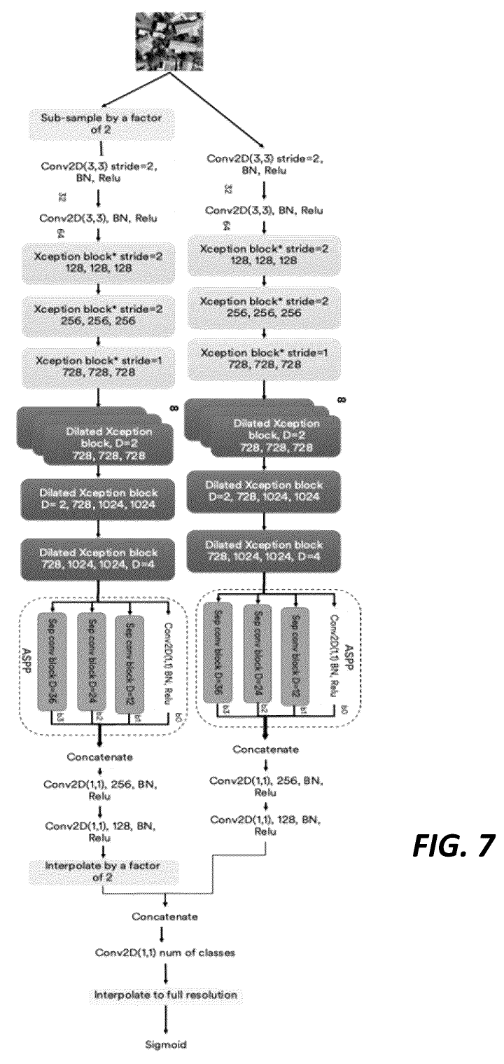

FIG. 7 shows a hybrid resolution model that is retrofitted to have a sparsity of one prediction every 8 pixels (for each vertical and horizontal direction) and generates dense predictions at the original resolution by up-sampling the concatenated feature maps. In practice, a model like FIG. 7 is used for inference.

Confidence calibration is the problem of predicting probability estimates that are representative of a true correctness likelihood. Accurate estimation of predictive uncertainty (model calibration) is essential for the safe application of neural networks in environments such as risk analysis in insurance. In real-world applications that use AI for decision making, not only is the accuracy of the AI model important, but also it is expected that the model generates a realistic indication of when it is likely to be incorrect. While models trained with binary cross entropy loss are theoretically calibrated, it has been found that modern deep CNNs are often poorly calibrated.

Platt scaling was originally proposed for generating probabilistic output from Support Vector Machine (SVM). For a binary classifier, to generate calibrated probabilities pᵢ using Platt, the non-probabilistic output (i.e., logits) zᵢ is passed through a Sigmoid function.

$$P ( {y}_{i} = 1 \vert f ) = \frac{1}{1 + exp ( {az}_{i} + b )}$$

where a and b are fitted using maximum likelihood estimation on a clean dataset not used for training of the original classifier.

Temperature scaling is a simpler form of Platt scaling where the bias term b is set to zero. The advantage of using Temperature scaling is that the uncalibrated probability of 0.5 is guaranteed to remain at 0.5 after calibration. Vectorization often uses the threshold of 0.5 to convert the probabilistic output of the raster model to a binary mask. When Temperature scaling is used for calibration, the vectorized shapes stay the same before and after calibration, and only the confidence values may change.

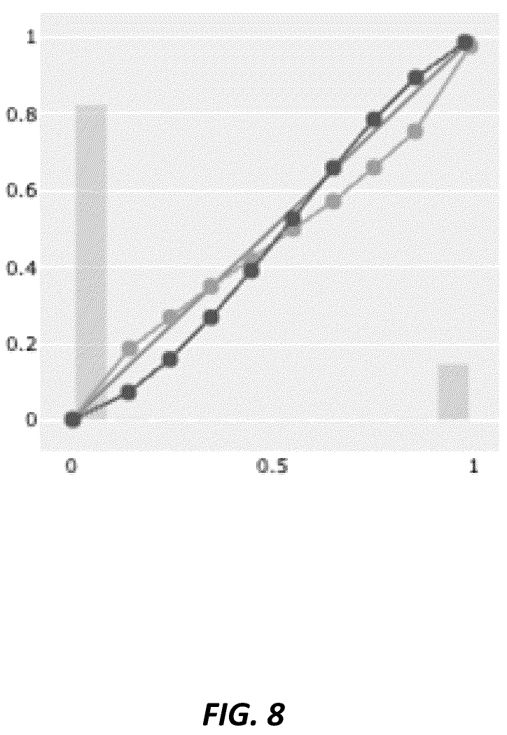

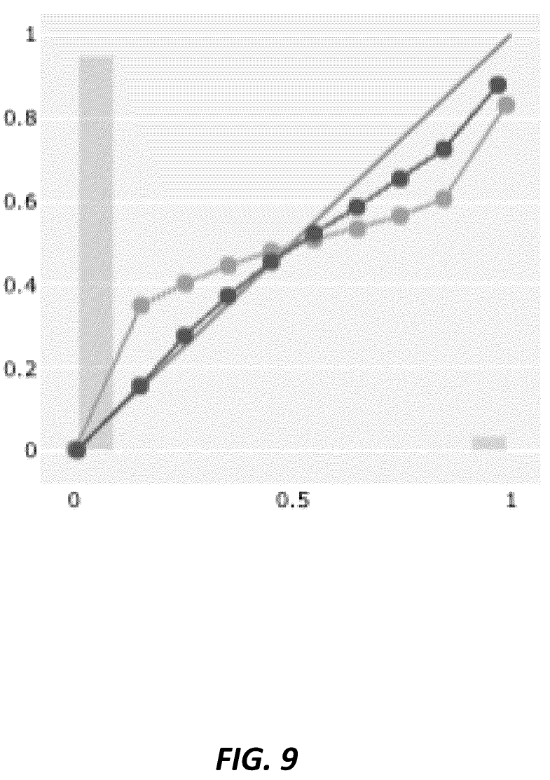

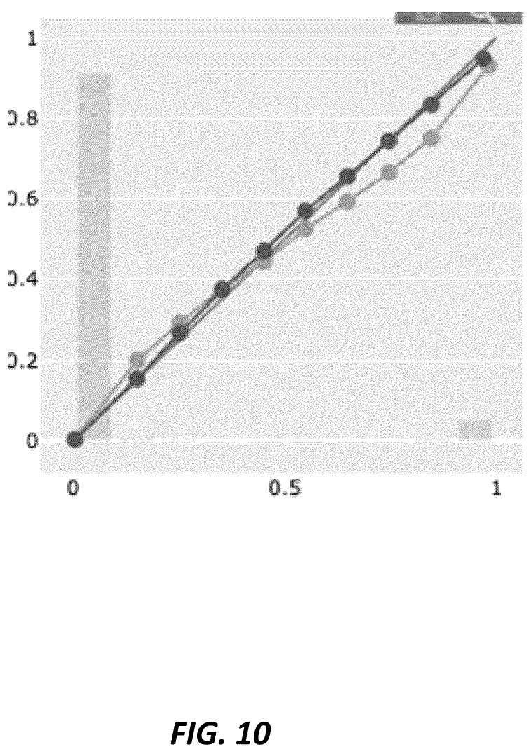

To calibrate the current AI model, a combination of Platt and Temperature-scaling for different classes is used. Each class is calibrated separately; hence we have a set of calibration parameters a and b per output class. The choice of calibration method is treated as a per-class hyper-parameter, which is decided by first training a set of calibration models using both Platt and Temperature scaling approaches on the validation set and selecting the better method by evaluating on the calibration set. Once the calibration config file is obtained, the final set of per-class calibration models is trained using a combination of validation and calibration sets and evaluates the final calibrated model on the test set. The calibration models are then fused into the final stage of the model and packaged as a single model for inference on a GPU. FIGS. 8-10 show the reliability curves of 3 sample classes before and after calibration. Reliability curves before (cyan) and after (magenta) calibration for Roof (FIG. 8), Construction Site (FIG. 9) and Gable roof shape (FIG. 10).

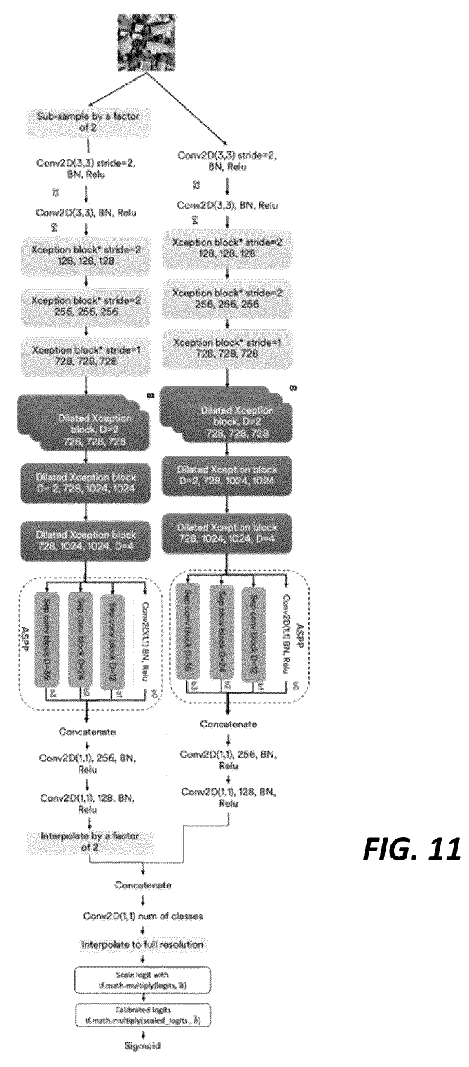

FIG. 11 shows a hybrid resolution model with calibration layers added to the model. Note that each output class has an independent calibration model.

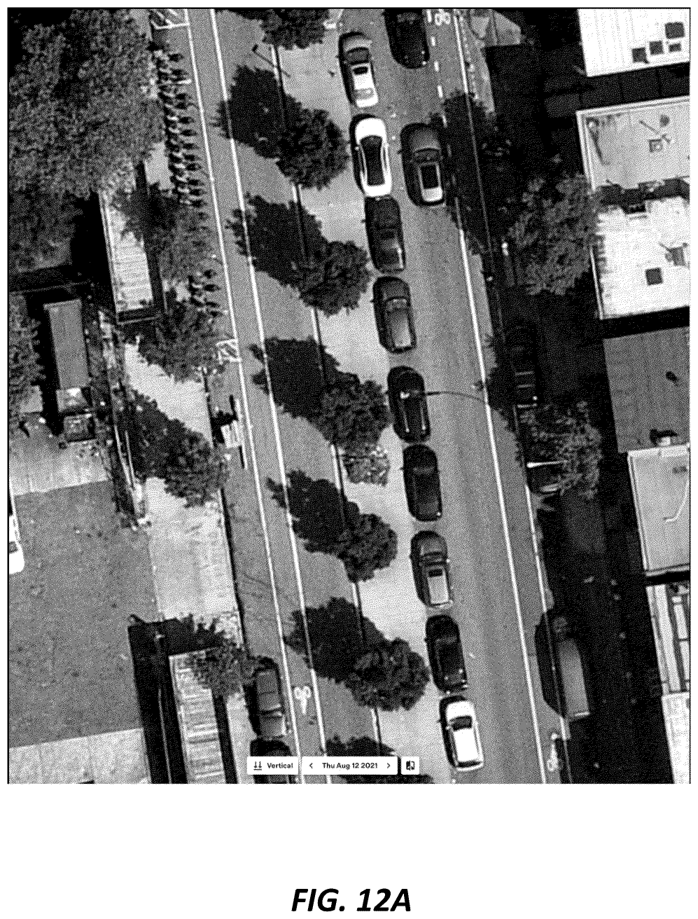

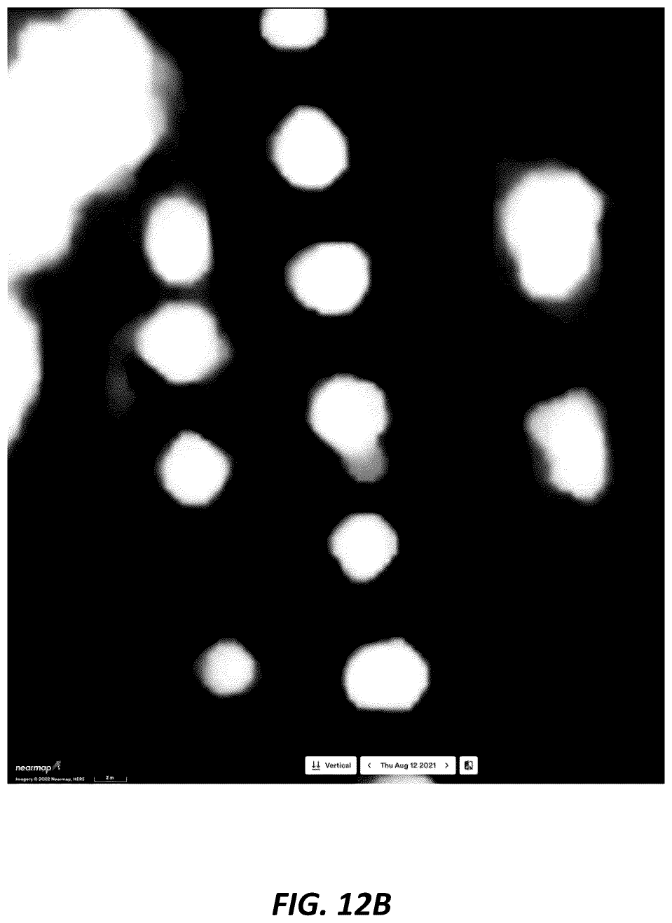

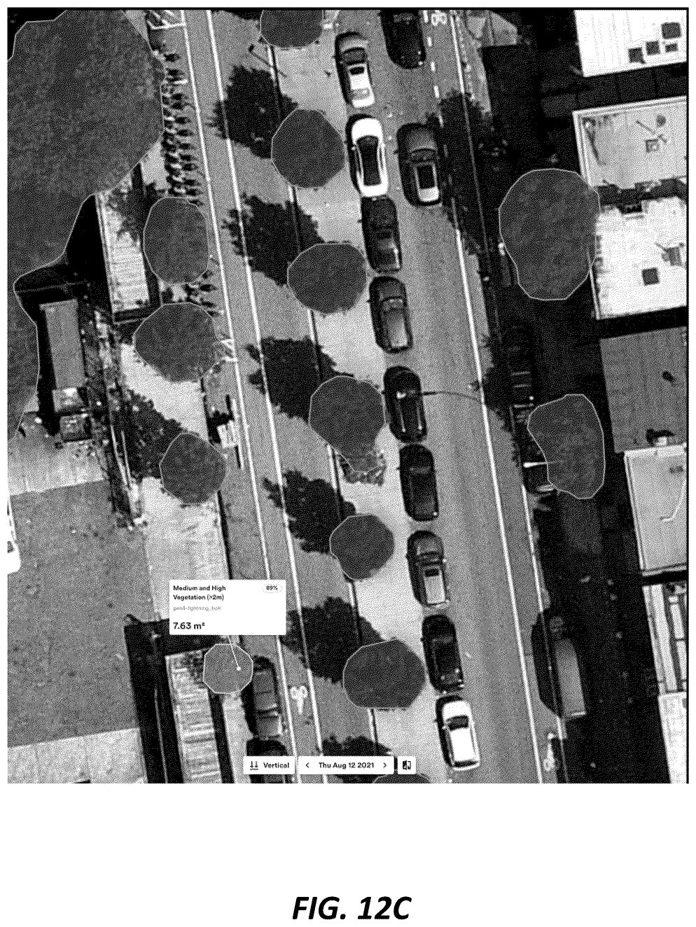

Feature Extraction: From Raster (pixels) to Vector (polygons). The feature extraction algorithm takes the output of the deep learning semantic segmentation model and uses computer vision algorithms to create polygons. FIGS. 12A-12C show the transition from raster prediction probabilities to features (vectorized polygons).

Confidence Contours. Each pixel for a given raster AI Layer represents a probability that the pixel represents that layer (e.g., that a solar panel lies at the latitude/longitude at the center of the pixel). This is represented by a unit value scaled to 0-255. Contours delineating pixels of equal confidence are then produced, in a similar manner to contours of equal height on a topographic map. These contours are performed at multiple confidence levels (e.g., typically at a very low level of confidence, and at 50% confidence).

Object Confidence Agreement. Objects (areas of raster predictions) with no part containing a confidence level above the threshold (e.g., 50%) will be filtered out. Conversely, any object with at least one section exceeding the confidence threshold will be included. In most situations, end users will likely want to perform some filtering of objects based on confidence. Approximately 4 out of 10 features (vectorized objects) with a confidence of 60% will be false positives, which is likely undesirable. In most scenarios, users find that ignoring objects below a threshold such as 70-90% strikes a good balance between false positives and false negatives.

Aside from minor morphological operations, no minimum area threshold is applied to features, although filtering by area or shape may be advantageous for some applications. In many situations, a user will want to filter out a minimum practical size, such as, a minimum reasonable size for a swimming pool. This is use-case dependent, particularly for buildings, as sheds and garages may or may not be of interest. In terms of maximum size, it is important to note that because processing is performed on an individual survey basis, areas only include connected classes such as a body of water that fall within the bounds of the same survey.

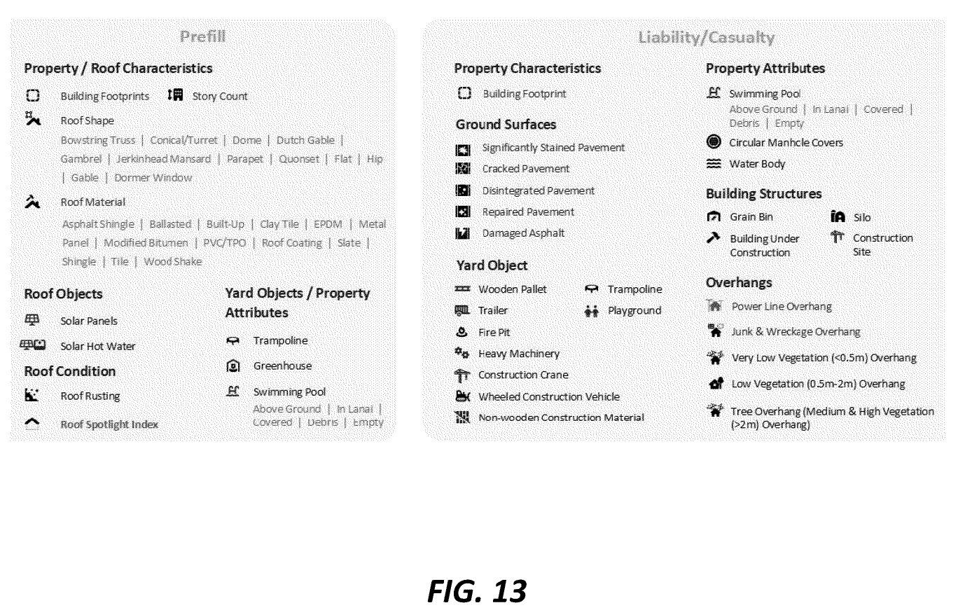

Referring now to FIG. 13, a Graphic User Interface (GUI) on a web page is presented to a user accessing information from server 12. For example, a section titled “Prefill” may include selectable items such as, “Building Footprints”, “Story Count”, “Roof Shape”, Roof Material”, “Roof Objects”, “Yard Objects/Property Attributes” and “Roof Condition” where each of those selectable items may include sub tabs for providing information about a specific property. Also shown on the web page is a section titled “Liability/Casualty”, which includes items such as “Property Characteristics”, “Ground Surfaces”, “Property Attributes”, “Yard Object”, and “Overhangs”, each of which may include sub tabs relating to specific information about a property. While certain descriptions are illustrated, it will be understood to one of skill in the art that many different types of information could be provided for on this intake page.

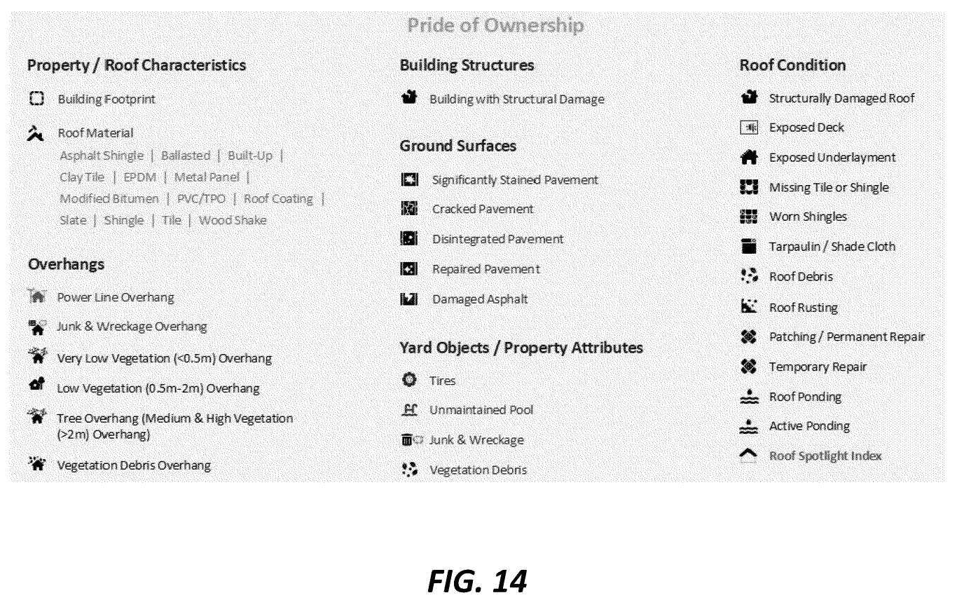

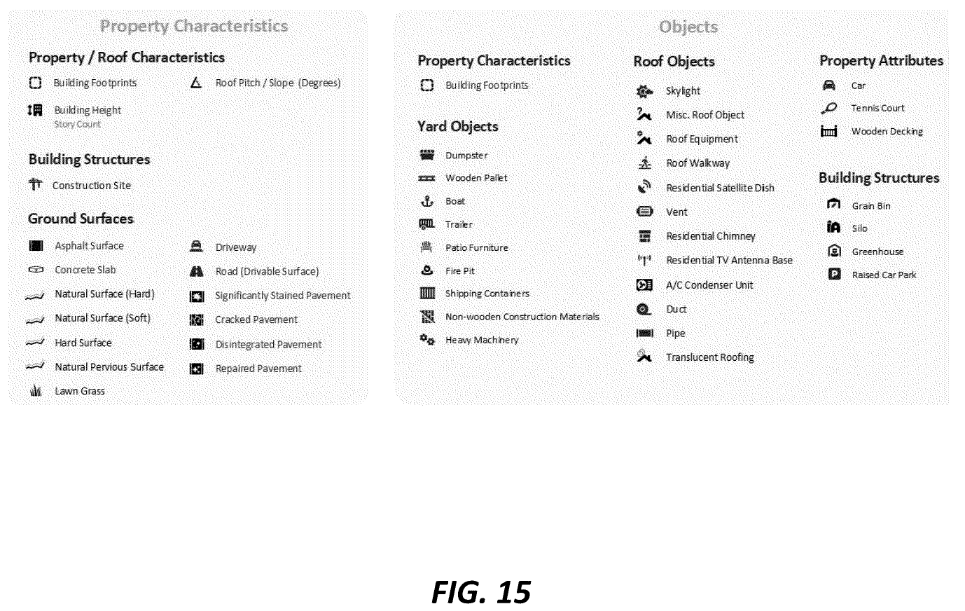

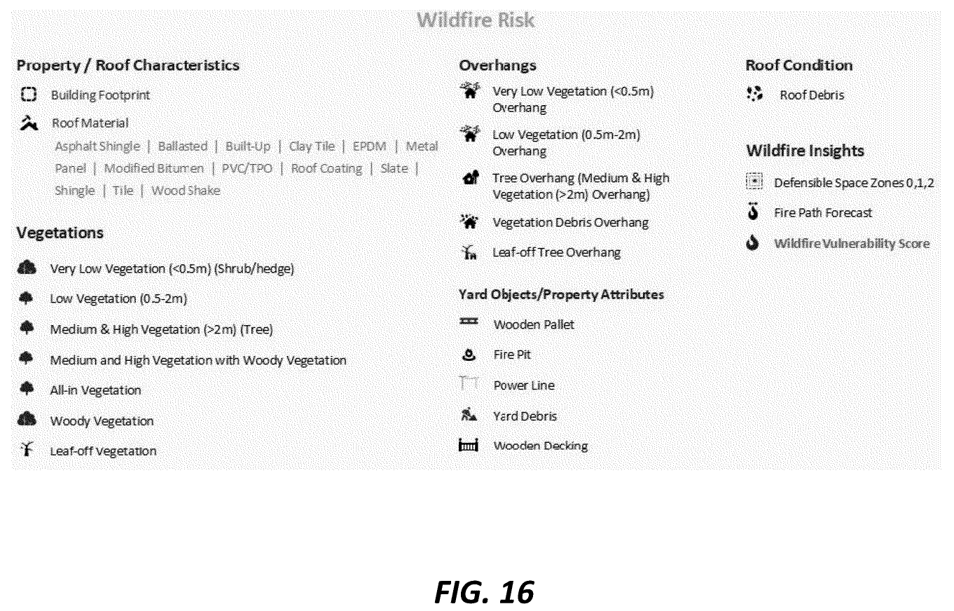

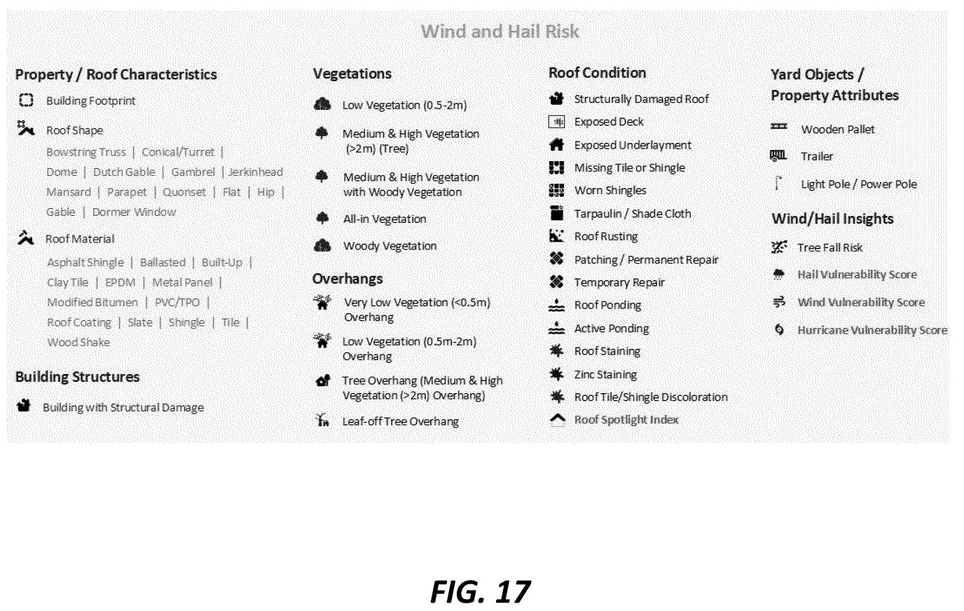

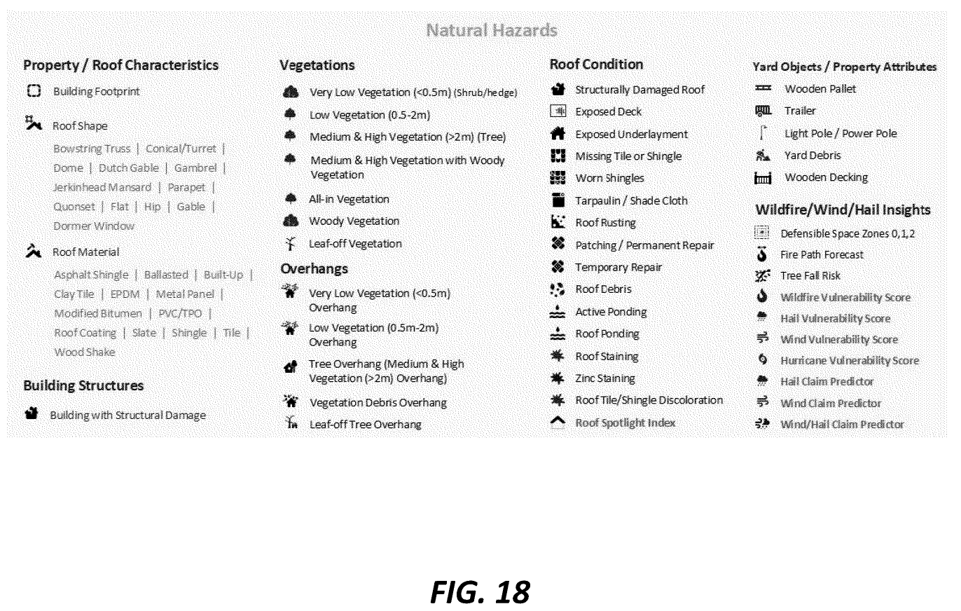

FIGS. 14-18 are further illustrations of a GUIs on web pages variously titled “Pride of Ownership” (FIG. 14), “Property Characteristics” and “Object” (FIG. 15), “Wildfire Risk” (FIG. 16), “Wind and Hail Risk” (FIG. 17), “Natural Hazards” (FIG. 18), all of which include many subsections, where each may include sub tabs associated with various characteristics of a property.

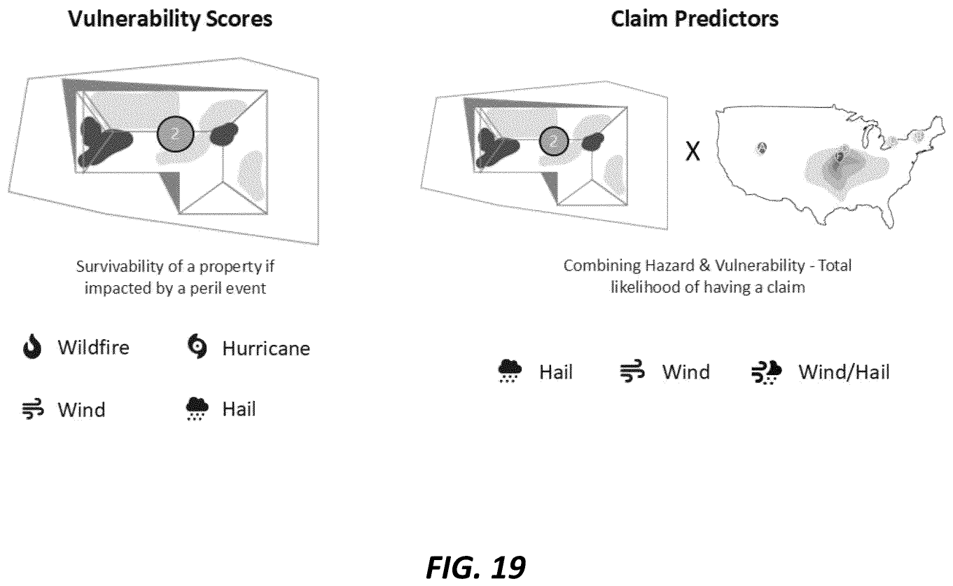

FIG. 19 illustrates a web page presented to a user showing the top of a roof and indicating calculated survivability of a property if it was impacted by a peril event such as, a wildfire, wind, a hurricane or hail. Also shown is the combination of hazard and vulnerability based on geographic information to provide a predictor of future insurance claims.

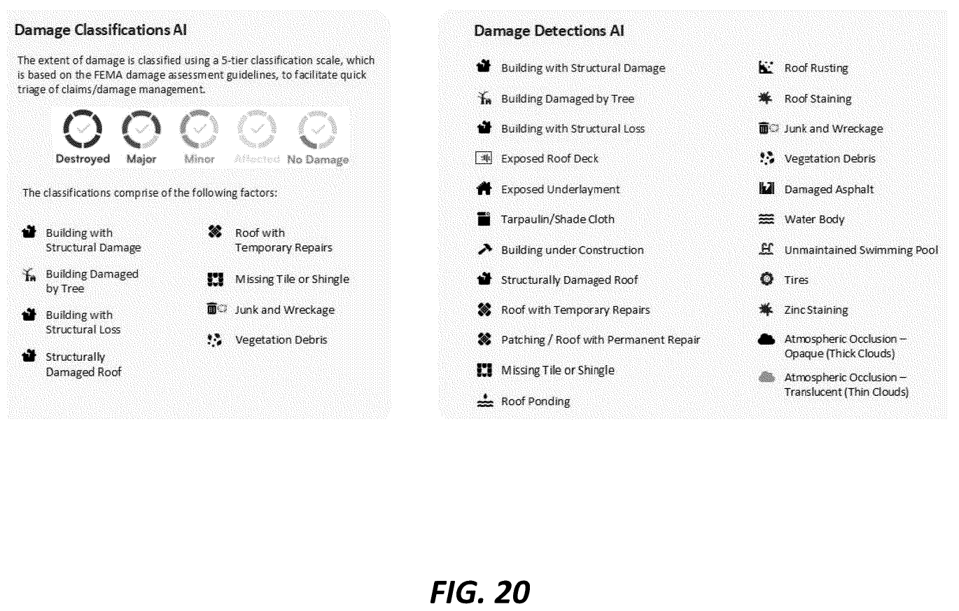

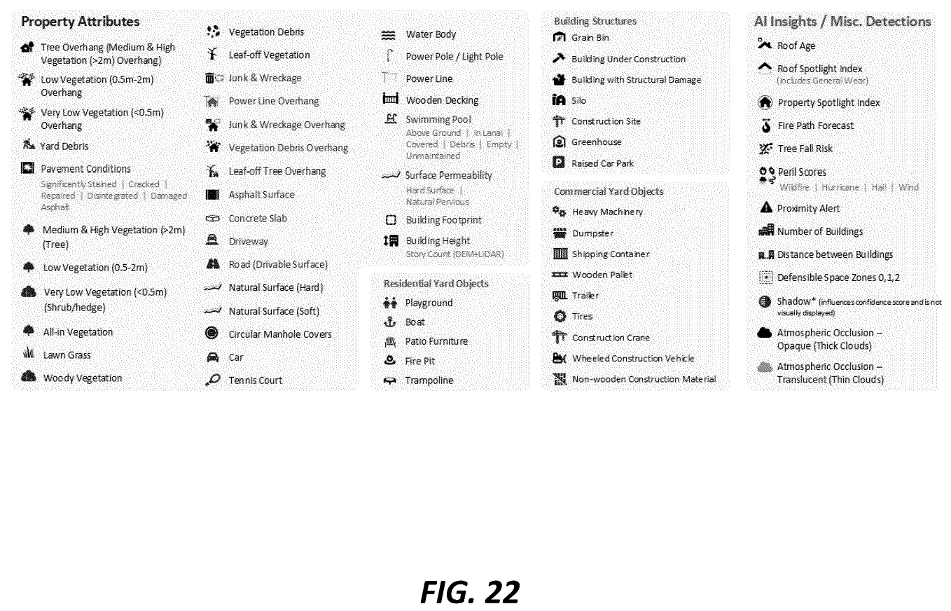

FIGS. 20-22 illustrate web pages presented to a user that show user interfaces and screen shots of AI damage classifications and detections, roof conditions, objects and characteristics, and property attributes the system processes to provide detailed information relating to the property. For example, FIG. 10 shows two categories including “Damage Classification Al” and “Damage Detections AI.” Damage classification can range from “No Damage” up to “Destroyed” including five classifications. The AI model is able to look for and automatically make damage detections, which are listed as sub tabs. FIG. 11 is specifically directed toward the roof of the structure listing “Roof Condition” and “Roof Objects”, while FIG. 12 is directed to “Property Attributes” and “AI Insights/Miscellaneous Detections.”

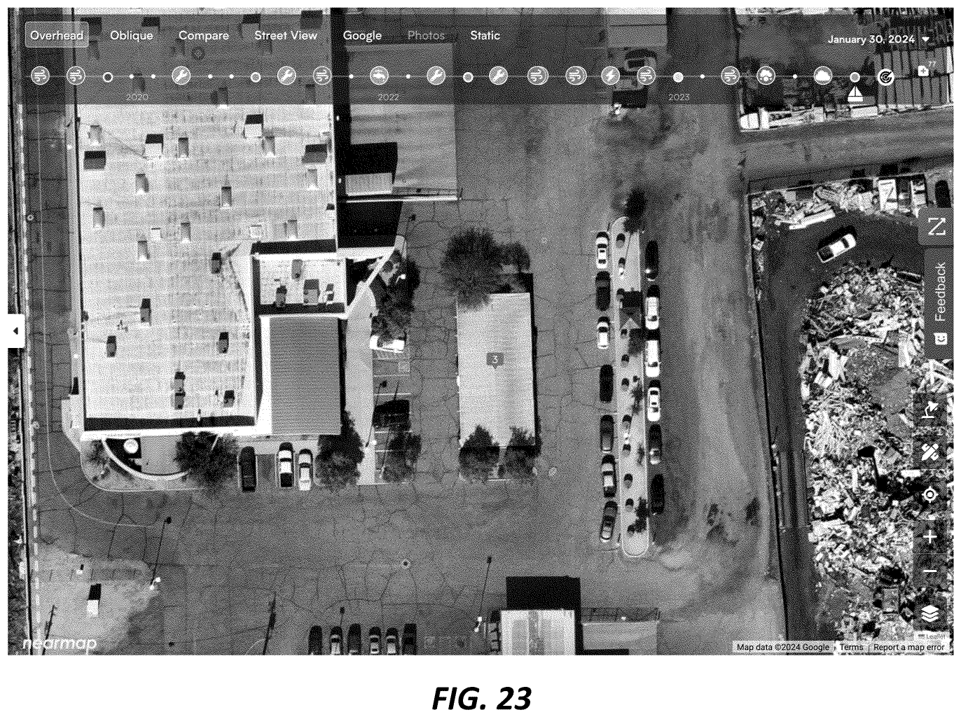

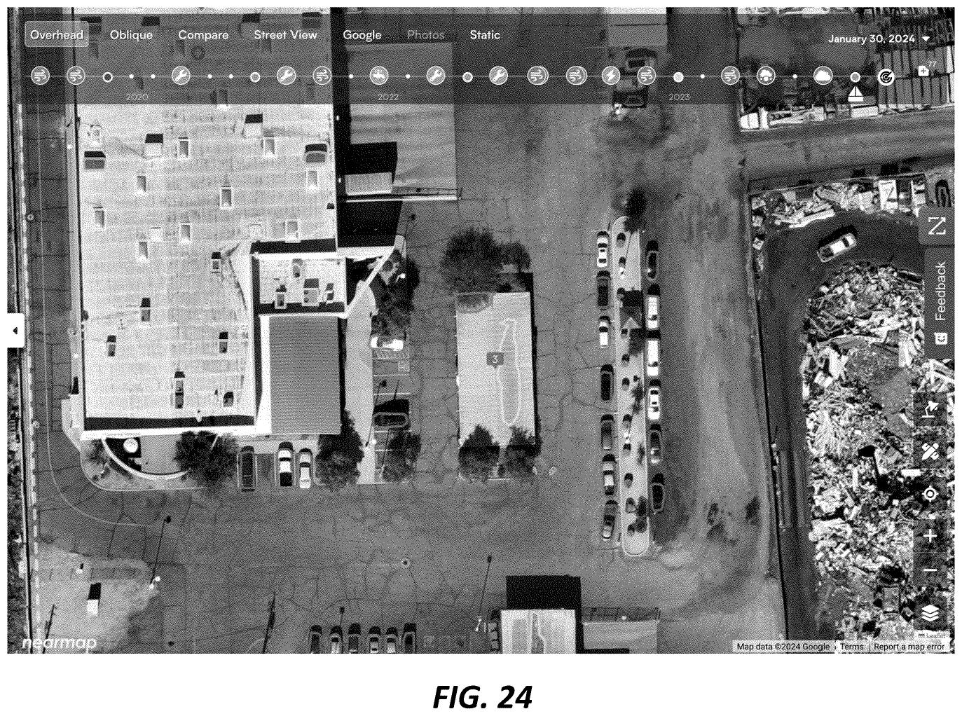

FIGS. 23 and 24 depict screen shots of a property including a several structures and a parking area. The raw image is depicted in FIG. 23, and AI detections are illustrated in FIG. 24. In this case, some of the detected items comprise automobiles. Also highlighted are areas of roof wear, roof objects, and areas of tree overhang where the AI model has estimated the roof edge. For example, referring to the covered car park in the parking area of FIG. 24, one end of the covered car park is obscured by tree overhang, whereas on the opposite side the AI model has detected the actual roof edge as the shadow in the image from the trees does not comprise a tree overhang.

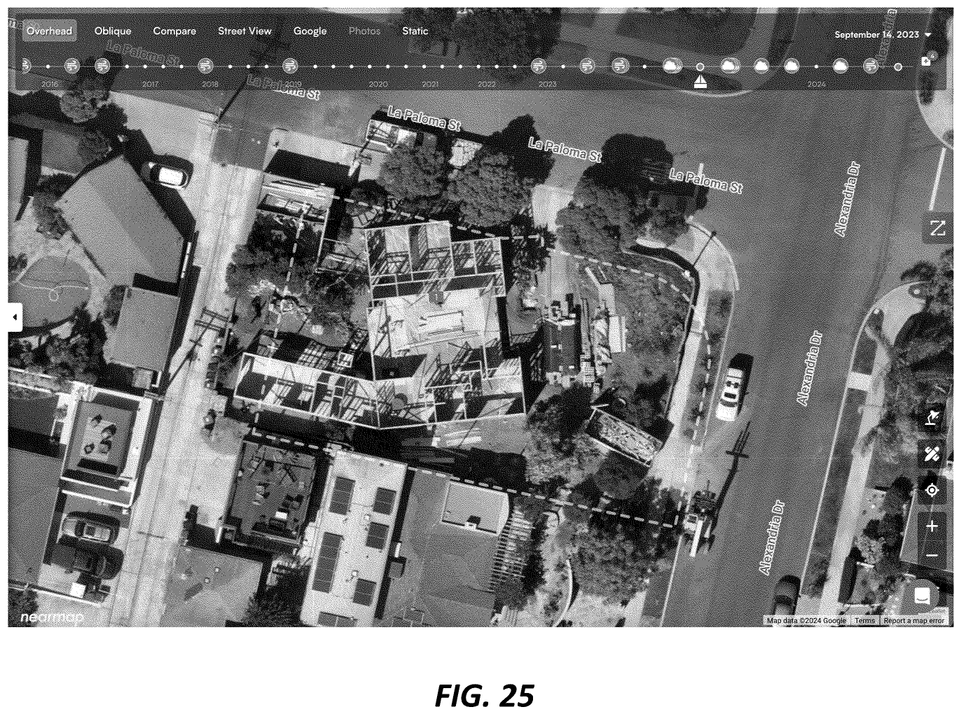

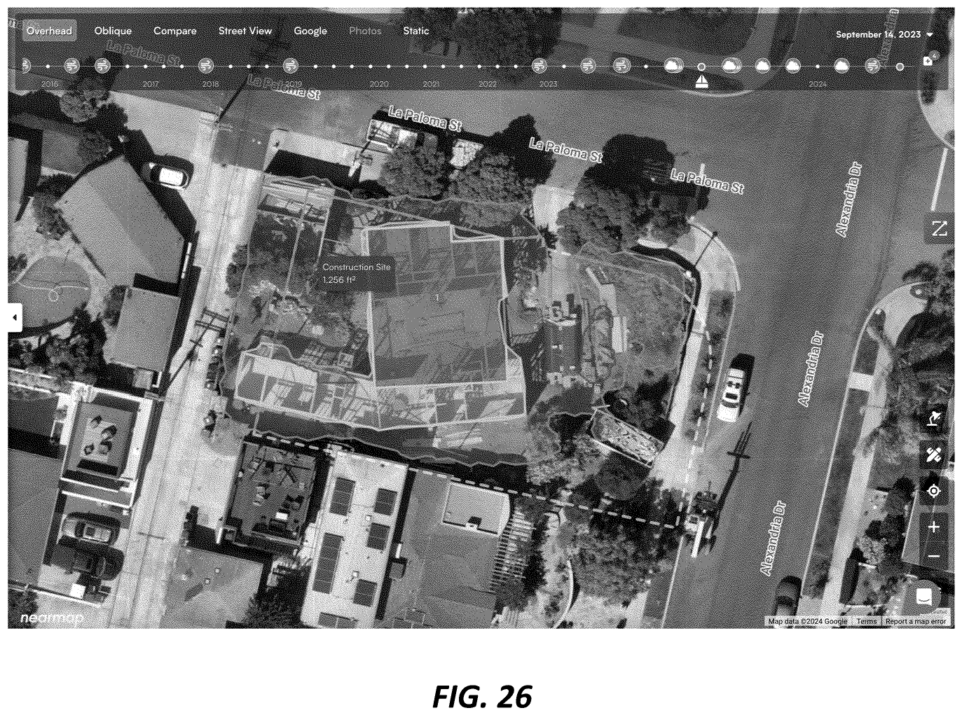

FIGS. 25 and 26 depict screen shots of a structure comprising a construction site. The raw image is depicted in FIG. 25, and AI detections are again shown in the subsequent image in FIG. 26. The AI detections in this case comprise detecting the area of a construction site. The AI model further estimates the area of the construction site, which in this example comprises approx. 1,256 ft².

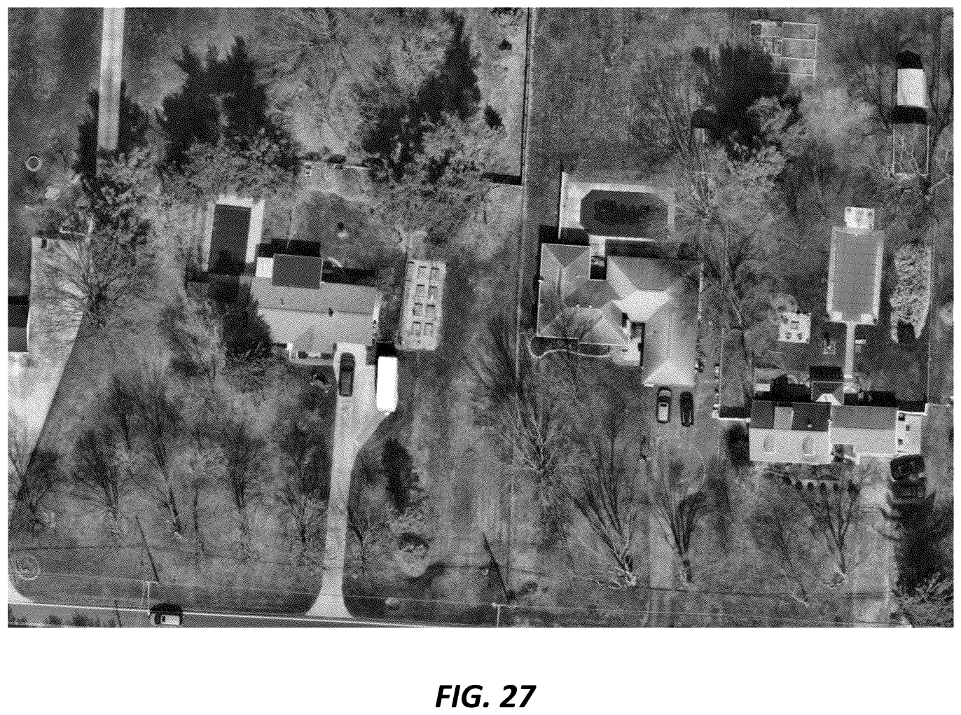

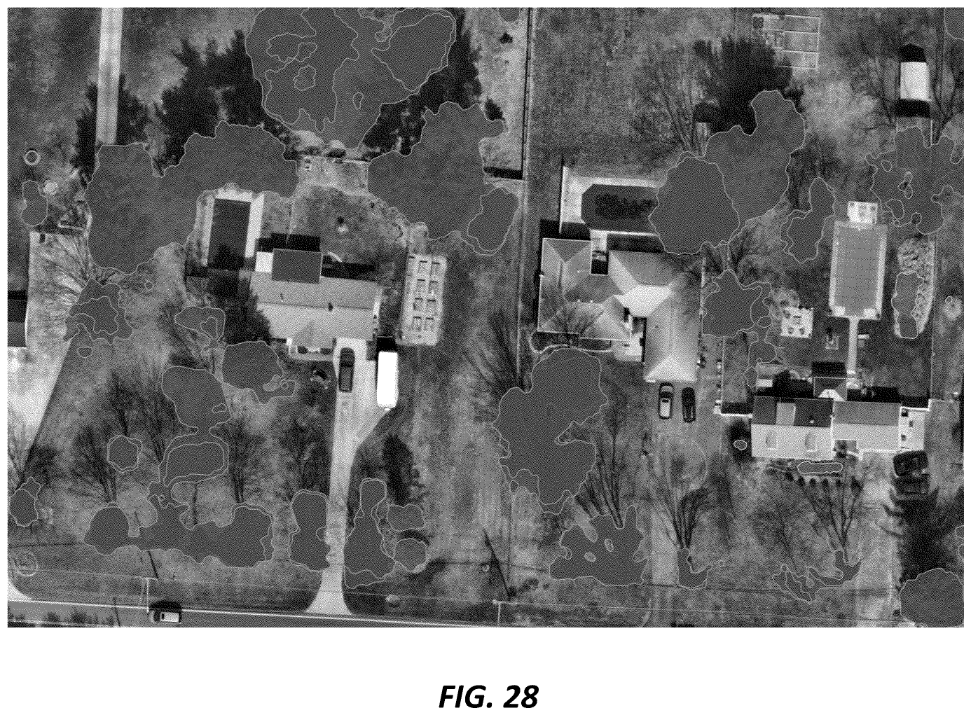

FIGS. 27 and 28 depict screen shots of showing tree coverage on a property. The raw image is depicted in FIG. 27, and AI detections are illustrated in FIG. 28. The AI model can discern between deciduous trees that have no leaves currently, and evergreens as indicated on FIG. 28. This is typically an exceptionally difficult detection due to the shadowing in the image. While the image is an overhead view, the shadows thrown on the surface of the ground due to the sun angle make placement of the deciduous tree detections challenging. However, the preprocessing of the images to generate vector layers and the analysis to create a confidence score has led to a process with very high accuracy (e.g., 97% accuracy, and an fl of 98.3%).

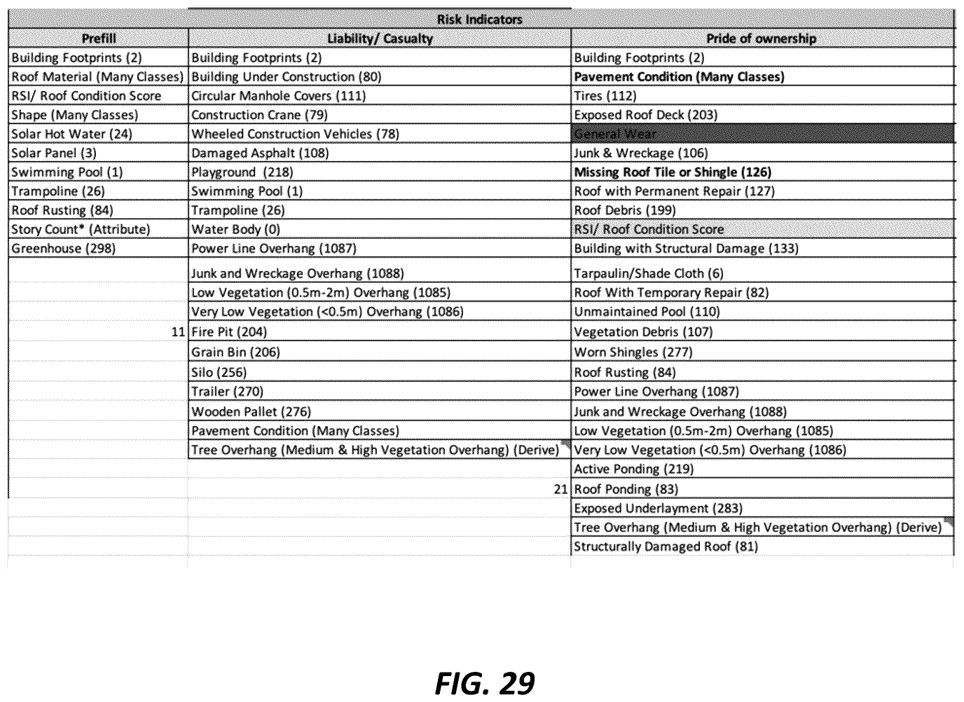

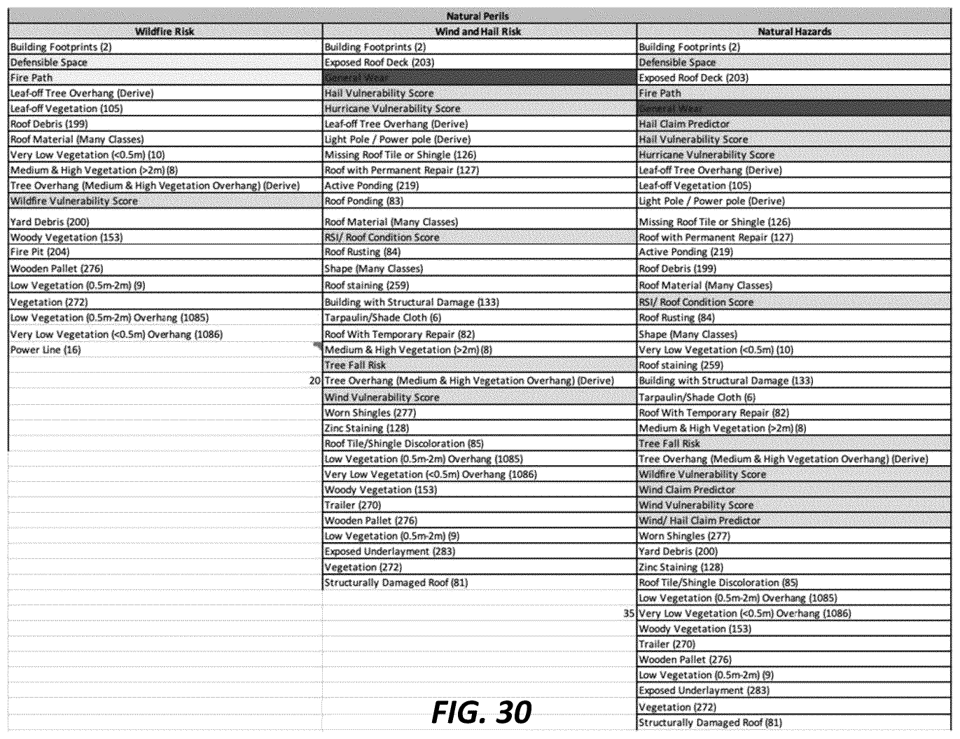

FIGS. 29 and 30 provide a consolidation of AI generated information for the user relating to Risk Indicators (FIG. 29) and Natural Perils (FIG. 30). The highlighted areas of the charts are AI-derived insights or scores as opposed to AI detections.

As was stated in connection with FIG. 3, only a few of the detection layers were illustrated for purposes of understanding the process flow for preprocessing. However, many detection layers may be provided. The following is an example of some of the many detection layers that can be used including: body of water, swimming pool, roof, building, solar panel, construction site, automobile, power pole, very low-low-medium-high vegetation, lawn, natural (hard or soft), concrete slab, asphalt, power line, road (drivable surface), tennis court, driveway, residential chimney, A/C condenser unit, residential TV antenna base, solar hot water, translucent roofing, trampoline, tile, shingle, metal, hip, gable, Dutch gable, shed, Gambrel, turret, light pole base, pedestrian crossing, wall, stop marking, raised car park, wheeled construction vehicles, construction crane, building under construction, structural damage, roof with temporary repair, roof ponding, roof rusting, tile or shingle staining, residential satellite dish, leaf-off vegetation, junk and wreckage, vegetation debris, damaged asphalt, letters and numbers, lane marker/line, arrow, turn lane, shoulder, bike path, unmaintained swimming pool, circular manhole cover, tires, wooden decking dormer window, natural pervious surface, hard surface, building, linear, arrow, block symbol, block character, painted lane, missing roof tile or shingle, roof with permanent repair, zinc staining, atmospheric occlusion, opaque, atmospheric occlusion translucent, building with structural damage, building with damage by tree, building structural loss, ballasted, mod-bit, PVC/TPO, EPDM, wood shake, woody vegetation, boat, roof debris, yard debris, duct, dumpster, exposed roof deck, fire pit, grain bin, heavy machinery, HVAC, missing asphalt shingles, nonwooden construction, roof patching, patio furniture, pipe, playground, active ponding, roof equipment, clay tile, slate, built up, roof coating, parapet, mansard, jerkinhead, Quonset, bowstring truss, roof walkway, shipping container, silo, skylight, roof staining, BV structural damage, trailer, vent, wooden pallet, worn shingles, cracked pavement, disintegrated pavement, repaired pavement, exposed underlayment, significantly stained pavement, miscellaneous roof object, greenhouse, tree overhang, flat roof composite, and building lifecycle (combination of roof, building, building with structural damage, building with structural loss and translucent roofing-want to capture a building in all lifecycle stages from construction to damage). These are just some of the various layers that may be utilized by the AI model.

One feature of the AI-based system 10 includes AI Packs. AI Packs are a way the AI-based system 10 groups AI layers with similarities (e.g., all layers relating to street detections). A user could request specific AI Layers or all layers within a specific AI Pack. A feature is an AI detection with a geometry, properties and in some cases attributes.

The True Ortho pipeline, including a deep learning model operating on True Ortho, DSM and DTM for Buildings, can provide greatly improved performance in areas with tall and complex buildings, such as downtown areas. The building layer is a semantic match for the new Building (Alpha) layer available in the standard vertical imagery processing pipeline.

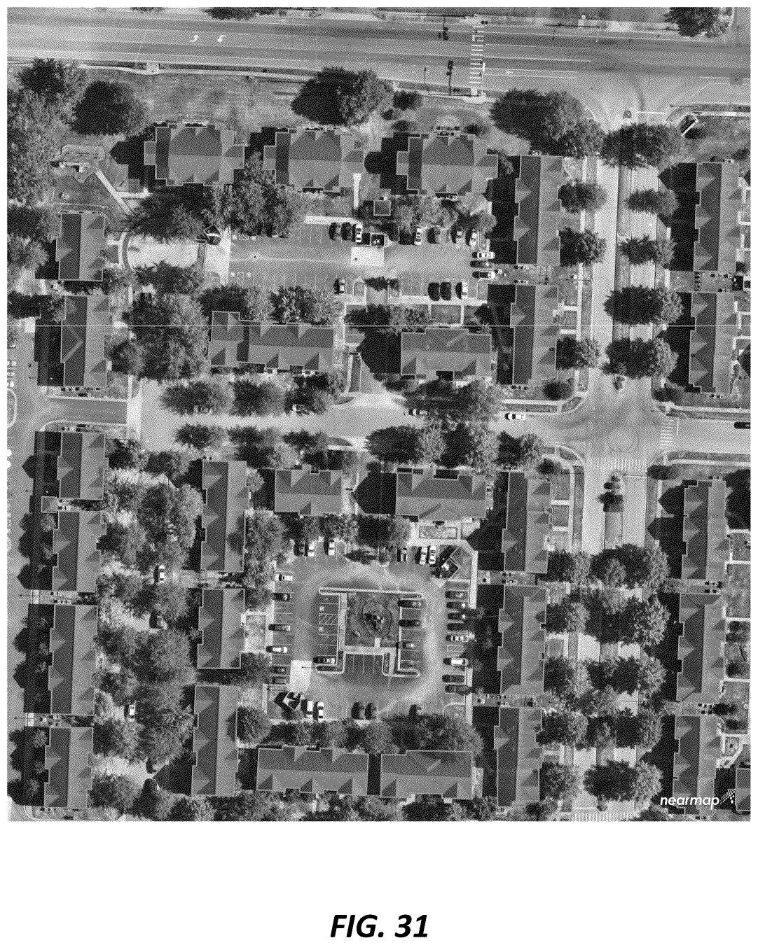

Referring now to FIG. 31, the enhanced building footprint algorithm performs additional processing to create features beyond the simpler approach in “Feature Extraction”. As shown in FIG. 31, it produces much more regular shapes with straight lines and right angles where possible, and is very robust to shadows, tree overhang, courtyards and a wide variety of shapes and sizes.

The custom designed machine learning algorithm involves observing a group of buildings, and inspecting multiple layers, including shadow and tree canopy. The aim is to balance polygon simplicity (i.e., identifying linear features which should be straight lines), while still representing a reasonable level of building complexity.

Fidelity score is an additional machine learning model that operates once the Enhanced Building algorithm has completed. It compares the polygon of each building to the raster probability predictions and estimates the quality of the outline. The score is returned in the 0-1 range. A score of 1 corresponds to sharp, crisp edges on the raster probabilities of the semantic segmentation, that are followed precisely by the Enhanced Building outline. Situations that degrade the fidelity score closer to 0 include areas of dense tree overhang, other occlusion or ambiguity, that cause areas of low confidence to be present in the raster predictions. Highly complex building footprints can also exhibit lower fidelity scores where the vectorization algorithm has failed to simplify the building outline correctly. The model is trained against human expert assessment of outline quality.

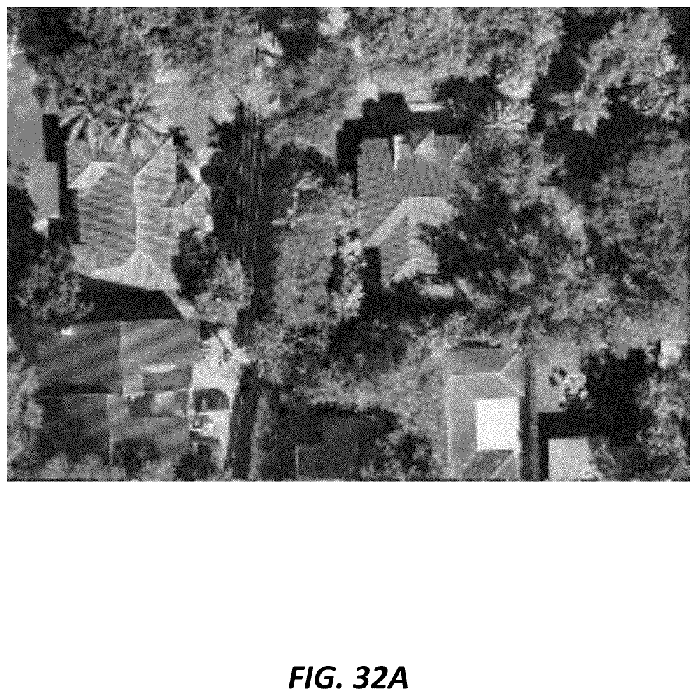

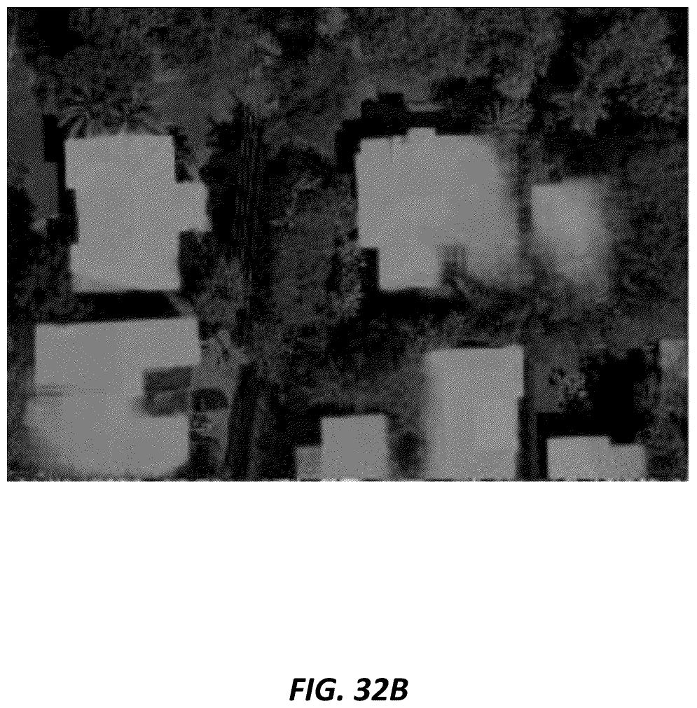

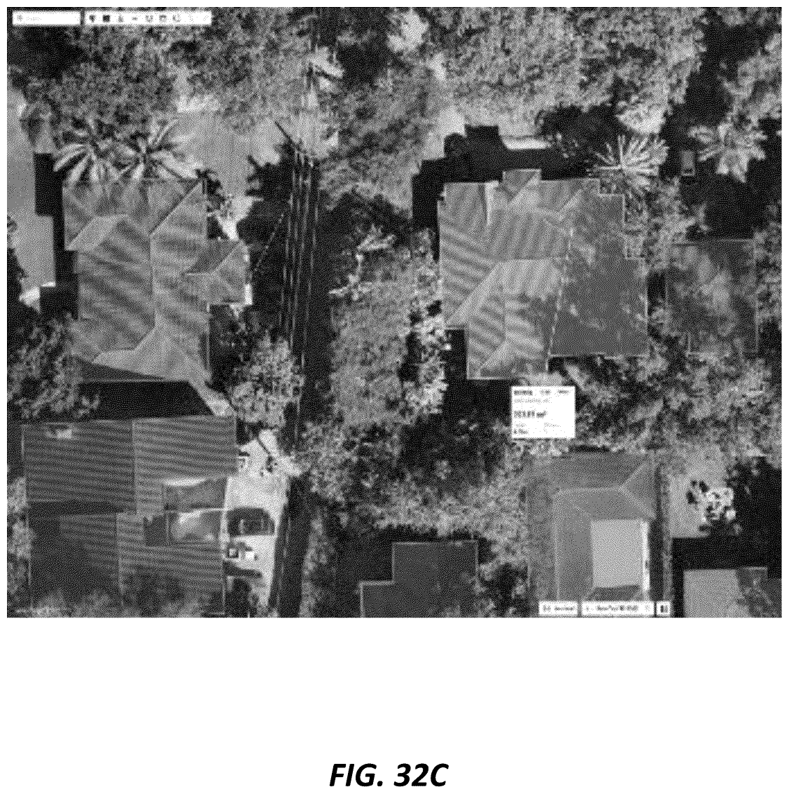

FIGS. 32A-32C show an example of a heavily shaded residential roof (FIG. 32A). The raster probability predictions are indicated in FIG. 32B, while the building outline is depicted in FIG. 32C. In this case, the fidelity score has dropped to 0.81, indicating a match that is of reasonable quality, but clearly imperfect.

The roof properties algorithm involves taking the feature extraction results for a wide range of layers and intersecting them with the Enhanced Building algorithm (on the roof layer). This intersection then results in two data types:
A polygon for each roof material, roof condition type, roof shape, tree overhang that is limited to falling within a particular roof. A parent/child relationship is present to facilitate linkages without requiring further geospatial operations.
Attributes attached directly to the roof feature include:
   “ratio” (fraction of roof covered by that layer)
   “area” (area of the layer within the roof)
   “count” (number of distinct polygons of that layer within the roof)
   “confidence” (the confidence attached to the building)

The 3D building and roof attribute algorithm operates on each enhanced building footprint. When a given survey has 3D mesh associated with it (a Hyper Camera 2 or 3 flight), for each building, the algorithm will:
Pull the relevant area of textured mesh around the building;
Identify the building in the mesh;
Calculate a local ground point estimate, that equates to the lowest point within a short (e.g., 10 meter) perimeter of the building, that does not fall in a semantically inappropriate location (such as a swimming pool).

The real-time algorithm calculates the amount of various layers present within buffered distances of a particular building.
A geospatial “buffer” operation is calculated at a set of fixed differences from the roof outline.
An intersection is performed between each buffer, and a variety of vectorized layers.
Summary attributes relating to count, area and ratio of intersected features are attached to the roof for each layer (as per the same intersection algorithm as “roof properties”).
Calculated attributes include the full interior area of each buffer (including the building itself). This means areas should always be higher for larger buffers (as they represent cumulative areas). Counts may increase or decrease, depending on how polygons have been cut by the buffer.

Buffer distances are configured within the API, and include distances such as 5, 10, 30, 100 and 300 feet. The set of classes used for buffer calculations extends beyond the typical “defensible space” set used for fire risk (buildings and trees), and can include layers such as: Roof, Wooden Decking, Swimming pool, Junk and wreckage, Vegetation debris, Power pole, Light pole, Power lines, Tree Canopy, Shrub (low vegetation), Brush (very low vegetation), Leaf off vegetation, Body of Water, and the like.

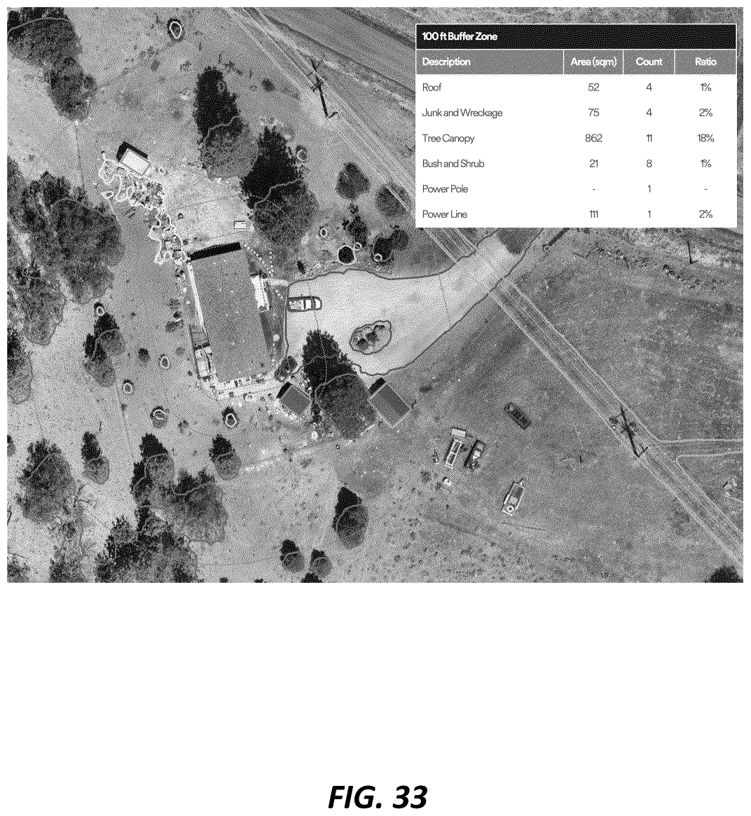

An example of buffers is illustrated in FIG. 33, where several of the layers are present. The pole centroid algorithm takes the power pole and light pole vectorized feature classes as inputs. These typically appear as small blobs, denoting the area where semantic segmentation identified pole base or head. The centroid algorithm performs several operations:
Merging both layers into a single pole class
Identifying the centroid of the pole class (as a point, rather than a polygon)
Appending attributes to the pole for separate light and power pole confidence, as well as an overall pole confidence.

Pool Properties use the same underlying intersection algorithm as Roof Properties, except the “swimming pool” feature class is taken as the base layer for the intersection, and the “unmaintained pool” layer is used as the condition (like a roof condition layer). In the same way, both the vectorized feature of the area of unmaintained pool and the pool itself are made available, as well as attributes being appended to the pool feature on confidence, area and ratio of the unmaintained pool.

Real time models are executed on a property, feature or area of interest in response to an API request. They operate by reading the pre-calculated content from a particular generation of the AI system, a range of other data assets, and serving up higher-level analytical model results. This structure permits the slower, more expensive deep learning from imagery assets to be performed in advance, with lighter weight calculations happening at the time of request.

The Roof Condition Summary Score is a summary of the physical condition of a particular roof at a particular point in time. It is designed to help assess whether a roof is fit to be insured and given its current condition how it may be affected in case high winds, hail, or other catastrophic weather events occur. The score is calculated on a per-building basis, with raster and vector AI layers from the Roof Condition and Roof Characteristics AI Packs as input. It is represented by an integer roof condition index (0-100), which is further broken into five ordinal buckets (Very Poor, Poor, Fair, Good, Very Good).

Labelling is performed with a Labeling Tool. A web-based application is provided as part of the system that is designed to facilitate users' exploration of the system's visual content, as well as measure, draw and annotate for a wide variety of use cases. This web-based application covers all content types-2D photomaps, 3D meshes, Digital Surface and Terrain Models, oblique source imagery, and ability to explore spatially and temporally. Various backend processes allow the management of labeling jobs, assignment to users, aggregation and error checking of results, and ultimately combining labels for over a hundred classes into a single unified training/validation/test data set for machine learning.

Labelling can be performed on any content types, and falls into two fundamental types:
Vector Polygon labeling permits the drawing of shapes representing the outline of each instance of an object.
Pixel accurate point labels on a regular grid permit efficient, pixel accurate labeling of large areas where discrete instances may be difficult to outline.

The core tenet of the labelling methodology is to label the truth on the ground. This is fundamentally different to most image labelling strategies, in which an image is labelled in isolation, for what is reasonably observable in that image by a human. Instead, labeling is directed to what object is physically present. To achieve this, multiple dates on a location should be observed, at multiple angles, and even external location data should be weighed to determine what is most likely to be physically present. Practical examples of this include:
Labeling swimming pool and building outlines as fully as possible, despite occlusion by overhanging trees.
Subtle differences between a tile and shingle roof may not be clear in poorer lighting conditions, but are clear from other dates, or observing street level imagery.
If with all available evidence, it is still unclear what the true object on the ground is, then a “don't know” is applied rather than assuming the object definitely exists/doesn't exist).

Much of the body of commercial and academic work applying machine learning to imagery assumes that there is a valid and correct ground truth against which to compare results, and that a human expert label on the image is a good representation of this. In the practical deployment of machine learning on aerial imagery, this is not the case. Firstly, the reference point must be considered: it needs to be determined if the ground truth is what is visible in the image (not occluded) or what is physically present. Also, the date the observation is referenced against must be determined. The exact definition of an object must also be determined (e.g., is a rooftop car park or basketball court still a roof?). Next, the precise, fundamental definition of a given object (such as a swimming pool) must be determined. Given the accuracy with which deep learning models can mimic consistent human expert labels, the corner cases are critical to define consistently and have a large impact on perceived model performance.

The visible truth (in an image) is most amenable to pixelwise labeling with human experts; given an image, label every pixel in an image which is visibly represented by a class (such as “roof”). This simplicity increases the reliability of the labeling and reduces the expense of the labelling task. However, the visible truth is particularly unhelpful with aerial imagery. Many objects of interest such as swimming pools or lawns are frequently occluded by trees, shade cloths, overlapping parts of buildings, awnings and more. If the use case involves calculating the area of lawn for a landscape gardener or identifying the extent of a roof that is covered by tree, the visible truth is largely irrelevant. To assess fitness for purpose, it is necessary to both train models, and assess their performance against the physical ground truth, what is physically present at a location. While it is often not possible to assess physical ground truth accurately from a single image, a sufficiently rich and diverse set of remote imagery (from multiple angles, and at multiple time points) means that a human expert can identify physical ground truth with a high degree of reliability.

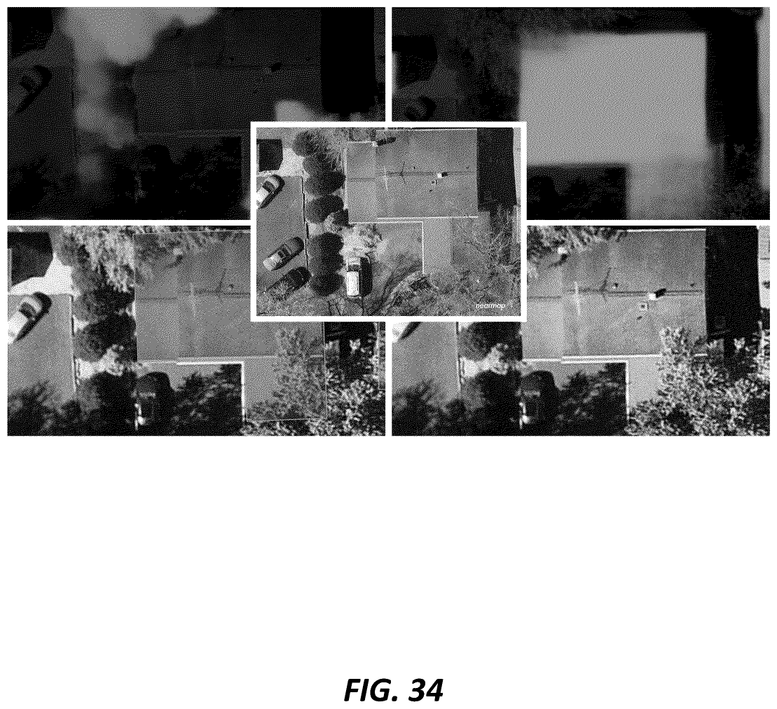

When machine learning models are trained against physical ground truth rather than merely visible truth, there is a very interesting emergent property that is particularly useful. In the case of the AI semantic segmentation model, it becomes possible for the model to make reasonable estimates about the presence and extent of an object despite occlusion. For trees and roofs, the model can express high pixel confidence for roof presence in locations that are covered by dense foliage, due to the contextual cues of an incomplete roof that clearly continues under the tree. As the extent of overlap increases, the model reduces certainty in expectations in a similar manner to a human visual assessment from the image, with high uncertainty in areas of deeper overhang. The result of this is that the intersection between the roof and tree classes can accurately estimate the extent of tree overhang on a single image, as depicted in FIG. 34.

As far as model assessment goes, the distinction between Visible and Physical Ground Truth becomes even more important. The measure that matters to end users is clearly Physical Ground Truth, rather than Visible. By way of example, if the quality of a satellite image-based swimming pool detection algorithm is assessed against single image labels for which the satellite data is used for assessing Visible Truth, the results will be extremely optimistic. Pools in deep shadow, extensive overhang, or with covers or unusual colors are unlikely to be noted by the human expert on the lower resolution, lower quality imagery (compared to aerial imagery). As a result, the properties with the pool will be marked by both the algorithm and the human expert as “no pool present”, and the example given as correct.

The AI system is backed by an ontology system that manages definitions. It includes programmatically accessible fields such as base definition, labelling instructions, inclusions, exclusions, example images with correct annotation.

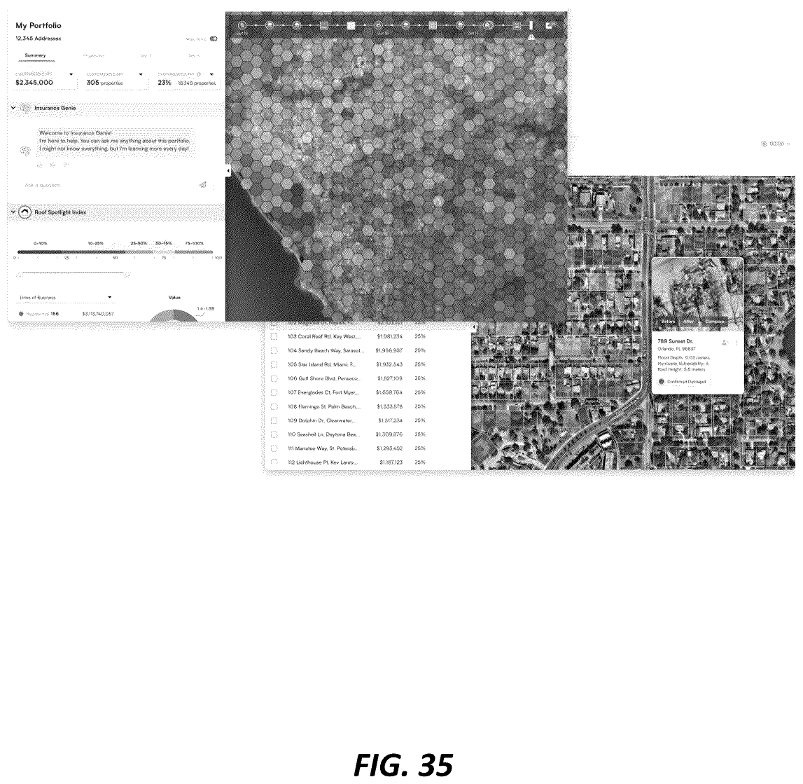

Referring now to FIG. 35, two screen shots are depicted where the AI system allows for viewing/filtering an entire portfolio of properties that, in one configuration, is aggregated into hex bins (foreground image) and relates to a Roof Spotlight Index. This allows for an interactive experience (e.g., the ability to drill down into regional views to isolate individual properties-background image). This can be used by an insurance company to better understand portfolio risk, which can enable the company to take actions to establish moratoriums (flags) based on desired accumulation exceedances.

For example, as indicated in the background image of FIG. 35, an overhead view of properties that are insured by the insurance company are depicted in the geographic area selected by the user. Hovering the cursor over a property will bring up a window of information on that property including specifics related to the property. Additionally, a listing of properties in the geographic area is provided on the left side of the screen listing the address, the property value and other relevant information to the property. Each listed property has a check box such that the user can click on the box and receive additional information for the property. It is contemplated that each property in the overhead view could have an indication related to the risk calculated for that property. In one configuration, the indication could comprise a color coding. Alternatively, it could comprise a number coding, or other indication.

In the foreground image a Roof Spotlight Index chart is shown with a coding index extending from 0-100% with 0 representing a lowest score a roof could receive and 100 the best score.

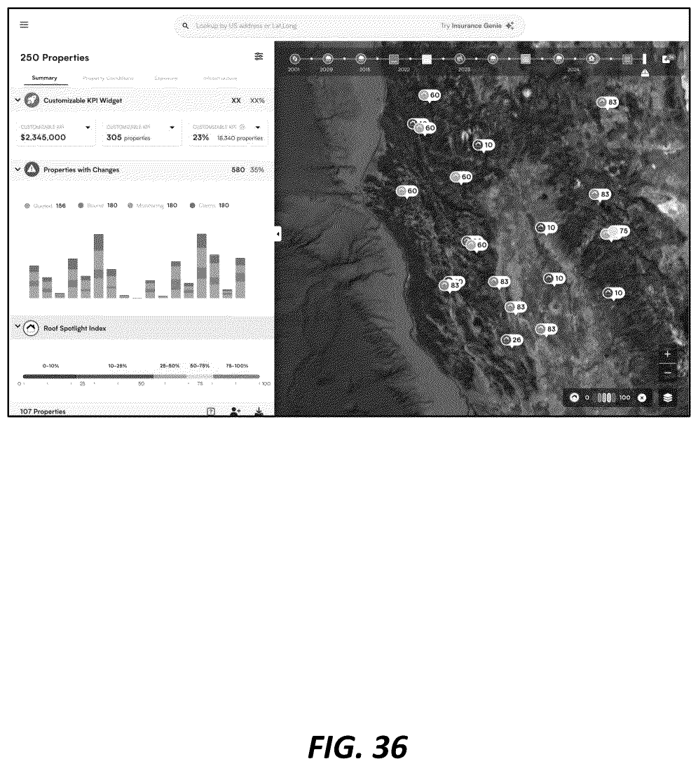

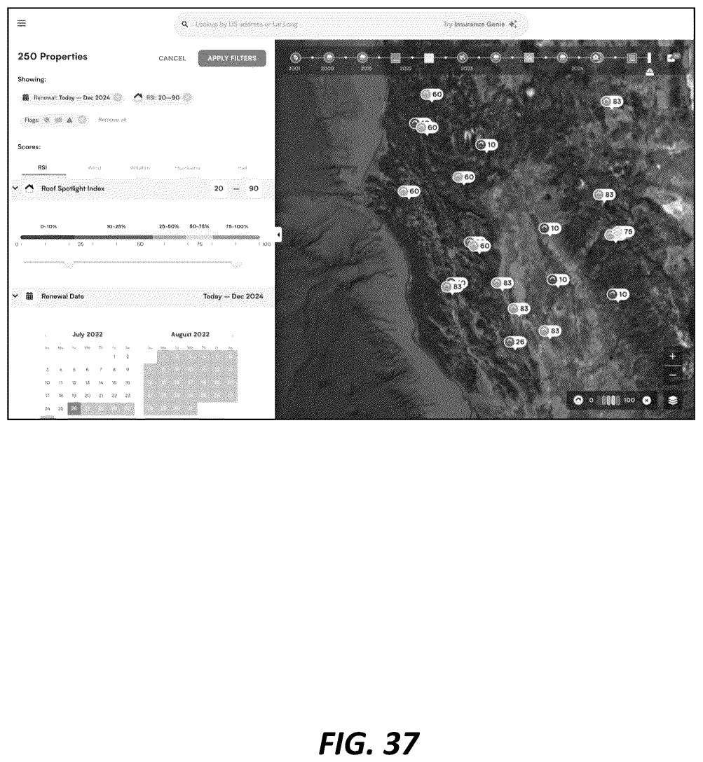

As illustrated in FIGS. 36 and 37, screen shots illustrate how zooming out reveals a regional view. The system provides filter properties for export and to view aggregates. The customizability of the system allows for custom UI configuration and for custom visualizations.

In FIG. 36 a listing of Properties with Changes is provided listing the number of properties with changes along with the percentage of properties that changed relative to the portfolio, with a graphical illustration of the changes including, Quoted properties, Bound properties, Monitoring properties, and properties with Claims. These are aggregated into tabs on a map of the geographic area (shown to the right of the screen shot), which when a cursor is hovered over a tab or clicked on, additional information is provided such that the user can drill down to receive more specific information related to properties grouped into that tab.

FIG. 37 illustrates additional information available to a user including, RSI (clicked on and indicated on the screen shot), Wind risk, Wildfire risk, Hurricane risk, and Hail risk. Also shown is a calendar showing a policy renewal date for a property. Again the Roof Spotlight Index can be indicated by a visual indication such as, color, or number, or the like.

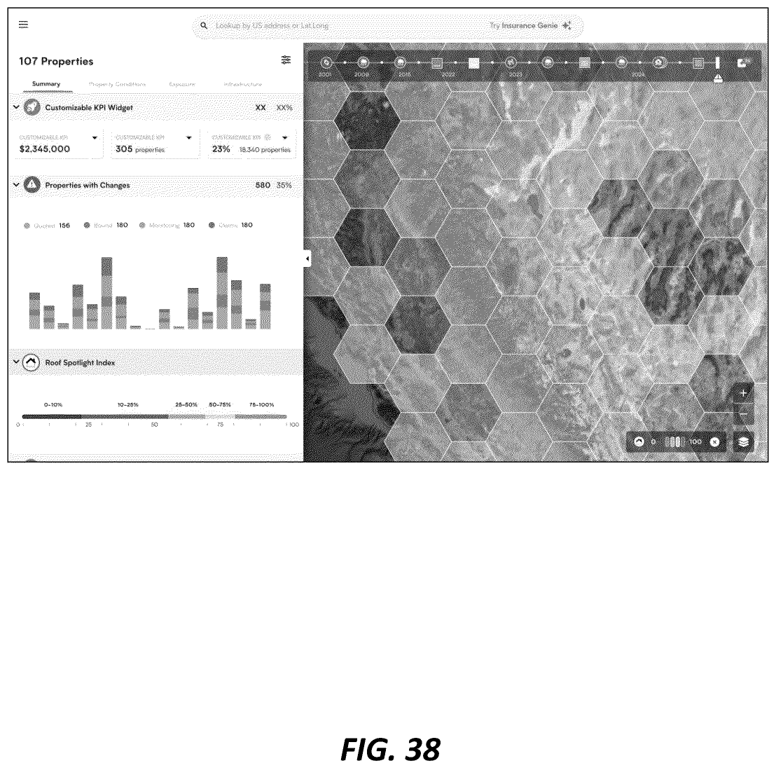

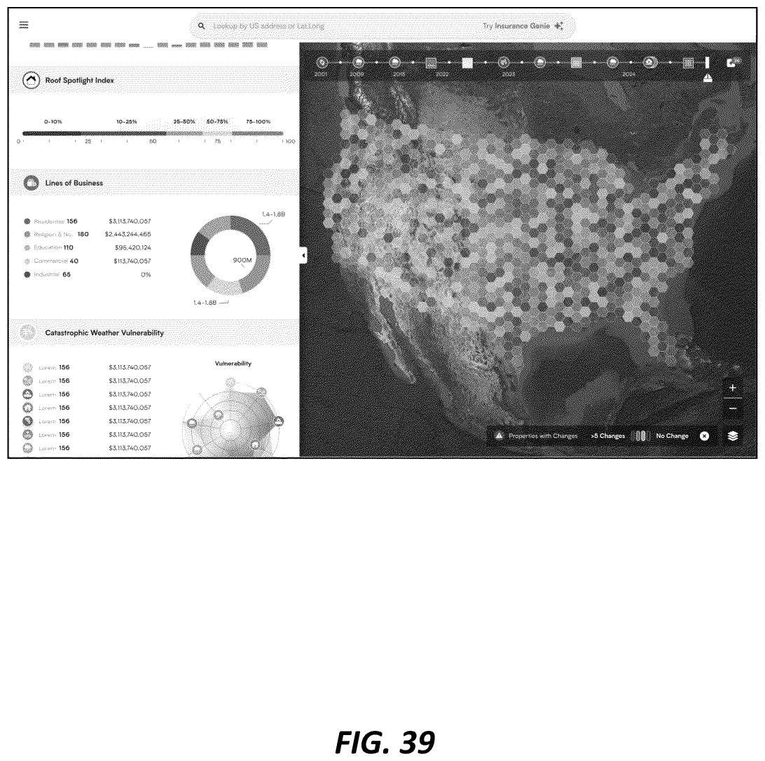

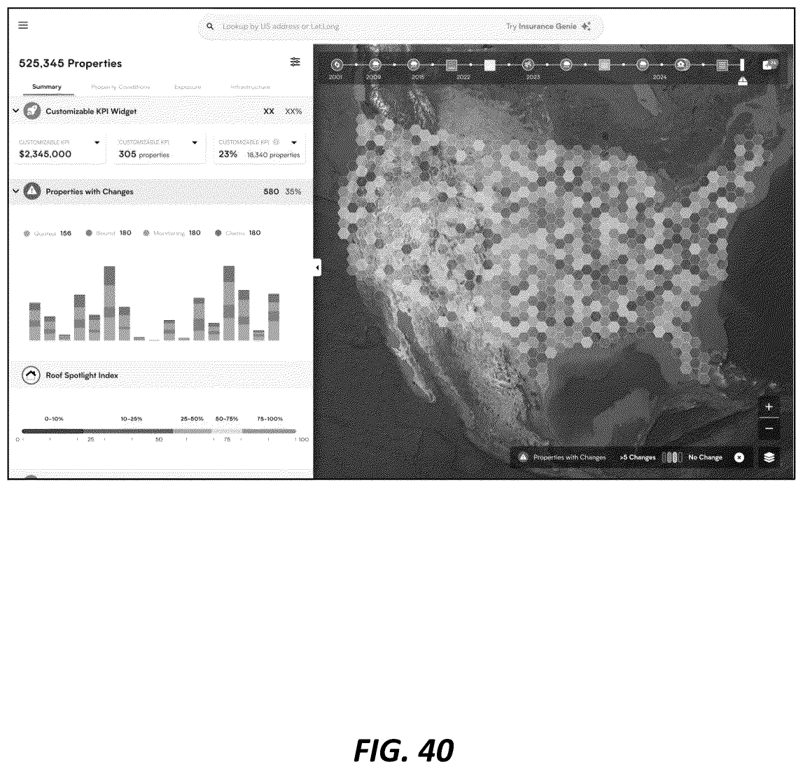

FIG. 38 is a screen shot of the customizable Key Performance Indicator (KPI) Widget that includes charts, graphs, listings and a visual indication on a map. FIGS. 39 and 40 provide a wide view of the entire contiguous United States again showing Roof Spotlight Index. FIG. 39 shows a variety of data presented relating to Lines of Business and Catastrophic Weather Vulnerability including indications on the map, which may take the form of color or a number or other indication. FIG. 40 shows the Customizable KPI Widget showing properties with changes including listings of data along with bar graphs.

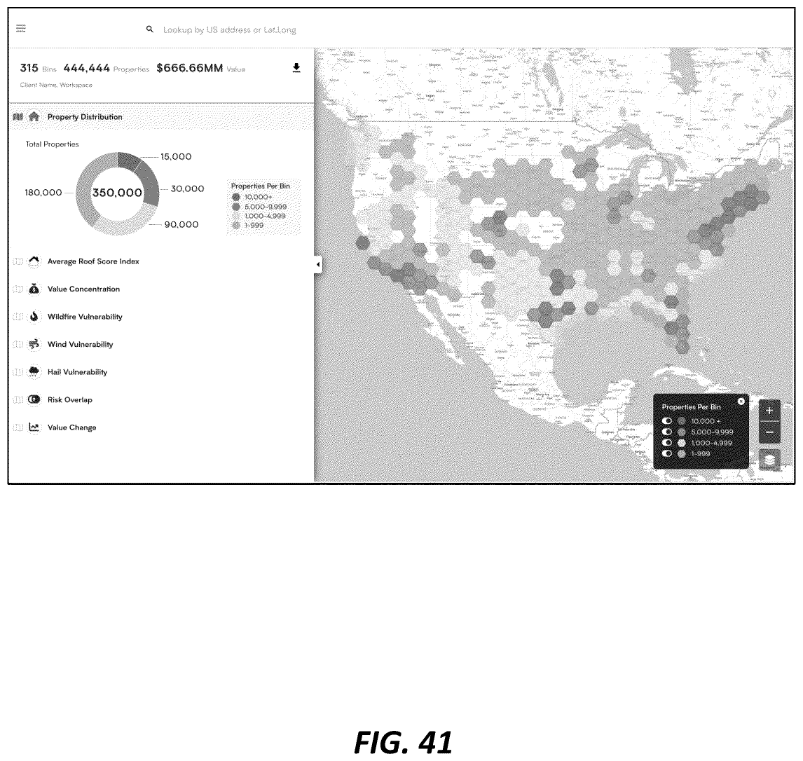

FIG. 41 is also a screen shot showing the entire contiguous United States listing Property Distribution and indicating this on the map via a color code. On the left is a chart showing the total number of properties and a coding for the distribution shown on the map. Also shown at the top on the left is the number of Bins, the total number of properties, and the total value of the insured properties. A listing of several data categories is provided including: Average Roof Score Index, Value Concentration, Wildfire Vulnerability, Wind Vulnerability, Hail Vulnerability, Risk Overlap, and Value Change. Any of the above-listed data categories can be checked to drill down into those categories.

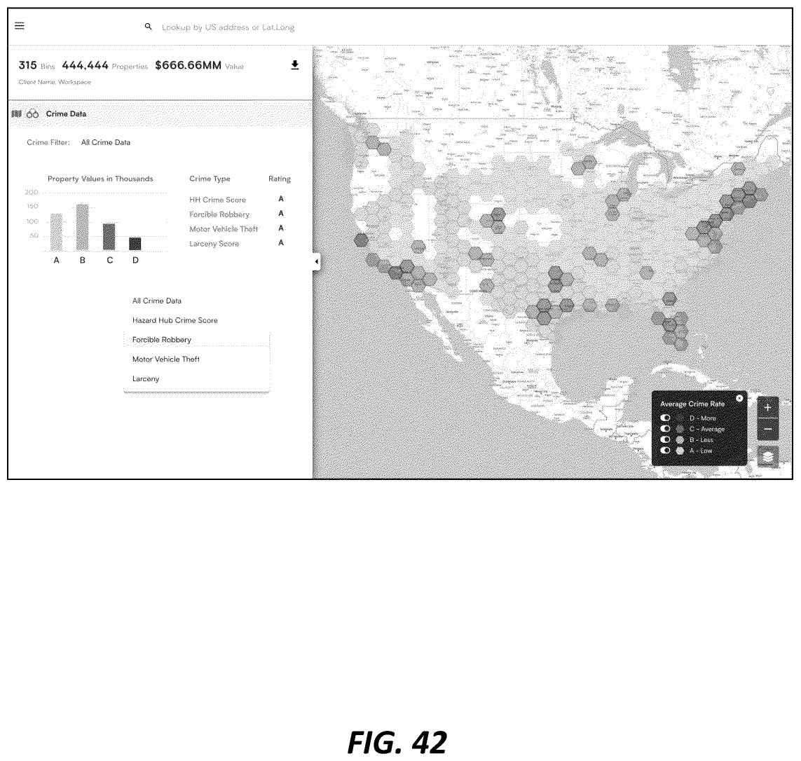

FIG. 42 is another screen shot showing the entire contiguous United States listing Crime Data with indications (letter grades) associated with Average Crime Rates. A graph depicting property value relative to grades is shown. Crime Type (e.g., Hazard Hub Crime Score, Forcible Robbery, Motor Vehicle Theft, Larceny Score, and the like) is indicated and shown on the map.

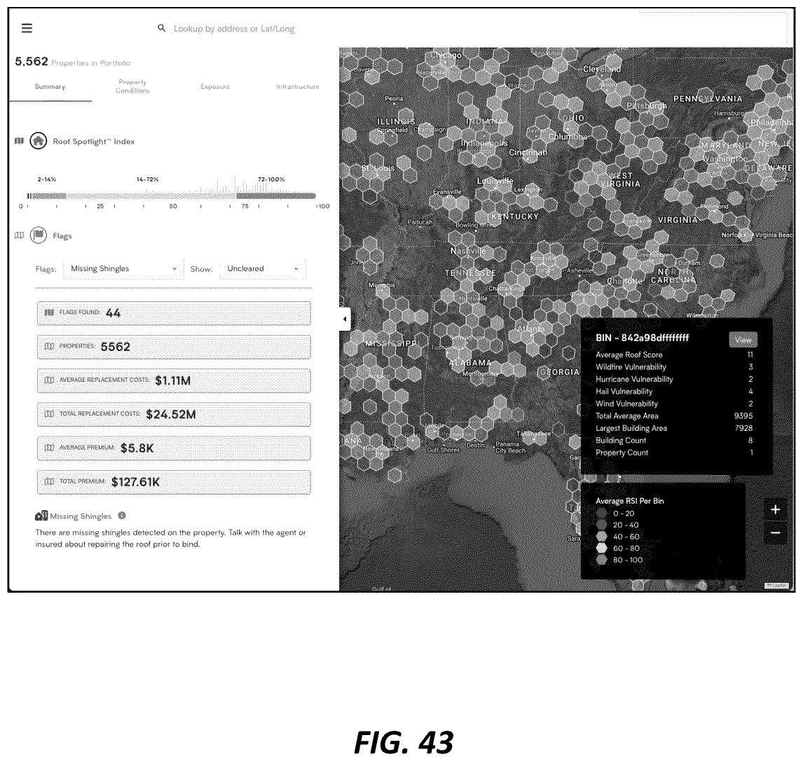

FIG. 43 is still another screen shot showing a portion of the United States again showing the Roof Spotlight Index. The data presented is fully customizable where here, Flags Found is shown along with the total number of properties for the selected geographic area, the average replacement cost, the total replacement cost, the average premium and the total premium. Flags indicate identified problems with a property. For example, the system indicates for the identified property there are “Missing Shingles” and the user is prompted to “Talk with the agent or insured about repairing the roof prior to bind.” Pop up windows are also show in the screen shot where hovering a cursor over an area will bring up summary information on that area such as, Average Roof Score along with listings of various vulnerabilities and other data.

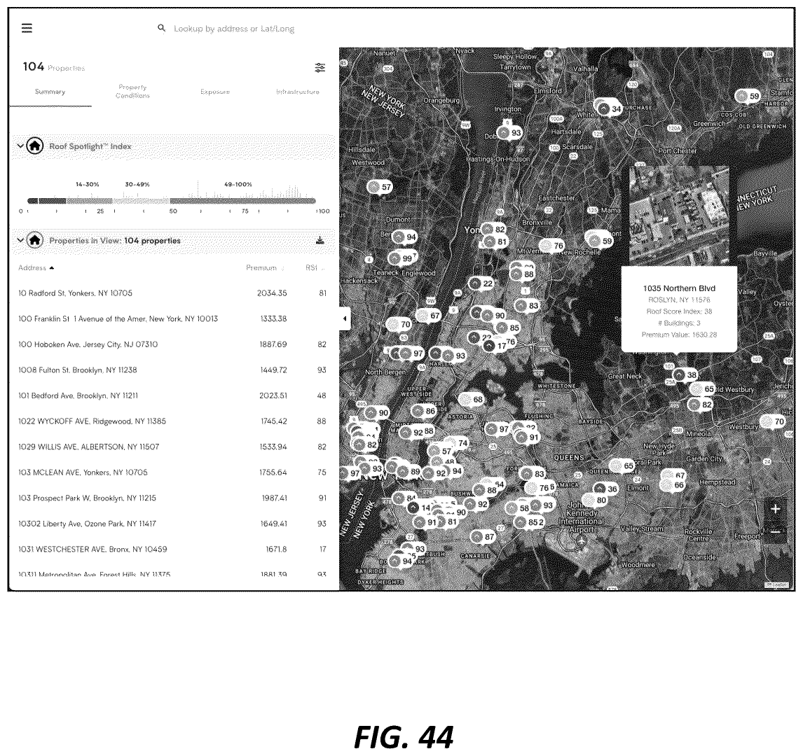

FIG. 44 is a drilled down view of the New York City area showing tabs of property groupings, which can be hovered over to pop up further information or clicked on to drill down into. On the left various properties are listed by address corresponding to the selected geographic area, with the premium per property paid along with a RSI score for the property.

As seen in reference to FIGS. 35-44, the system facilitates users to search globally for properties that exhibit X or Y criteria for use by the user. This could be used by policy holders to obtain a transparent view of their property and the criteria used to grade it. This could be used to aid the policy holder how to lower their premium by making changes to the property. Alternatively, the system could be used by insurance companies to check on a property, or generate leads, or view compliance with changes the policy holder has submitted were made to the property. The system is fully customizable allowing for significant zooming in/out to view an entire property portfolio. Interaction with the left panel allows for viewing portfolio accumulations by Key Performance Indicators. Additionally, the system allows for extended feedback for the AI model, allowing users to delete polygons, create new ones and create general reports on AI outputs.

Scalable processing system. It may be desired to obtain insights or actionable intelligence based in part on geospatial data corresponding to a parcel of land. For example, an owner of the parcel of land may have entered an insurance contract covering some property on the parcel of land and may want to inspect the parcel of land. Another user may require insights or actionable intelligence for a larger region such as a suburb, town, city or county. Other users may require insights corresponding to a set of specific properties, for example a portfolio of properties covered by a particular insurance policy or provider.

A need exists for a system that can efficiently generate geospatial data that can be used to derive insights or actionable intelligence corresponding to specific locations and dates using an expandable set of processing techniques and data sources such as aerial imagery. Such a system is particularly challenging to build when the processing techniques are based on multiple sub-processes and depend on multiple data sources with different geographical and temporal coverage. The systems described herein advantageously use several conflation processes to combine intermediate results of sub-processes, reusing previously calculated results where available in a highly efficient manner. The systems advantageously minimize system latency, processing time and cost, and memory usage, and store intermediate and final outputs in an efficient structured format that is suitable for networked storage such as Amazon s3, Google Cloud Storage, Azure Blob Storage, DigitalOcean Spaces, and the like. They also preserve the consistency, reliability and accountability of generated outputs. Accountability may be provided through relevant samples of input data that were processed to generate a particular output such as original source image data, and the like.

Aerial imagery may be stored in a suitable tiled structure, for example in a tiled web map format (e.g., based on web Mercator tiles at zoom level 18 with 256 by 256 pixels). Aerial imagery may be grouped according to the date range and coverage region. For example, a survey ID may be used to define the images captured around a particular date that cover a region of interest such as a city, town, suburb, state or other regional descriptor. The aerial imagery associated with a survey may be captured using a single or multiple aerial imaging systems and may correspond to a range of times of day. The aerial imagery for a survey may be processed to generate suitable photomaps such as vertical photomaps, oblique photomaps (referred to herein as panoramas), and 3D representations such as 3D mesh, digital terrain models (DTM), digital surface model (DSM) and the like. In addition to the geospatial information corresponding to a tile (it's location, size, zoom level, and coverage on the ground), each tile data may be assigned an identifier based on the type of data (e.g. vertical photomap or North panorama, and the like) and a date associated with the capture (e.g., the survey date). The identifier may take the form of a hash code.

Geospatial data may take many forms and may be stored in a variety of formats including raster, vector, text, table, list, dictionary and other.

A first type of geospatial data (e.g., a feature) may be a model of something that exists in the world. These can be discrete things such as, a roof, a power pole, or a swimming pool or connected like vegetation, a drivable surface, or a water body.

A second type of geospatial data (e.g., a geometry) may be a digital representation of the shape of a feature. For example, a geometry may comprise a point, a line, a polygon, or a 3D model such as that produced by CAD. A geometry may be a 2D object, for example, it may be a geometry on the ground. A geometry may represent a single point in time (e.g., a polygon drawn on a single image), or may be the digital representation of the feature for a timeline (e.g., derived from multiple images from multiple dates of the same thing in the world).

A third type of geospatial data (e.g., an attribute) may comprise data or metadata. An attribute may correspond to features and/or geometries. An attribute may be determined for a point in time (e.g., the amount of staining on a roof at the time that an image way captured, the condition of the roof at that time, or the dirtiness of a swimming pool). Alternatively, it may be determined for a time range (e.g., the ID of the feature that persists over time, the height of a building, the pitch of a roof, or the type of roof material). An attribute may be an event (e.g., the installation date of a roof, the construction date of a building, damage resulting from an event such as a storm or fire). An attribute may further be a trend or rate of change at a point in time (e.g., the rate of change of Roof Score Index). An attribute may be a prediction of the future (e.g., the remaining life of a roof, the likelihood that a roof is replaced in some number of years).

Relationships may exist between and among features, geometries and attributes. These include parent/child relationships such as ontological relationships between features. For example, a roof staining feature is a child of a roof feature. The ontology allows for loose relationship definitions. For instance, some roofs are children of a building, but others are not (e.g., a covered bus stop). Additionally, solar panels are often children of roofs, but may also be stand alone on the ground.

Pipelines. The systems described herein can employ one or more pipelines to generate specific required geospatial data outputs such as features, geometries and/or attributes. A pipeline can comprise a set of sub-processes in an architecture that may be represented by a graph structure, for example a directed acyclic graph (DAG). Each sub-process may produce intermediate geospatial data that may be input to a later sub-process in the graph structure. A sub-process may be used in many different pipelines and some (or all) of the geospatial data outputs generated may be advantageously stored and reused to improve the performance of the system in terms of processing, memory usage, storage and latency.

The sub-processes of a pipeline can include tile-phase subprocesses that process data specifically limited to a tile. The sub-processes can further include merge-phase sub-process methods that process data that spans multiple tiles. Higher order pipelines can be composed of one or more tiled-phase and one or more merge-phase sub-processes. Such pipelines typically perform tile-phase subprocesses in the earlier stages of the graph architecture, then merge-phase sub-process in the later stages of the graph architecture.

The orchestration of the sub-processes between tiled-phase and merge-phase of a pipelines is controlled by the system at a high level. Further, the system can run multiple pipelines concurrently, each generating geospatial data outputs corresponding to the same and/or different survey regions.

The system may advantageously use an identification system as part of the management, data flow and storage of geospatial data generated in each sub-process. For example, each sub-process may generate an identifier for the geospatial data based on multiple identifying factors such as the input data sources used and the precise configuration of the sub-process used to generate it. The configuration data used in the hash code may include a version number of the algorithm, thereby advantageously allowing the management of generated data while improved algorithms are developed and deployed.

The identifier of a sub-process may be a hash code generated from these identifying factors that may be used as an identifier for storage and retrieval of the data. The identifier may be used as a prefix that defines a path on a networked storage system where the geospatial data is stored. The path to file storage for specific geospatial data content may further be defined in terms of the geospatial information of the tile. For example, the identifier may define a top-level directory, within which sub-directories may be defined based on geospatial information, for example the zoom level and the coordinates of the tile (e.g., as x and y coordinates).

In one example, a first sub-process that inputs aerial image tile data may build an identifier based on the identifier associated with the tile and the sub-process configuration. A second sub-process that inputs geospatial data generated by another sub-process may build a identifier based on the identifier associated with the input geospatial data in addition to the configuration of the sub-process. A third sub-process with multiple geospatial data inputs (that may or may not include aerial image tiles) may build an identifier based on an ordered set of input geospatial data identifiers in addition to the configuration of the sub-process. Each of these examples may use a hash code to generate the identifiers and can store generated geospatial data in networked storage based on a prefix that is built from the identifier and a sub-directory structure based on geospatial information for the output geospatial data (e.g., zoom level, location, and the like). The hierarchy of identifiers and data storage may be advantageously managed using a Merkle tree approach, and the system may benefit from a significant amount of data reuse if, for example, two different pipelines ask to process the same tile.

Each tiled-phase sub-process can be performed in parallel, for example, as a batch on multiple processing resources. Algorithms in this regime may operate on “partial” data in the sense that, for example, a roof may span multiple tiles, and the tile-processing methods must be capable of working with only a partial section of the roof at a time. Tile-phase processing may generate semantic segmentation with labels, polygons, (e.g., ‘enhanced’ outlines of roofs and buildings using a deep learning model and a series of geometric operations).

The system can also perform merge-phase sub-processes for which data is processed that corresponds to regions outside of a single tile. Such merge-phase sub-processes may be advantageous when objects on the ground may span multiple tiles. A merge-phase pipeline can merge tiled information from several tile-phase processing stages and may employ a single processing resource. It may merge features, attributes and geometries from adjacent tiles.

Some merge-phase sub-processes can use feature merging based on edge data of adjacent tiles to perform highly efficient hierarchical aggregation of features. The merge-phase sub-process may iterate over each tile edge to build a graph of connections between partial features of adjacent tiles without ever needing to hold their complete geometry in memory. It may generate merged features based on connected components of the graph. For example, feature merging may be used to generate features that extend beyond tile boundaries including property features such as roofing, drivable surfaces, and vegetation.

The merge-phase of a pipeline can further perform attribute merging of attributes generated in the tiled-phase of the pipeline. For example, an area or length may be merged by summation over multiple adjacent tile-local partial features. Confidence or fidelity may be aggregated in an area-weighted average of the tile-local partial features, or other suitable statistics (e.g. minimum, maximum, percentile, and the like). Attributes such as roof pitch or building height may be aggregated from tile-local data using geometric and/or statistical techniques.

Some merge-phase sub-processes can use image or raster data from multiple tiles to improve the accuracy of the results where a tile-processing method would be limited by the limitation of “partial” data. The context from adjacent tiles may advantageously improve the quality of the generated geospatial data. Buffering methods may be employed to improve the efficiency of such merge-phase sub-process methods, for example by storing and reusing input and output data around tile edges.

Pipeline processing regions. The pipelines represent processing methodologies may be performed for specific properties, regions, portfolios of properties, and the like. A pipeline can be run for a specific region that may be as small as a single tile or a single property parcel, or could be as large as an entire survey region, state, nation. The region may comprise a single connected region or may be a set of unconnected regions.

In one example, batch-running a pipeline over a large region of many tiles may be advantageous when the goal is to publish the entire set of output data and provide it to one or more users. Such batch-processing may be particularly advantageous for processing intensive pipelines when it is expected that the output data will be used by many other pipelines in the future, and direct access to output data would provide a latency advantage for users requesting output data for other pipelines that depend on the batch-processed pipeline.

For example on demand processing of a single or small region corresponding to a small set of tiles may be advantageous when the pipeline is specific to a particular user request and its use is expected to be sparse relative to the available coverage for the pipeline.

Processing tile ordering and modes. The tile-phase subprocesses of a pipeline can run in parallel, and without data from neighboring tiles. One or more “fan-out”/“fan-in” architectures may be used to handle the processing, and it may employ multiple tiled phase processing steps according to a graph structure. For example, a double-diamond architecture may employ a first fan on a GPU to generate vectors (arrows with direction and magnitude) using a deep learning model, and a second fan on a CPU may convert the vectors into tiled features.

Within a batch, the tiles could be scattered across a wide geographic area, or may include all the tiles of a complete survey. The processing of tiles in parallel may advantageously use space-filling curves based on a Morton Index or a Hilbert Index or other suitable methods to sequence the processing of tiles within a batch. These methods will schedule the generation of geospatial data from neighboring regions to occur at similar times, thereby allowing parts of later merge phases of the pipeline (that use such neighboring geospatial data) to begin before the entire batch is complete. Further, if the geospatial data is the final output of a pipeline, and is intended to be output to a user, such as through a GUI or API, it may be useful to prioritize processing to begin with the ROI currently viewed by a user and then proceed to neighboring regions according to such a space filling curve.

The system can process tiles in a tile-phase of a pipeline in several modes. In Survey Mode, all the tiles for a specific survey are processed. In Geodata Mode tiles are selected for processing according to a defined geometry and set of dates that may be passed in through a geodata file such as a parquet file.

In Georect (Hash) Mode tiles are selected for processing according to one or more hash codes. The hash code may be constructed based on data such as:
identity of a survey, for example taken from a database of surveys.
a type of webtile to process (for example vertical photomap tile, true ortho tile, panorama tile with specific line of sight).
a specific custom ID for a webtile resource.
A georect hash that defines the label area's geometry for example, based on a space filling curve such as a Morton Index or a Hilbert Index.

In WKT mode tiles are selected based on an AOI defined using, for example, an epsg: 4326 WKT string and date information. Date limitations may be set based on specific selected dates, or may be defined in terms of the available survey data based on a coverage lookup of a database of surveys (e.g.,
latest_intersecting: Select the latest survey that intersects each input area, even if it is not completely covered.
latest_complete: Select the latest survey that completely covers each input area.
all_intersecting: Select all surveys that intersect each input area, even if they are not completely covered.
all_complete: Select all surveys that completely cover each input area.

Pipeline examples. An efficient tile-based processing pipeline may be employed to generate an output such as:
Trend lines for attributes (such as roof condition staining and rusting)
Rate of change of attributes (e.g. Roof Score Index)
Roof replacement likelihood
Remaining life years of a roof.
Definition of Stable Roof/Building ID
Roof shapes & materials
Damage Classification from an event

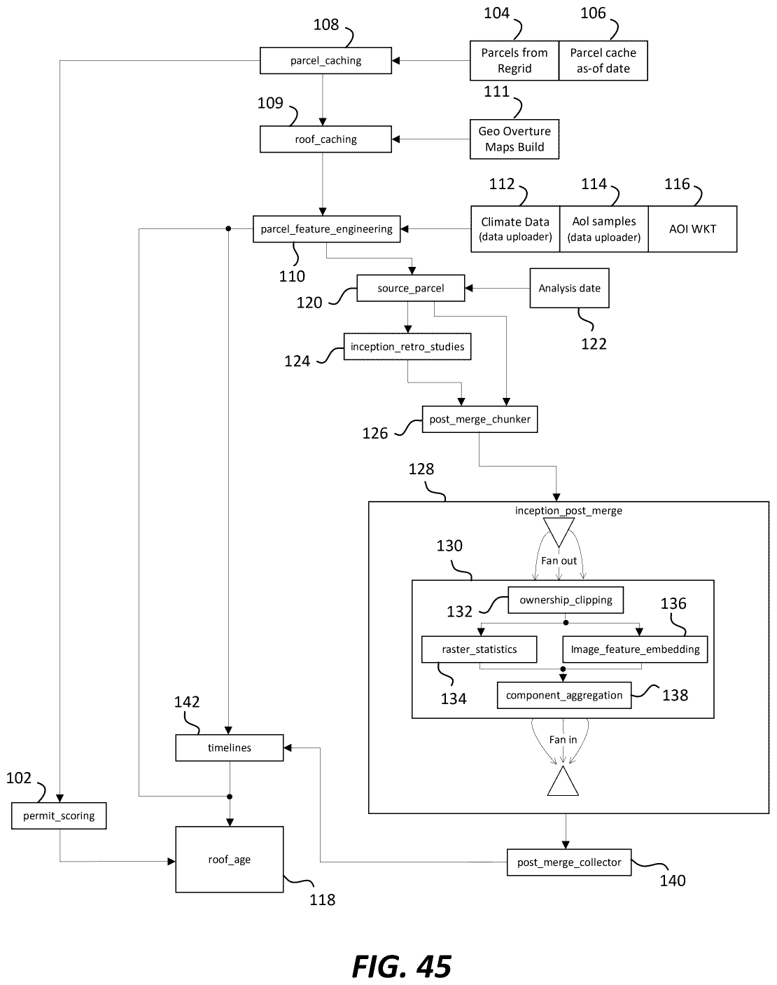

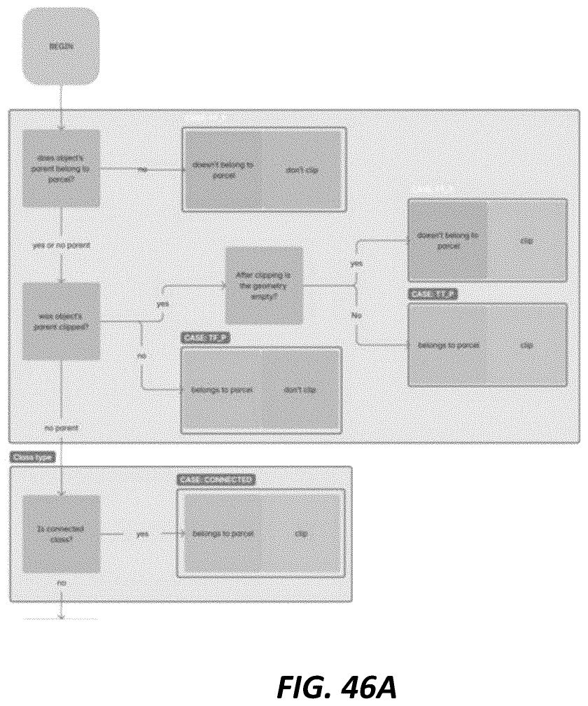

Roof Age. A system for deriving roof age data for properties may use a complex pipeline to generate geospatial data as illustrated in FIG. 45 (118-roof_age). The system integrates data from multiple upstream sources including observation imagery, climate records, assessor information, and permit data to construct a comprehensive timeline for each roof instance. Based on the available data coverage, the pipeline employs various sub-processes to estimate a roof installation date, assigns a Trust Score, and determines the Evidence Type. Advantageously this system is capable of end-to-end processing that ensures that each roof instance is analyzed with the most complete and reliable information available. Optionally, the system may perform geospatial aggregation, calculating metrics such as the average or median roof age within a specific geographic area. This can help surface local trends or support downstream models that benefit from neighborhood-level context.

The system employs a parcel caching subprocess (108, parcel_caching). Parcel data that may be uploaded from a database or provider of parcel data (e.g., Regrid). The parcel data may be stored in a cache memory, for example on networked storage that allows lookup and access to parcel data. The cache may be maintained to provide the latest parcel data as new data becomes available. The cache may convert the parcel data from a third-party data schema to a standard format suitable for downstream processing. An identifier may be generated for parcel data based on its source, corresponding date information, and the like.

The system employs a roof caching subprocess (109, roof_caching) that stores and manages roof data related to the geometry of roof structures. Some roof data may be generated by system pipelines and therefore associated with identifiers based on the processing and geospatial data used as discussed above. Other roof data may be sourced from external systems, in which case identifiers for roof data may be generated based on the source and associated dates and may be converted to a format suitable for downstream processing. Multiple sources of roof data may further be combined, for example by taking the union of overlapping roof geometries to maximize roof coverage, in which case updated identifiers may be generated based on the combined inputs. Geospatial parcel data may further be used at this step.

The system employs a parcel feature engineering subprocess (110-parcel_feature_engineering) that reads parcel data from the parcel caching subprocess and attaches other attributes to the parcels, such as climate data. Climate data may be sourced from one or more climate datasets such as CHELSA or Köppen-Geiger and may provide high-resolution quantitative data on temperature and precipitation and classify systems to recognized climate zones. Parcel feature engineering may also input area of interest (AoI) samples that specify geometries for roof age analysis, for example, through address information corresponding to properties of interest. Parcel feature engineering may further input AoI WKT (Area of Interest Well-Known Text geometry) data, specifying geometries for roof age analysis such as, a specific county or neighborhood.

The system employs a source parcel (120, source_parcel) subprocess that reads the parcel data from parcel feature engineering and identifies which surveys cover each parcel. The source parcel may also schedule a pipeline process for specific parts of surveys based on parcel inputs and may initiate one or more Retro Studies.

The system employs a Retro Studies subprocess (124-inception_retro_studies) that schedules a pipeline process that generates geospatial data including tile-based segmentation and classification data for use in later stages of the roof age estimation for the regions corresponding to selected parcel. The pipeline takes input geometries and initiates one or more tiled phase pipelines, each of which in turn, initiates one or more merge phase pipelines.

The system employs a post merge chunker subprocess (126, post_merge_chunker) that identifies parcels that have tile-based segmentation and classification data but are missing roof age features, determines the workload required to generate the roof age data, and divides the workload into manageable chunks, each corresponding to a separate pipeline.

The system employs a graph of tile-based subprocesses (128, inception_post_merge) with a fan-out/fan-in architecture for efficient parallel tile processing. The graph employs three separate subprocesses.

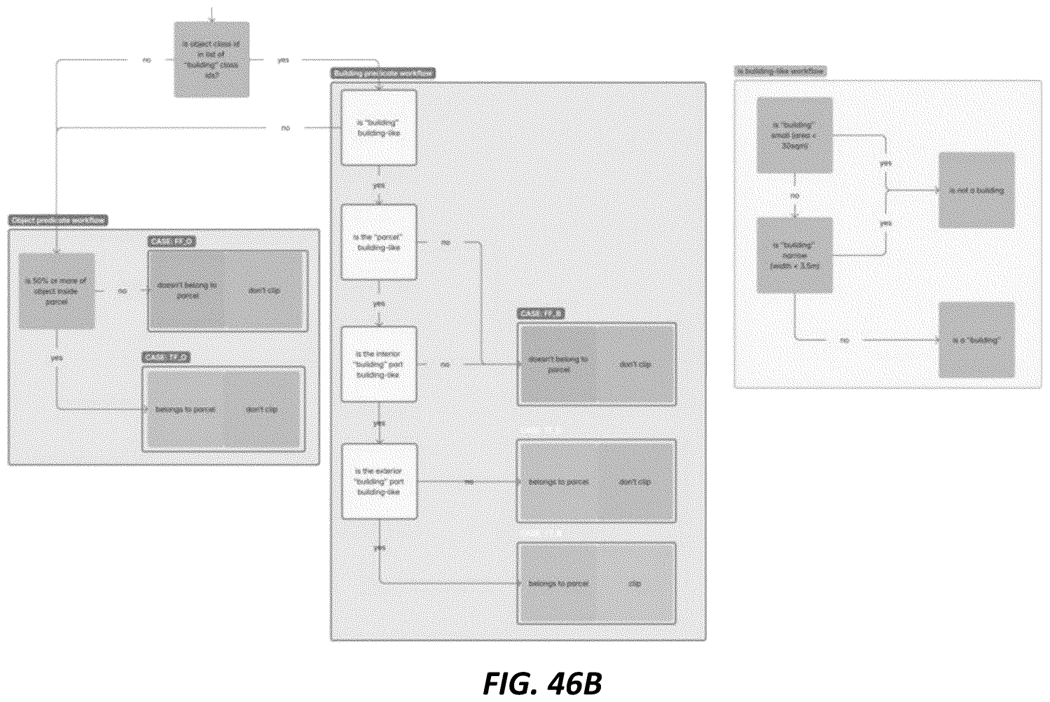

Firstly, the graph employs an ownership clipping (132, ownership_clipping) sub-process that is a method to split a roof into smaller instances based on the parcels that intersect with the roof's geometry. This process is described in further detail below with respect to FIGS. 46A and 46B.

Secondly, the graph employs a raster statistic sub-process (134, raster_statistics) that analyses predicted features by computing confidence-based metrics. For each predicted feature the raster statistic sub-process computes the median confidence values across a set of thresholds, giving a summary of model certainty. The application also produces an 18-bin histogram of confidence scores to show the overall distribution of prediction strengths. It also supports tile-level histograms for a specified query class, allowing for localized insights into prediction patterns across spatial tiles.

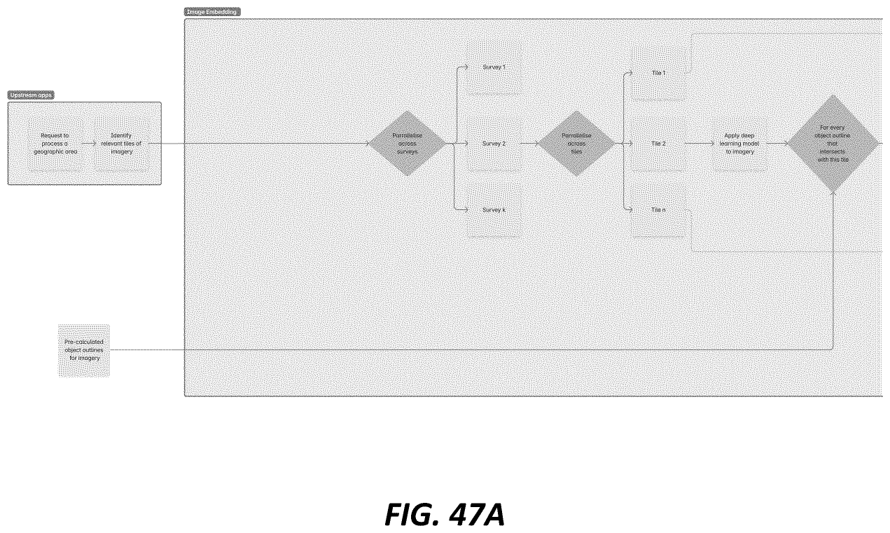

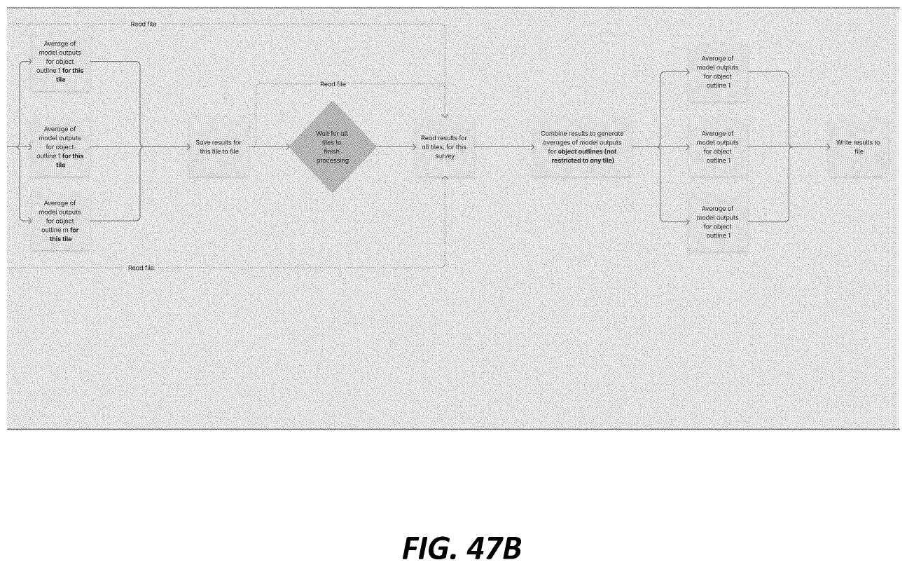

Thirdly, the graph employs an image feature embedding sub-process (136, Image_feature_embedding) that processes imagery and generates image embeddings for each roof instance. This sub-process is described in further detail below with respect to FIGS. 47A and 47B.

The pipeline works in parallel across multiple surveys (different captures over time), and multiple tiles within each survey. For each tile, a deep learning model is applied to the imagery. Model predictions are averaged per object outline (e.g., roof polygon) within that tile. Once all tiles in a survey are processed, the tile-level outputs are combined to produce a survey-wide average per object. These results are saved and can be used for downstream tasks like roof change detection. The graph also employs a component aggregation (138, component_aggregation) sub-process which combines the metadata of ownership_clipping, raster statistics, and image feature embedding into a single metadata.

The system employs a post merge collector sub-process (140, post_merge_collector) that provides spatiotemporally unique observation data for each area of interest. It collects all the observation ‘chunks’ and provides a single index into all their data.

The system employs a timelines sub-process (142, timelines) that collates graphs of relevant geospatial data across multiple surveys, so that we can assemble sequences of outputs. It outputs connected graphs of spatially unique observation data for each area of interest, crossing multiple time-points.

The system employs permit scoring (102, permit_scoring) which uses a large language model to identify permits that are relevant to roof work and generates word embeddings that capture the semantic meaning of each permit's description. These embeddings are then passed to a which assigns a roof-relatedness score to each permit, indicating how likely it is to be associated with roof change.

The system employs a roof age sub-process (118, roof_age) that is described in further detail in the Roof age sub-process described below.

Object Parcel Clipping (=ownership clipping) subprocess. An object parcel clipping method suitable for use in determining a roof age is illustrated in FIGS. 46A and 46B. Objects generated from a pipeline may be clipped to fit within a property parcel. Object parcel clipping generates new attributes, features and/or geometries that fit within the parcel based on a geometric analysis of the objects. For example, raster defined semantic segmentation objects with labels may have pixels removed that are outside of the parcel boundary. This may result in objects being split into multiple parts.

Parcel predicates. Given a parcel and a feature, the parcel predicates determine the following two relationships between them:
belongs_to_parcel (bool): Whether the feature belongs to the parcel.
should_clip (bool): Whether the feature should be clipped (i.e., the clipped instance should be the result of the intersection between the feature and the parcel).

The implementation determines these relationships and contains four different ‘workflows’ to handle the different cases.
‘Parent’ predicate workflow: This workflow assigns predicate values of features according to the values of the feature's parent's predicates. The child classes should inherit the predicates of their parents.
“Connectedness” predicate workflow: This workflow is for determining the predicate values of features which are connected classes, which always belong to the parcel (if they intersect the parcel) and should be clipped to the parcel boundary.
“Object” predicate workflow: This workflow is used for determining the predicate values of features which are not building-like (i.e., they're object-like, such as pools, vegetation and the like). An object is defined as any feature class that is not considered building-like, or whose geometry is not considered to be building-like. If at least 50% of the feature's area is contained within the parcel, then the feature belongs to that parcel. Parentless “Objects” are not clipped to the parcel boundary.
“Building” predicate workflow: This workflow is used for determining the predicate values of features which are building-like. If the feature's class is considered building-like and the geometry of the part of the building that's inside the parcel is considered building-like, then the feature belongs to the parcel. If, in addition to belonging to the parcel, the part of the feature that is outside of the parcel is also building-like, then the feature is clipped to the parcel boundary.

Building likeness. For a feature (or part of a feature) to be considered building-like, it must satisfy the following conditions:
The class of the feature must be one of the building-like feature classes, defined (e.g., ROOF, BUILDING_DEPRECATED, BUILDING_UNDER_CONSTRUCTION, BUILDING_WITH_STRUCTURAL_DAMAGE, STRUCTURAL_LOSS, BUILDING_LIFECYCLE, BUILDING).
The geometry of the feature must have an area of at least 30 square meters.
The minimum width of the geometry of the feature must be at least 3 meters.

Parcel Splitting. The parcel splitting implementation extends the parcel predicates implementation to handle features that intersect with multiple parcels. For example, if a row-home feature intersects many different parcels, the parcel splitting implementation can be used to split the feature with all these parcels. The implementation handles some of the edge cases that might arise when applying the parcel predicates implementation independently to a feature that intersects many parcels. One such edge case is when the parcel predicates implementation suggests that a feature, which intersects two parcels, should be clipped to one of the parcels but not the other. Without edge-case handling, the result would be one clipped feature that overlaps with another unclipped feature. More specifically, the edge case here is that the resulting feature geometries are not disjoined (i.e., their interiors overlap). The parcel splitting implementation handles this and other such edge cases by considering the predicates of the feature across all parcels and arriving at a result that has the property that the resulting feature geometries are disjoined. The way to use the parcel splitting algorithm is to provide:
The geometry of the feature.
A list of all the parcels that intersect with the feature.
A Boolean flag to indicate whether the feature's class id is one of the building-like class ids.

Without going into too much detail, the algorithm works by:
1. Ignore any parcels to which the features do not belong to.
2. For the parcels that remain, group them into disjoined groups. (i.e., any parcel whose interior overlaps with another parcel is grouped together).
3. Apply the parcel predicates algorithm for the feature and each group. (i.e., the ‘parcel’ in this case is the union of the parcels in a group). If the feature should be clipped to the parcel group, then tentatively clip the feature to the parcel group.
4. Check to see if the resulting clipped features are disjoined. For any group of clipped features that may overlap, un-clip them (i.e., union their clipped geometries back together).

The result of the algorithm is:
A list of clipped features, where a clipped feature contains the geometry of the clipped feature, the parcels which that feature was clipped to (may be more than one), and a flag to indicate if the clipped feature represents the whole building (i.e., no clipping was done), or if the clipped feature represents a part of the building (i.e., clipping was done).
A list of orphaned parcels, which are the parcels provided to the algorithm but were not used in the final result.

Image feature embedding sub-process. The system in one configuration proceeds in a few steps, which may include the fan step and the merge step. The fan step involves making many independent computations, which can therefore be spread across many computing resources. For each tile of imagery to be processed, a deep learning model is applied. In addition, there are pre-existing object outlines for that tile.

These outlines allow for averaging the results of the deep learning model across those tiled outlines, resulting in a dataset where each row relates to a “object-outline-within-tile”, and can be linked back to the original object outline from the imagery (which may be arbitrarily large), and contains an area for that outline, and a vector of numbers.

In the merge step, all the data generated in the fan steps for a particular survey is loaded. Because each computation can be linked back to the original outline within that survey, it is possible to summarize the data to produce an area-weighted average of the “object-outline-within-tile” results for a particular object outline. This area-weighted average is identical to the average of the deep learning model across the entire object outline (which may be arbitrarily large) but computed so that much of the work is done in parallel.

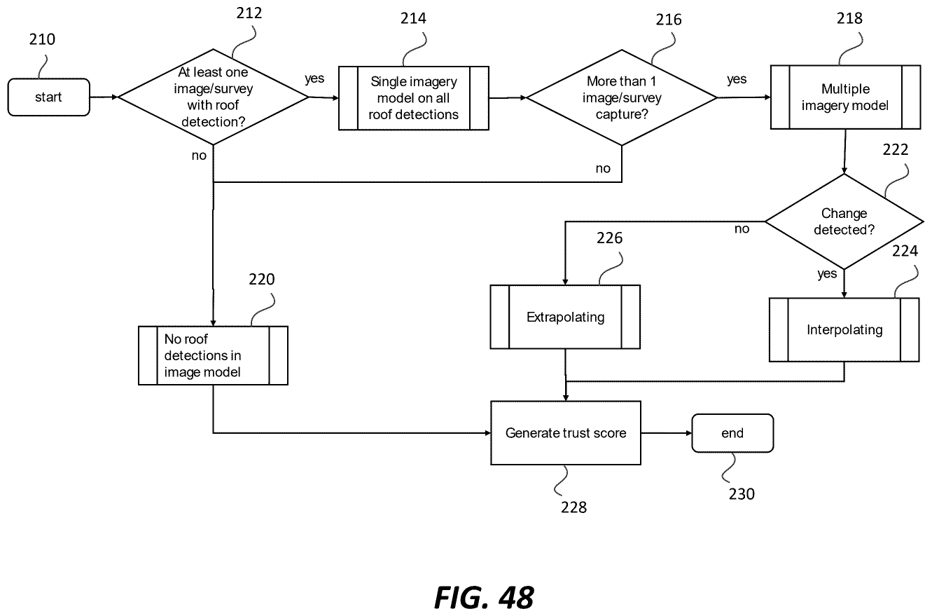

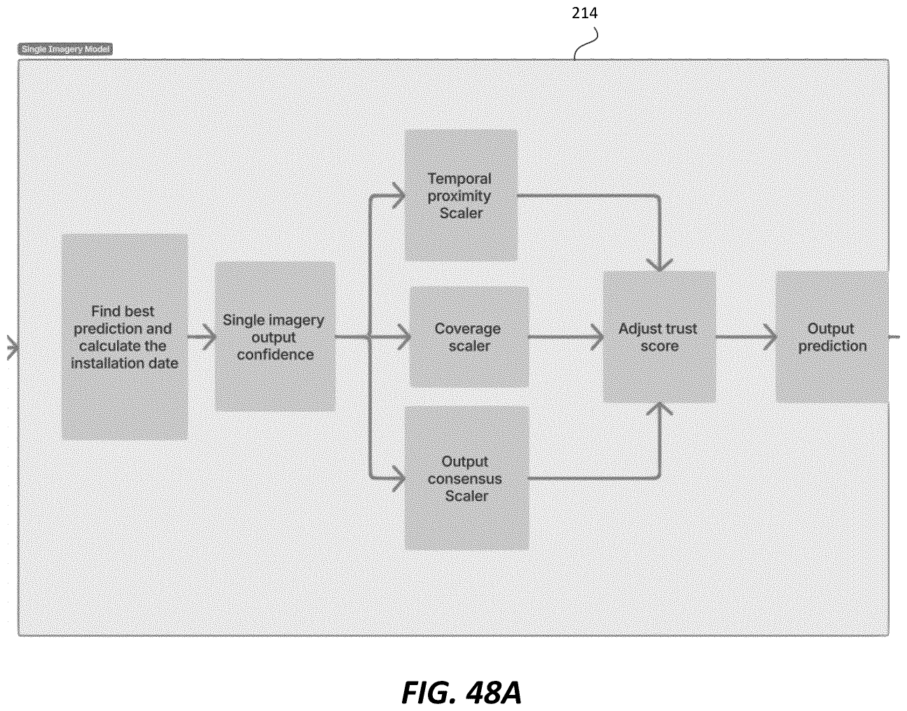

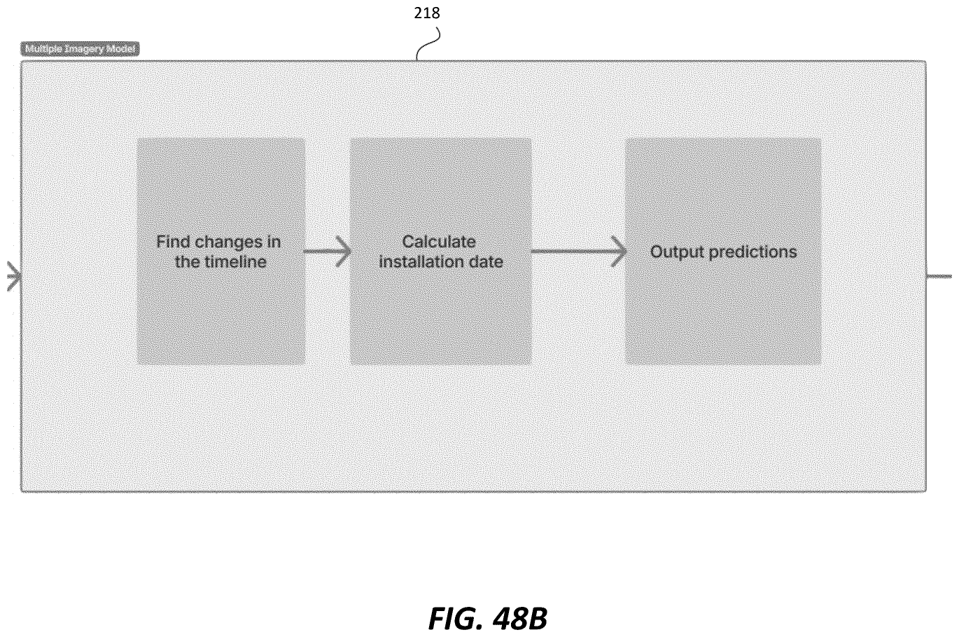

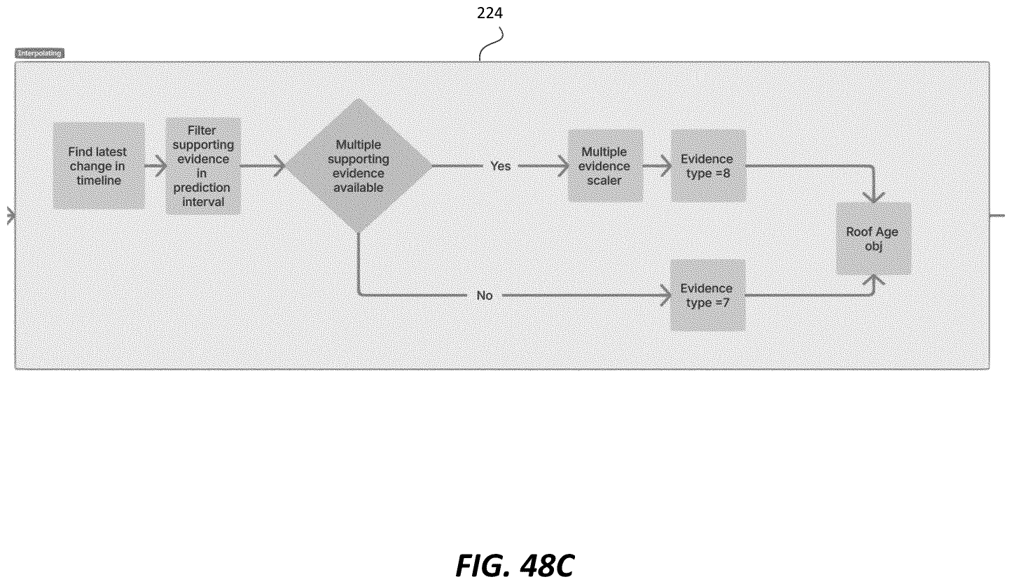

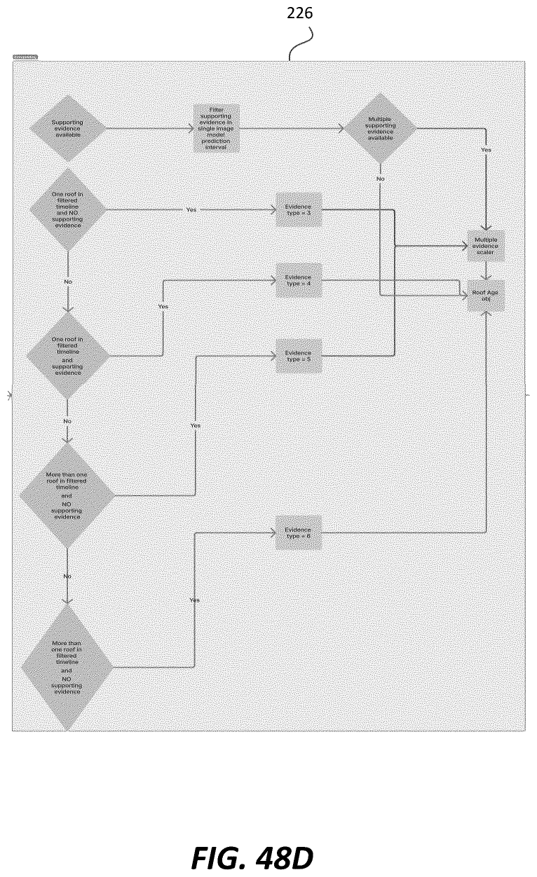

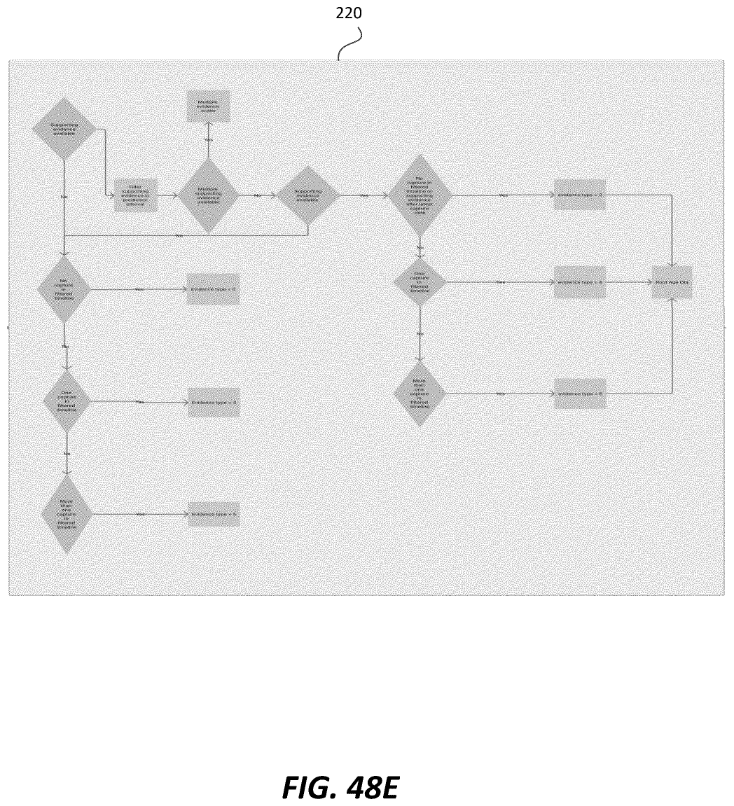

Referring now to FIGS. 48-48E, FIG. 48 is a process flow diagram showing roof age subprocess overall architecture, while FIGS. 48A-48E illustrate subprocesses of FIG. 48 in greater detail. For instance, FIG. 48A illustrates Single Imagery Model step on roof detections of FIG. 48; FIG. 48B illustrates Multiple Imagery Model step on roof detections of FIG. 48; FIG. 48C illustrates the Interpolating step of FIG. 48; FIG. 48D illustrates the Extrapolating step of FIG. 48; and FIG. 48D illustrates the No Roof Detections step in the image model of FIG. 48.

FIG. 48 starts at 210 and proceeds to determine if at least one image/survey are available with roof detection 212. If yes, the system moves to Single Imagery Model on all roof detections 214. From here the system determines if more than one image/survey has been captured 216. If yes, the system moves to Multiple Imagery Model 218.

If no image/survey was detected at 212, or if only one image/survey was detected at 216, the system moves to No Roof Detections in image model 220.

If the system proceeded to the Multiple Imagery Model 218, the system will then proceed to determine if a change in the roof was detected 222. If a change was detected, the system will move to the Interpolating step 224, if no change was detected, the system will move to the Extrapolating step 226.

Based on whether the system had no/one imagery/survey, or whether it had multiple imagery/survey and whether a change was detected or not, the system will move to generate a trust score 228 and then the process will end 230.

Roof age predictions are provided on a roof instance which is a roof that is aligned with ownership using parcel boundaries. This means for row homes, the large single roof polygon is cut to each parcel. In the cases where imagery does not show a roof installation, or where only a single image is available, a roof age is still extrapolated from the state of the roof evident in the imagery. This is combined with third party data, such as regional climate information, to weigh varying roof degradation rates in regions. Supporting information, such as, permits and assessor year-built data, is used in conjunction with imagery (if available) to provide a roof age prediction on all parcels. Evidence Type and Trust Score can be provided with a roof age prediction to provide transparency in the predictions. Roof age predictions are provided for every roof (or parcel) where there is some information available. A Trust score value may factor in the county in which a parcel is located (e.g., the confidence in the existence of permit or other adjunct data within a county, that may depend on the local rules and guidelines).

The Trust Score is scaled based on several quality indicators of the imagery and model outputs, allowing the system to increase the score when the underlying data is determined to be more reliable. Three scalers are applied during the single image model processing, and an additional one is applied separately. These include:
Coverage Scaler: This scaler rewards imagery coverage across time. It increases when the imagery spans a longer period relative to the time since installation, boosting trust when we have broader temporal coverage.
Temporal Proximity Scaler: This boosts Trust Score when the imagery is close in time to the predicted installation date. The closer the prediction is to the earliest image used, the higher the score.
Output Consensus Scaler: This reflects the level of alignment across multiple model outputs. When model predictions are more consistent, this scaler increases the final score.

Each of these scalers adjusts the trust score independently, and together they contribute to ensuring higher scores are assigned when the data is more complete, timely, and consistent.

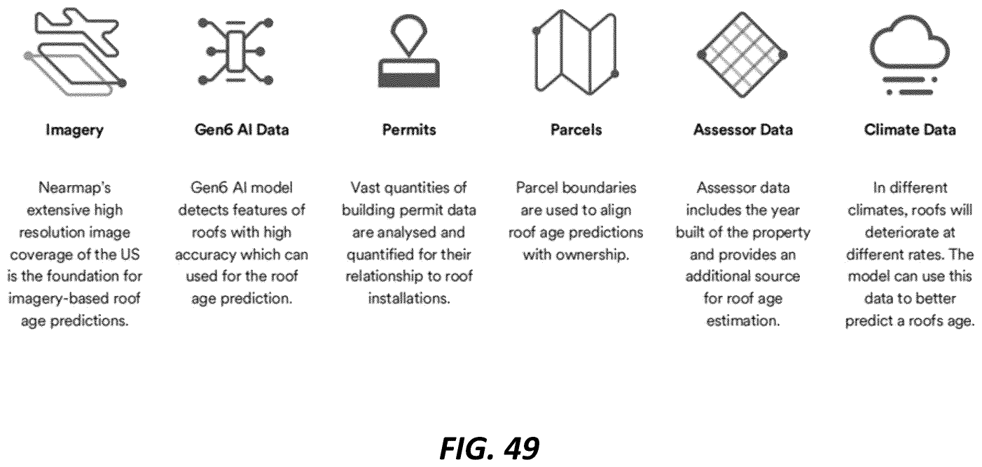

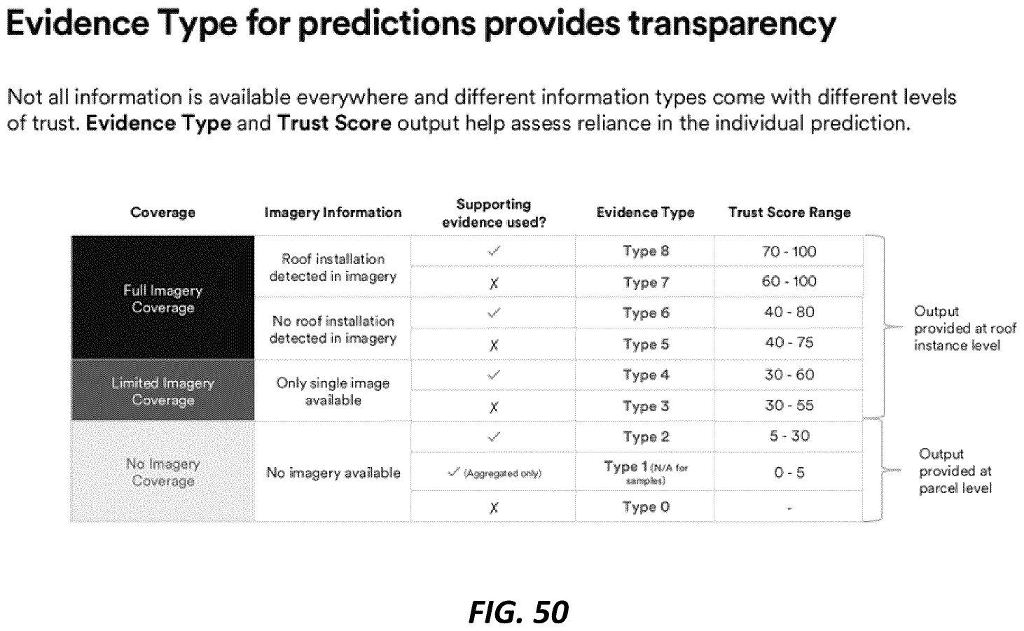

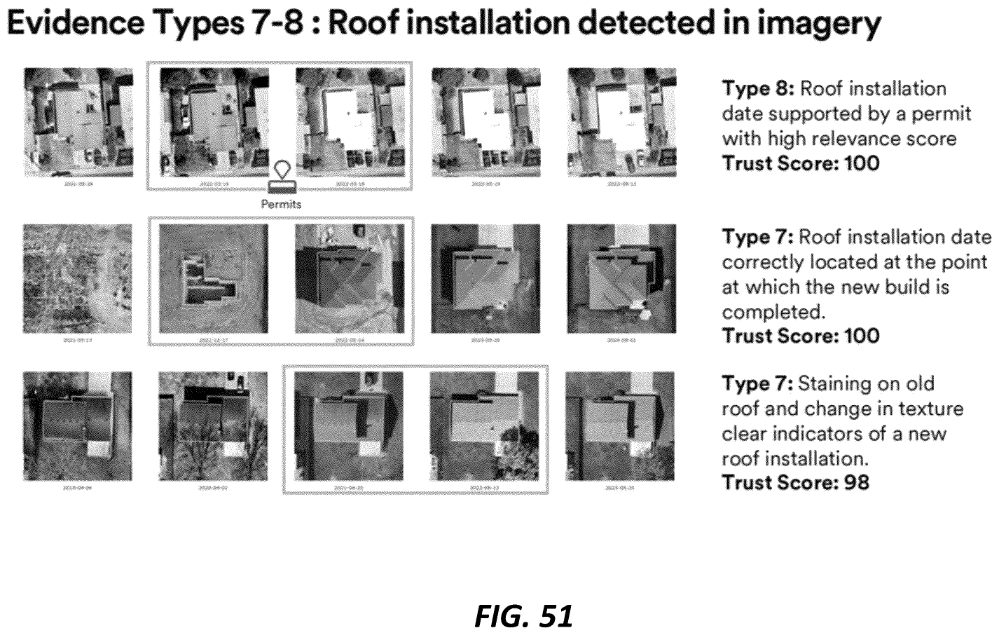

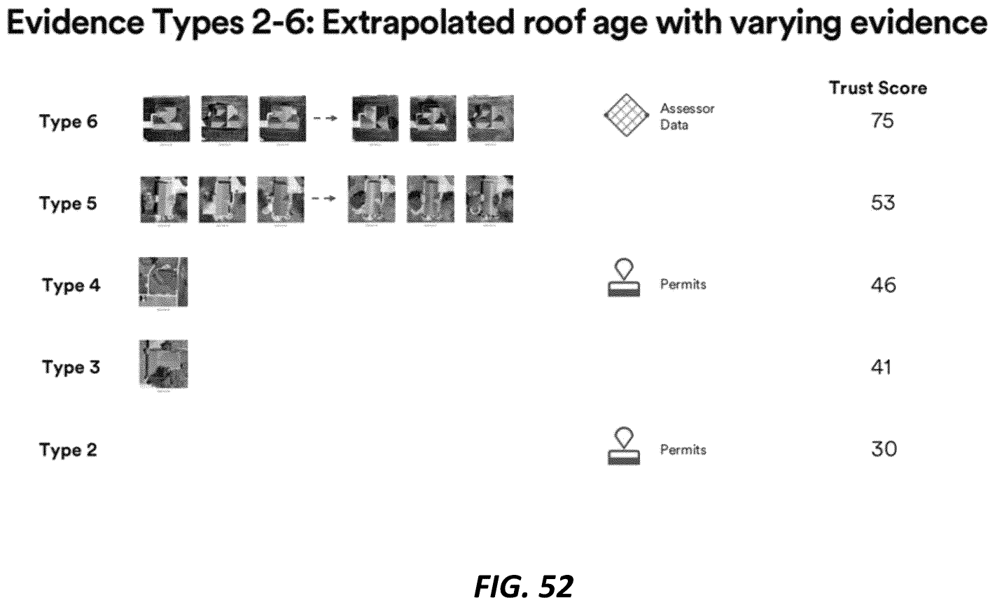

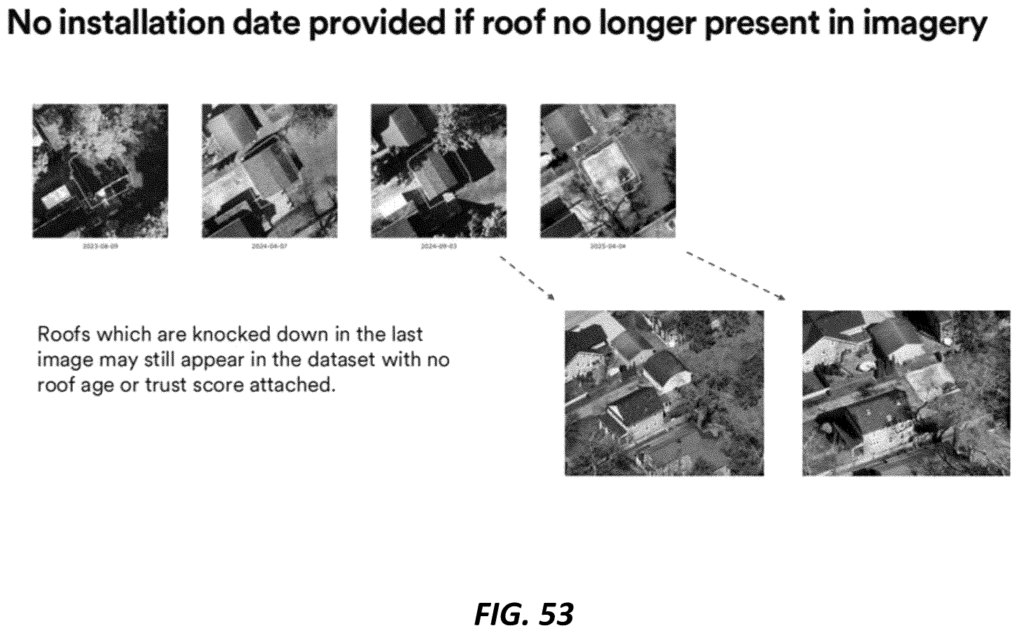

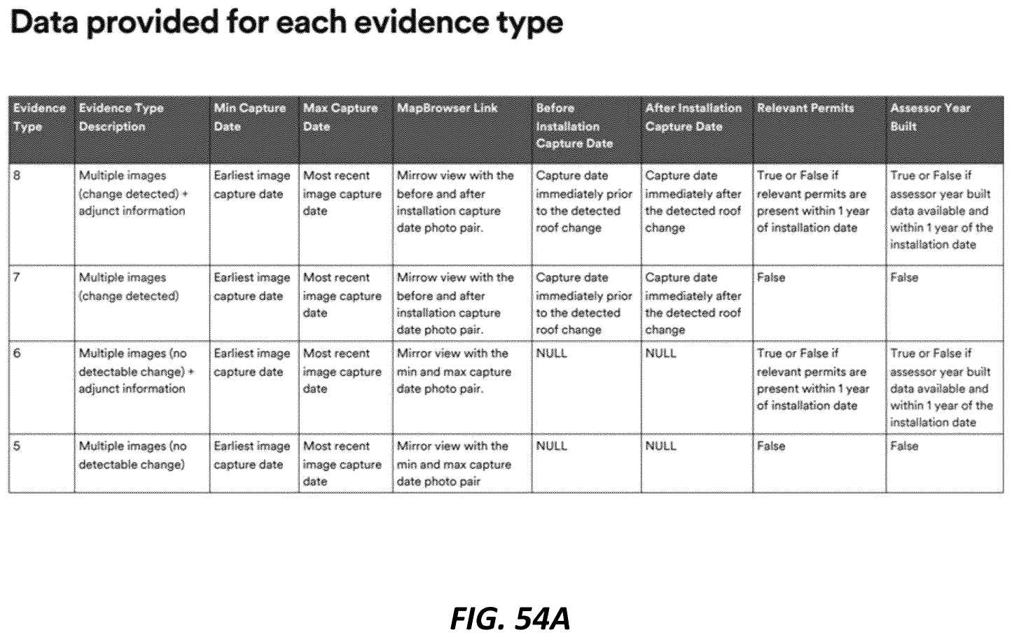

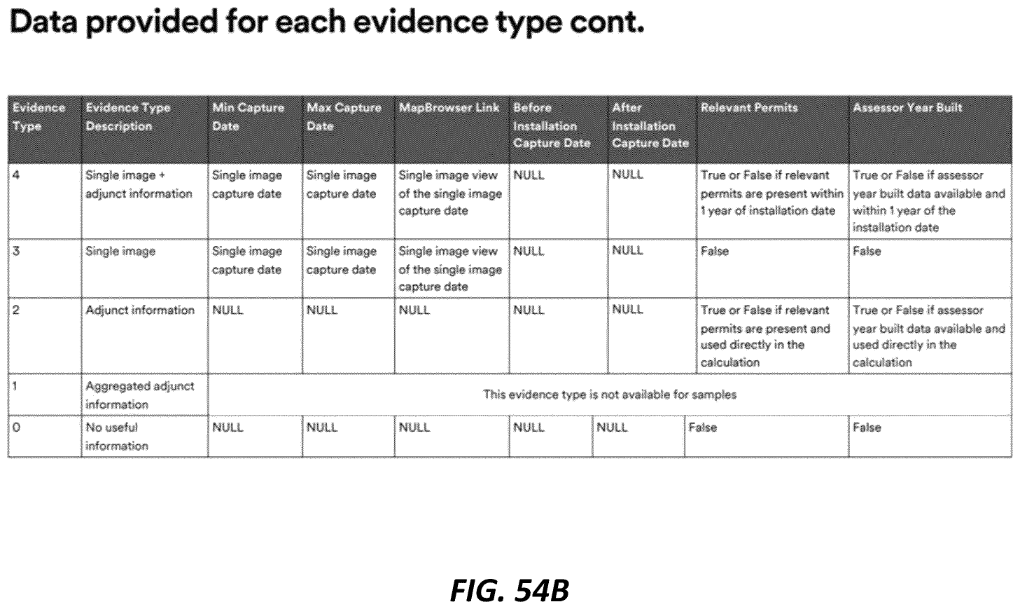

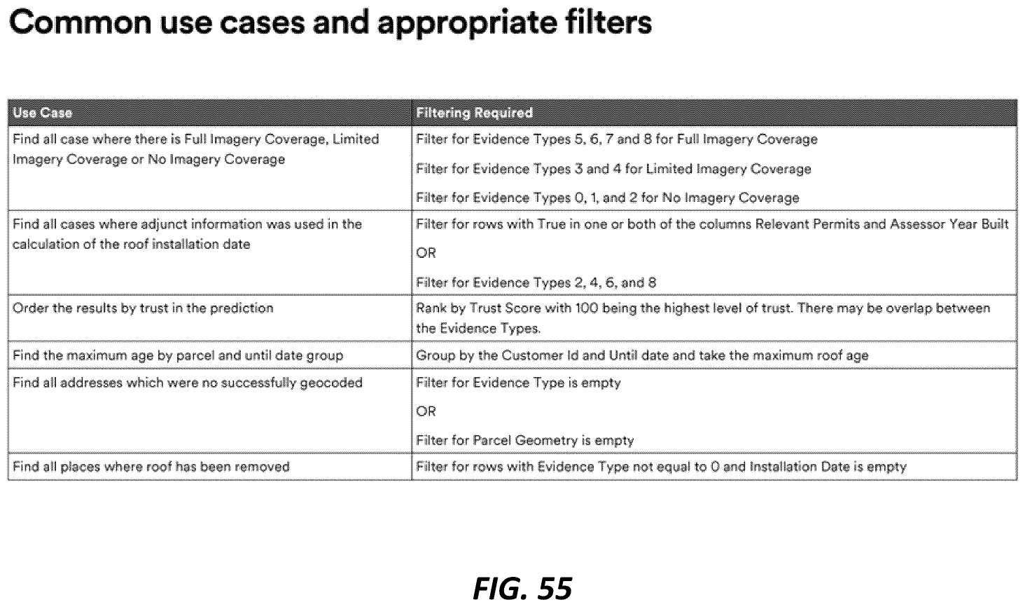

FIG. 49 illustrates the types of data used in determining a roof age. FIG. 50 illustrates the evidence types that are used and provided to the user to ensure transparency of the process. For example, the evidence the system uses to make a determination of a roof age can be provided to the user, which the user can then review for accuracy leading to complete transparency in the process. FIG. 51 illustrates several evidence types for roof installations detected via imagery, while FIG. 52 illustrates several evidence types for roof installations detected by various evidence types along with a corresponding Trust Score, which varies based on the evidence available to the system. FIGS. 54A and 54B illustrate data provided to a user for each evidence type, which provides full transparency for system determinations. Finally, FIG. 55 illustrates common use cases and appropriate filters that can be used by the system.

A suitable data structure representing a roof age and associated relevant properties, geometries and parameters is shown in the following Table 1.

TABLE 1
Data Structure Representing a Roof Age

| Column Name | Data Type | Description |
|---|---|---|
| customer_id | String | An identifier, for example provided by a |
| | | customer. |
| until_date | String | Date as of which the roof age is calculated |
| | | (may be set according to the date of |
| | | analysis). |
| street_address | String | The street address of the parcel. |
| city | String | The city of the parcel. |
| state | String | The two-letter code for the state of the |
| | | property e.g. TX. |
| zip_code | Int | The 5 digit numerical zip code of the |
| | | parcel. |
| parcel_geometry | WKT Polygon | Data structure representing the parcel |
| | | geometry, for example, a WKT polygon of |
| | | the parcel boundary of the property in |
| | | 4326 projection. |
| roof_geometry | WKT Polygon | Data structure representing the geometry |
| | | of the roof, for example a WKT polygon |
| | | of the roof instance to which the roof |
| | | installation date applies in 4326 projection. |
| | | Parcel boundaries may be used to align |
| | | roof age predictions with ownership. |
| address_point_geometry | WKT Point | For example a binary point geometry, for |
| | | example representing a point on a roof or |
| | | in a parcel. |
| roof_installation_date | String | Predicted roof installation date, for |
| | | example in YYYY-MM-DD format. The |
| | | installation date is the most recent |
| | | installation at the point in time of the |
| | | until_date. The date may be the mid point |
| | | between captures if a roof installation is |
| | | detected in imagery. |
| roof_age | Float | Predicted age of the roof, for example in |
| | | years at the point in time of the until_date. |
| trust_score | Float | Trust score between 0 and 100 for the |
| | | prediction. The trust score accounts for the |
| | | level of evidence used in the prediction as |
| | | well as the raw confidences output by the |
| | | models. |
| evidence_type_description | String | Description of the evidence type for the |
| | | prediction. |
| evidence_type | Int | The evidence type for the prediction of the |
| | | roof installation date. It may be a value |
| | | between 0 and 8 which ranges from no |
| | | information available to full image |
| | | coverage with supporting evidence. |
| min_capture_date | String | Earliest capture date of the parcel, for |
| | | example in YYYY-MM-DD format. |
| max_capture_date | String | Latest capture date of the parcel, for |
| | | example in YYYY-MM-DD format. |
| number_of_captures | Int | Number of unique capture dates. |
| mapbrowser_url | String | Link to an online view of this property. |
| | | May optionally link to show multiple |
| | | images of the property at different dates, |
| | | for example with a mirror view. Multiple |
| | | images presented may show the imagery |
| | | from before and after the installation (e.g. |
| | | from before_installation_capture_date and |
| | | after_installation_capture_dates) or the |
| | | max range of available imagery (e.g. from |
| | | min_capture_date and max_capture_date). |
| | | Mirror view may use a slider to interact |
| | | with overlayed imagery from different |
| | | dates. |
| before_installation_capture_date | String | The capture date immediately prior to the |
| | | predicted roof installation date if the roof |
| | | installation date is within the range of the |
| | | available imagery, for example in YYYY- |
| | | MM-DD format. |
| after_installation_capture_date | String | The capture date immediately after the |
| | | predicted roof installation date if the roof |
| | | installation date is within the range of the |
| | | available imagery in YYYY-MM-DD |
| | | format. |
| relevant_permits | Boolean | True if roof installation related permits |
| | | were used within the calculation of the |
| | | roof installation date. False if no permits |
| | | available or not used in calculation. |
| assessor_data | Boolean | True if year built assessor data associated |
| | | with the parcel is available. False if no |
| | | data is available. |

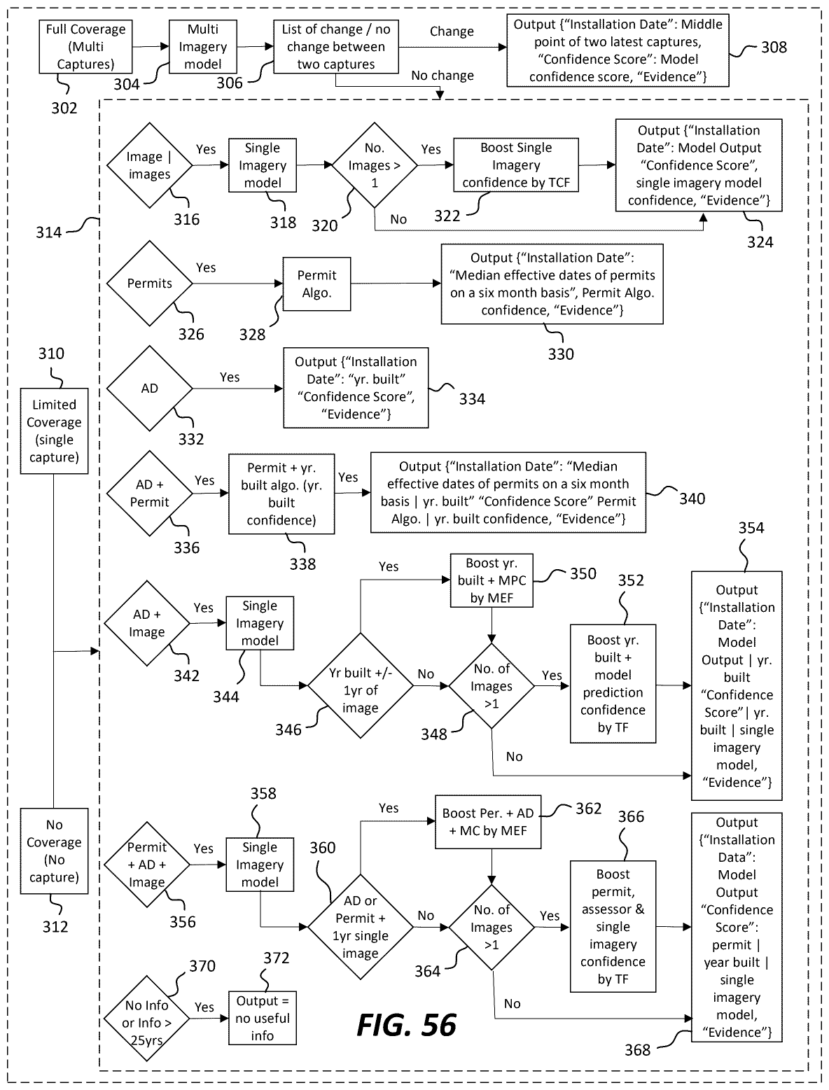

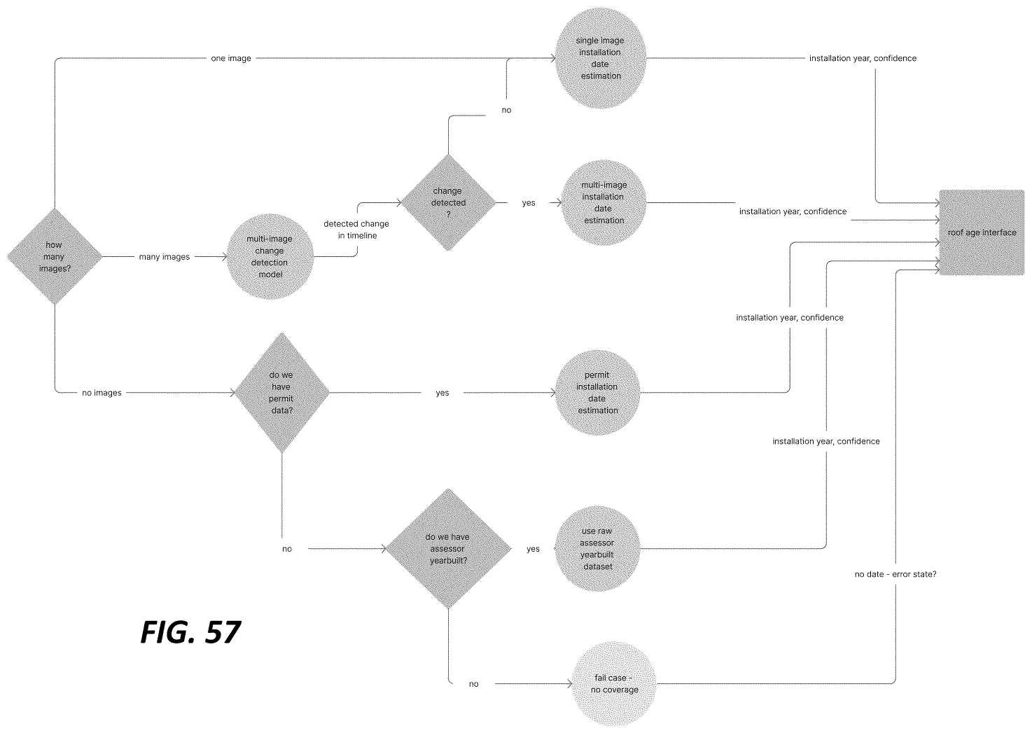

Referring to FIG. 56, a flow diagram is provided illustrating the process steps for the Meta Algorithm in greater detail for each of the coverage scenarios described above. The Meta Algorithm is where all outputs from the models are aggregated. It operates in three modes depending on imagery coverage and aims to produce an installation date and a confidence score for each roof instance or parcel. The three basic modes of operation for property coverage include:

1. Full coverage 302 (Multiple image sources (multiple dates)): images. In this mode of operation, the system includes multi-Image model 304, 404, List of change/no change between two captures 306 and if there is a change, then Output {“Installation Date”: Middle point of two last latest captures, “Confidence Score”: Model confidence score, “Evidence”} 308. If there is no change, the system will move to one of several different processes 314 depending on the data available to the system. Additionally, if the middle point of the last two captures exceeds a threshold duration (e.g., the two captures points are too far apart in time), the system will treat this as limited coverage (single capture) 310.

This allows for processing of imagery via models into image embedding vectors. Then the system will compare vector embeddings and AI descriptors across all image pairs/sequences of images (more than two images). Finally, there is post processing of pairs/sequences of images that most likely have changes as described in step 308.

2. Limited coverage 310 (one image): image+permit and assessor data (if available). This mode may include when there is a combination of: imagery, year-built (from assessor data) and permit information (score and type) and would advance to one of several different processes 314 depending on the data available to the system.

3. No coverage 312 (No imagery): permit+assessor data. This mode would use permit algorithm that inputs permit scores and types obtained from permit ML model trained by text embeddings and returns an aggregated permit confidence score. The process utilizes year-built and permit confidence scores and would advance to one of several different processes 314 depending on the data available to the system.

Looking now at the processes 314 there are several starting points depending on the data available including: Image | Images 316; Permits 326; Assessor Data 332; Assessor Data +Permit 336; Assessor Data+Image 342; Permit+Assessor Data+Image 356; and No Information or Information is >25 years old 366.

If the data available comprises only one or more images, the system will move to Image | Images 316 where the system moves to single imagery model 318 and determines if the data comprises >1 image 320. If so, the system will boost single imagery confidence by timeline_coverage_factor 322, (also referred to as “TF”) and move to Output {“Installation Date”: Model Output “Confidence Score”, single imagery model confidence, “Evidence”} 324.

If the data available comprises only permits, the system will move to Permits 326 and reference permit algorithm 328. The system will then move to Output {“Installation Date”: “Median effective dates of permits on a six month basis”, Permit algorithm confidence, “Evidence”} 330.

If the data available comprises only assessor data, the system will move to Assessor Data 332. The system will then move to Output {“Installation Date”: “Year Built”, “Confidence Score”, “Evidence”} 334.

If the data available comprises assessor data and permits, the system will move to Assessor Data+Permit 336. The system will then move to Permit+year built algorithm (year built confidence) 338, and then to Output {“Installation Date”: “Median effective dates of permits on a six month basis | year built”: “Confidence Score” Permit algorithm | year built confidence, “Evidence”} 340.

Referring to FIG. 56, if the data available comprises assessor data and image, the system will move to Assessor Data+Image 342. The system will then move to Single Imagery model 344, and determine the year built is +/−1 year of the single image install date 346. If yes, the system will Boost year built+model prediction confidence by multiple_evidence_factor 350. If no, the system will determine if the number of images is >1 image 348. If yes, the system will boost year built+model prediction confidence by time_factor 352. If no, the system will move to Output {“Installation Date”: Model Output | year built “Confidence Score” | year built | single imagery model, “Evidence”} 354.

In FIG. 56, if the data available comprises permit+assessor data+image, the system will move to Permit+Assessor Data+Image 356. The system will then move to Single Imagery model 358 and then to determine if the assessor data or permits are+/−1 year of the single image install date 360. If yes, the system will boost permit+assessor data+model confidence by multiple_evidence_factor 362. If no, the system will determine if the number of images is >1 image 364. If yes, the system will move to boost permit, assessor data & single imagery confidence by time_factor 366. If no, the system will move to Output {“Installation Date”: Model Output “Confidence Score”: permit | year built | single imagery model, “Evidence”} 368.

If the data available comprises no information or the information is >25 years old, then the system will move to No Information or Information >25 years old 370. The system will then move to Output=no useful information 372.

FIG. 57 is a flow diagram illustrating the process steps for the system for the three imagery coverage modes described above. For example, as a first step, the process determines how many images of the roof are available. If there is one image, then the process moves to single image installation data estimation providing an installation year with a confidence score that is input to the roof age interface.

In instances where many images are available, the process moves to multi-image change detection model where it determines if changes are detected. If no, the system move to the single image installation data estimation step. If yes, it moves to the multi-image installation data estimation step providing an installation year with a confidence score that is input to the roof age interface.

In instances where no images are available, the process moves to the query of whether permit data is available. If yes, it moves to permit installation data estimation step providing an installation year with a confidence score that is input to the roof age interface. If no, the system determines whether assessor year built data is available. If yes, the system moves to use raw assessor year built dataset providing an installation year with a confidence score that is input to the roof age interface. If no, the system moves to fail case-no coverage.

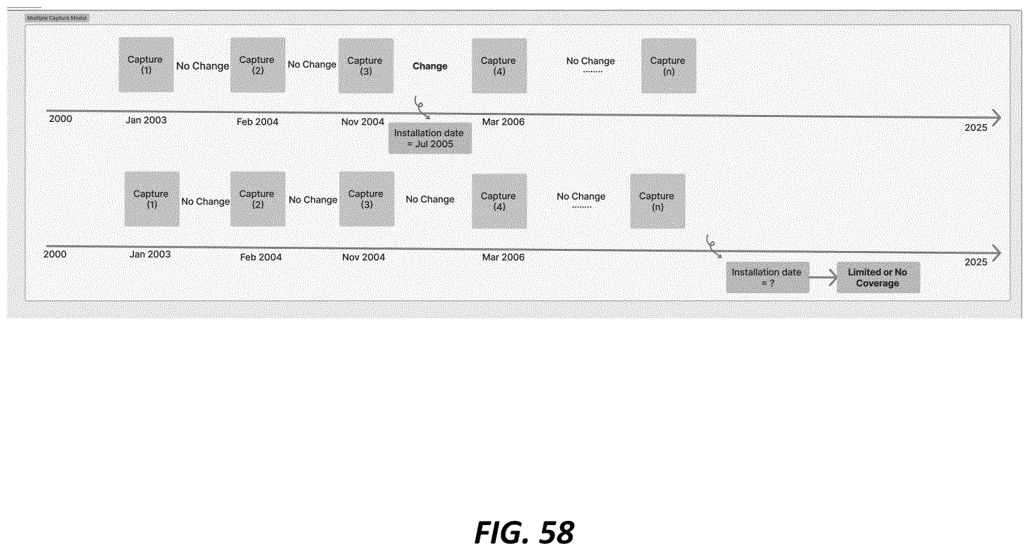

FIG. 58 illustrates image capture of a parcel on five different dates, (e.g., Capture 0 on Nov. 23, 2018, Capture 1 on Nov. 13, 2019, Capture 2 on Jan. 18, 2021, Capture 3 on Oct. 15, 2021, and Capture 4 on Aug. 13, 2022).

ML Models. 1) Roof change embedding including: roof instance raw image. 2) Roof change permit score including: permit embeddings. 3) Single-Image installation date estimator including: AI processed raster features and climate data. 4) Multiple-Imagery change detector including: image embeddings, Gen6 raster features, camera model, and season.

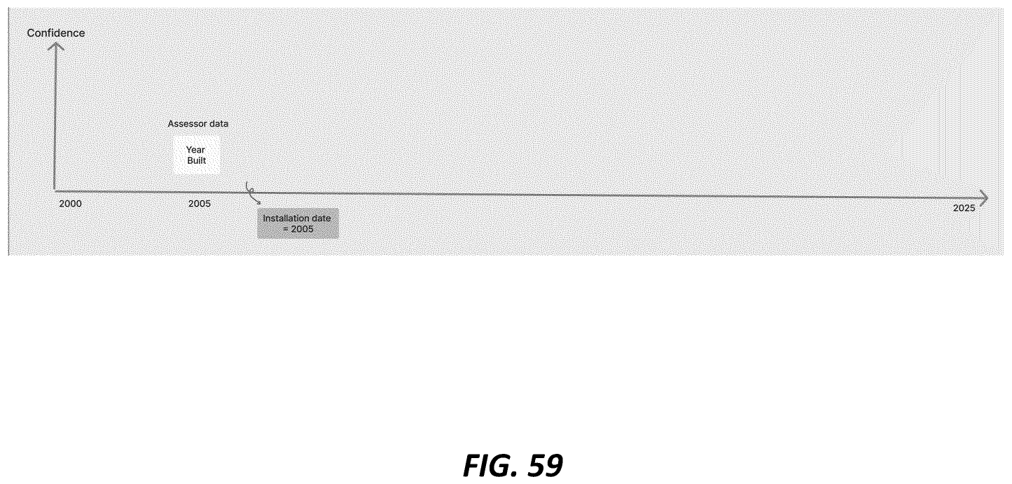

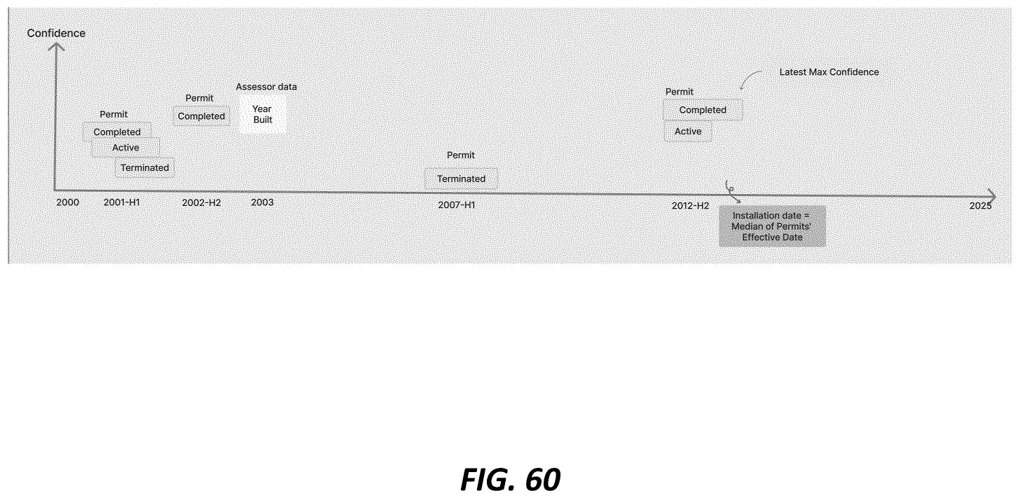

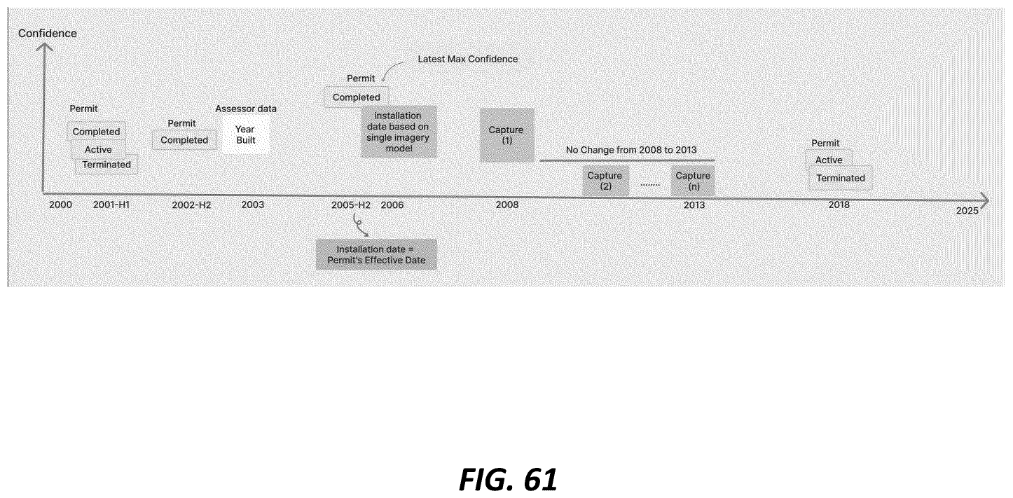

FIGS. 58-61 illustrate various timelines of image captures as a sample analysis of the system according to the various modes of operation as described in connection with FIGS. 3 and 4.

In summary, the major differences with current roof age product from currently know systems include: 1) Coverage-Limited to areas with imagery vs US national coverage; 2) Scalability-Current roof age models require whole images of the roof, which is not scalable for nationwide processing; 3) Performance-Can handle a) no imagery with Assessor Data, Permits, b) limited coverage with one capture including Image, Climate Data, Assessor Data, Permits, and c) full coverage with multiple capture including Images/Climate Data, Assessor Data, Permits.

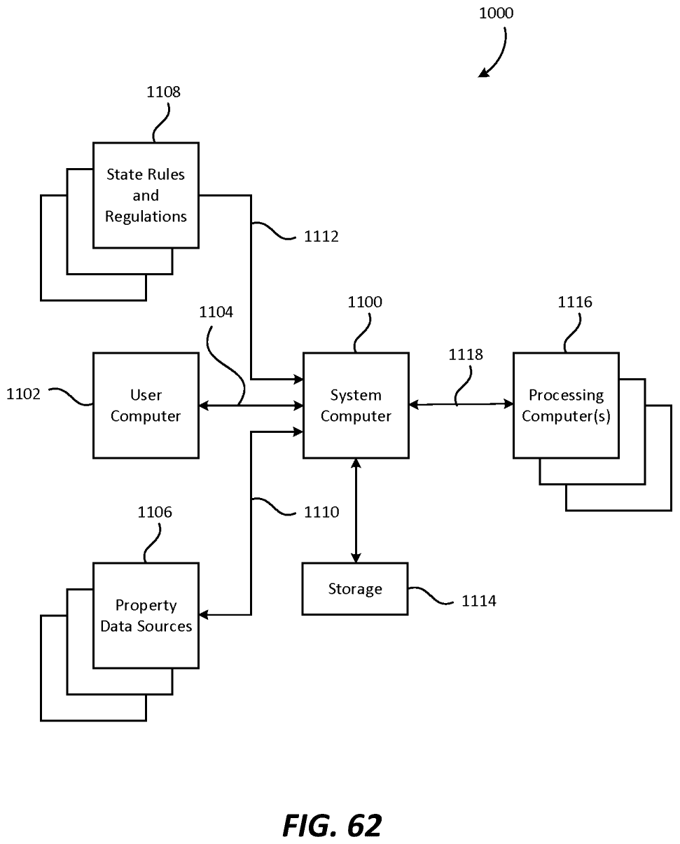

Referring now to FIG. 62, system 1000 is illustrated including a system computer 1100 that is coupled to a user computer 1102 via a network connection 1104. System computer 1100 may include a webpage presented to the user via the computer 1102 allowing a user to access the functionality of system computer 1100.

System computer 1100 is connected to various data sources including property data sources 1106 and rules and regulations data sources 1108 via network connections 1110 and 1112 respectively.

System computer 1100 also has a storage 1114 on which additional data may be stored for retrieval by the system.

Finally, processing computer(s) 1116 is illustrated connected to system computer 1100 via a network connection 1118.

The system 1000 is arranged such that a user may access the system computer 1102 to determine whether the system 1000 will allow for insurance underwriting of, for example, a property. The user can input various information into the system computer 1100, which in turn will access various data sources relevant to the property. This data may come from many different third-party data sources, each having their own data format and scaling.

System computer 1100 will receive and process all the received data and will normalize and convert it into a format that is useable by the system 1000 to evaluate (e.g., for insurance underwriting or claims adjusting and the like). As the data may be quite extensive, external processing (e.g., remote commercial data center processing) may be required to process the information (i.e., high resolution image data, 3D processing, and the like). This processed data is adapted to be used with insurance specific data (e.g., insurance rules of the company to provide the underwriting) that saved on the storage 1114. The various data sources will be discussed in greater detail in connection with FIGS. 2-4.

The system includes several stages including: 1) Rule Ingestion, 2) Rule Analysis, and 3) Rule Deployment.

1. Rule Ingestion. This includes, digesting and interpreting the set of rules (as documents) that insurers have come up with to decide which properties should be underwritten, and which fall outside their desired risk profile.

Going from PDFs of underwriting rule documents (per customer per state), to a database of clearly articulated rules with standalone explanations, explicit dependencies where they exist, IDs and versions, and applicability (e.g., to different states or customer segments). There will be explicitly defined categories (strict eligibility rules, rules that place limits on cover, rules that require manual involvement, and the like).

The rules may be provided as a set of PDFs. But what seems quantitative and clearly defined to lawyers and underwriters is not necessarily precise for AI. The PDFs are not a straightforward list of rules but often comprise rich documents with many sections referencing each other, some rules, some guidelines, and many aspects that are not directly relevant to the immediate task. The document(s) will often include definitions and interpretation of terms. Rules that depend on other rules in a hierarchy. Rules that leave aspects up to human judgement, with deliberate areas of vagueness. This means the system needs to turn a bunch of PDFs from a customer (one per state with subtle variations copy pasted amongst them) into a rigorous rules database-formally decomposed into individual rules that have relationships and dependencies between each other; versions as the rules get updated or obsoleted; links to data sources and even code snippets-as the LLM attempts to interpret the rule in light of the data sources that are available to it. This means the rules need to be validated to ensure they were extracted correctly.

2. Rule Analysis. This includes, working with the customer organization, reasoning about that set of rules in the “rubber hits the road” scenario (e.g., have we understood the rules correctly? What if our system applied retrospectively? What different decisions would have be made? What are the systematic biases that would be introduced? What rules can be reliably interpreted and decisioned, and which are more subjective, or even unable to be answered with data sets at our disposal?)

At stage 1, it is anticipated that many of the rules from the extraction process will not line up 1-1 with exact dataset to rule relationships. This requires that the LLM think creatively and come up with ideas on how the rules can be addressed giving the system to cover as many rules as possible. Stage 2 is the organizational level onboarding, where the “candidate” decisioning engine from Stage 1 receives necessary validation, inevitable changes and adjustments due to errors. This further provides the benefit that the user is then forced to understand their rules and book of business in an entirely new way (e.g., have they been writing policy inconsistent with their rules? And should it be the rule or the underwriters who changes?). Insurers will be able to see that what they believe is already a clear cut, well adhered set of rules turns out to contain significant ambiguity, inter-rule conflict, and be inconsistently applied across their business. Stage 3 is the deployment. Once there is clear agreement on the quantitative nature of the rules and recommendations, a key aspect to consider is that as well as the trusted data sources the system brings, there will be data sources from the customer themselves, that fall into two categories-well managed and structured data (such as an internal data attribute on whether the person has had previous claims with them), and ad hoc blobs of data that are uploaded to reason about a particular property (e.g., condition reports, drone flights or mobile phone photos from the potential insured, utility bills, or any other number of letters, reports and documents that the underwriter deems relevant). These must be parsed and reasoned about on the fly, without the benefit of the centralized organizational validation process.

3. Rule Deployment. The system in day-to-day underwriting support, with individual underwriters in the loop making live decisions on individual properties.

At this point, the system is made available to underwriting officers making decisions about properties. At this point, deployed rules are in line with what has been agreed above. Going forward, the system provides: a UI for frontline staff; Ongoing monitoring to check the deployed rules (and underwriter feedback) maintain the same statistical distribution; determine the output form of the data (provenance, recommended actions, direct actions including providing evidence); Analyze the feedback (does the underwriter exercise their discretion); Uploading of documents is a critical part of analyzing each property including historic claims list, property inspection condition reports, pictures of electrical wiring and the like.

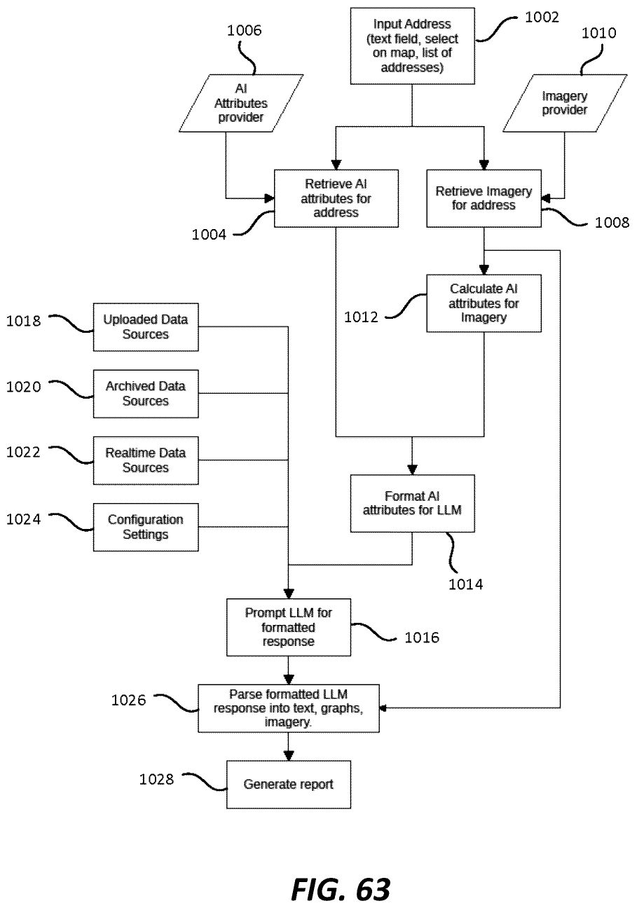

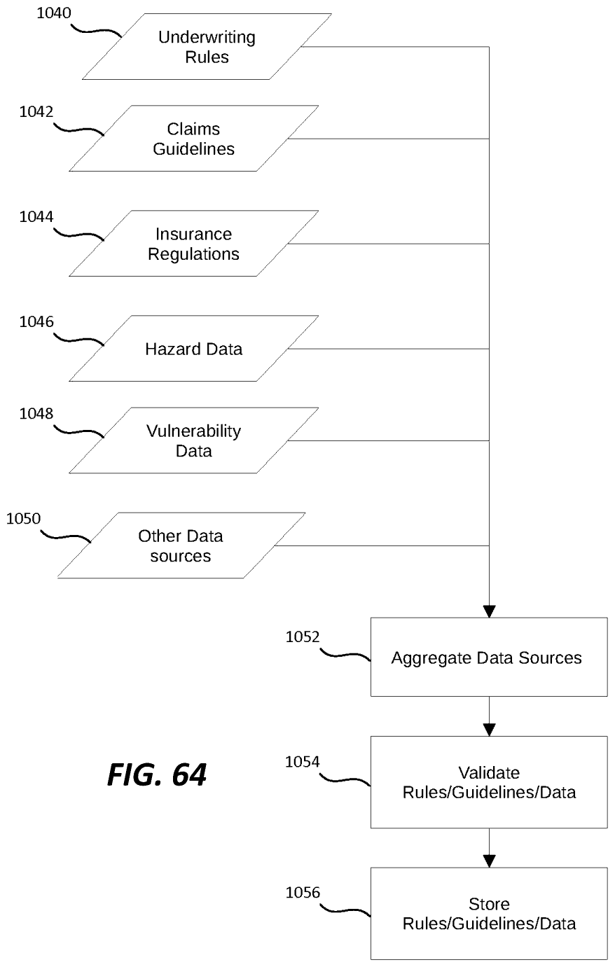

Turning now to FIG. 63, the system 1000 for insurance underwriting and adjustment is further illustrated. For the process illustrated in FIG. 64, initially a user can input an address 1002, which may comprise filling out a text field, or could be by selecting a location on a map displayed to the user, or it could be selected from a list of addresses, or any combination of the above.

Once an address corresponding to a property is identified, the system 1000 can then retrieve Artificial Intelligence (AI) attributes associated with the address 1004. The system can request such AI attributes from an AI attributes provider 1006. This information may comprise, for example, non-imagery data comprising a vector as pre-processed data.

Additionally, system 1000 can then retrieve image data of the property 1008 corresponding to the address. The system can request such property imagery from an Imagery provider 1010. It is contemplated that the retrieved images may include associated AI attributes that can be used by the system. These AI attributes may comprise vector layers (polygons) derived from raster (pixels) as discussed in connection with FIGS. 32B and 32C as pre-processed data.

Alternatively, if precomputed AI attributes are not available for the retrieved image data, the retrieved raw image data is then optionally used by the system 1000 to calculate AI attributes for the imagery 1012. For example, the imagery can be used as an input to a Convolutional Neural Network (CNN) or other artificial neural network (ANN) used in the AI system to derive AI attributes from the image data on demand. This on-demand data processing of imagery to generate AI attributes requires separate AI processing of a large amount of data. It is contemplated that external processing (e.g., remote commercial data center processing) could be used to accomplish this task.

The retrieved non-imagery AI attributes for the address or the derived AI attributes or both are then processed so that the AI attributes are formatted 1014 for the LLM. AI attributes are required to be formatted in a syntax or language that is suitable for the LLM, such as JSON or text. For example, an AI attribute for a swimming pool with an identifier “123” requires formatting as “swimming pool” for input to the LLM.

Referring now to the LLM prompt, it will be understood that there are different underwriting guidelines for different U.S. States:
$ {pdfTextCombined}
There is also raw property data:
///
$ {JSON.stringify (rawApiData, null, 2)}

The underwriting guidelines are then combined and the property data is reviewed to decide on an insurance underwriting outcome. The property will be declined for underwriting if it is not associated with one of the States represented in the rules. In the “decisionReasons” array, the system will be as descriptive as possible as to the reason for the decision and in one configuration, will include at least eight reasons for the user. If an endorsement is required to cover a home, the details of the endorsement will be included in the decision supplement. Most of the reasons for making the decision will be from the underwriting guidelines. If a specific decision variable is shows a high risk, a decision reason that details why that variate is high will be included, but only one reason will be provided for each variate. For example, return ONLY valid JSON in this format (no extra text or explanations):

```
{
  “address”: “${address}”,
  “decision”: “underwrite”| “decline”| “endorsement”| “acv”,
  “decisionSupplement”: “string (e.g. recommended coverage)”,
  “decisionReasons”: [“array of reasons”],
  “decisionVariates”: {
    “crimeRisk”: number,
    “perilRisk”: number,
    “conditionRisk”: number,
    “prideOfOwnershipRisk”: number,
    “valueRisk”: number
}
```

The next step is prompting the LLM for the formatted response 1016, which will receive the formatted AI attributes, as well as receive data from various data sources including uploaded data sources 1018, archived data sources 1020, real time data sources 1022, configuration settings 1024, and the like. It should be noted that the various data sources may provide data in a plurality of differing formats that may need to be modified (normalized and formatted) for use by the LLM. For example, real time data may need to be formatted or processed to coincide with or be comparable with uploaded data or archived data that may be in a different data format, scale, and the like.

The system 1000 will then proceed to parse the formatted LLM response into text, graphs and imagery 1026, after which, the system will generate a report 1028.

Turning now to FIG. 64, the system processes are shown in greater detail, particularly the gathering of data from various data sources. The various data sources may include underwriting rules 1040, claims guidelines 1042, insurance regulations 1044, hazard data 1046, vulnerability data 1048, as well as other data sources 1050 (refer to FIGS. 35-44 for various data types). This is not intended to comprise a complete listing of all data sources but is provided to illustrate some of the various types of data that can be used by the system.

Once all the data is gathered/received from the various data sources, the system can then aggregate the data 1052 from the data sources. The aggregated rules/guidelines/data can then be validated 1054 and/or pre-processed and stored 1056 for later retrieval by the system in evaluating various properties for underwriting or claims adjustment.

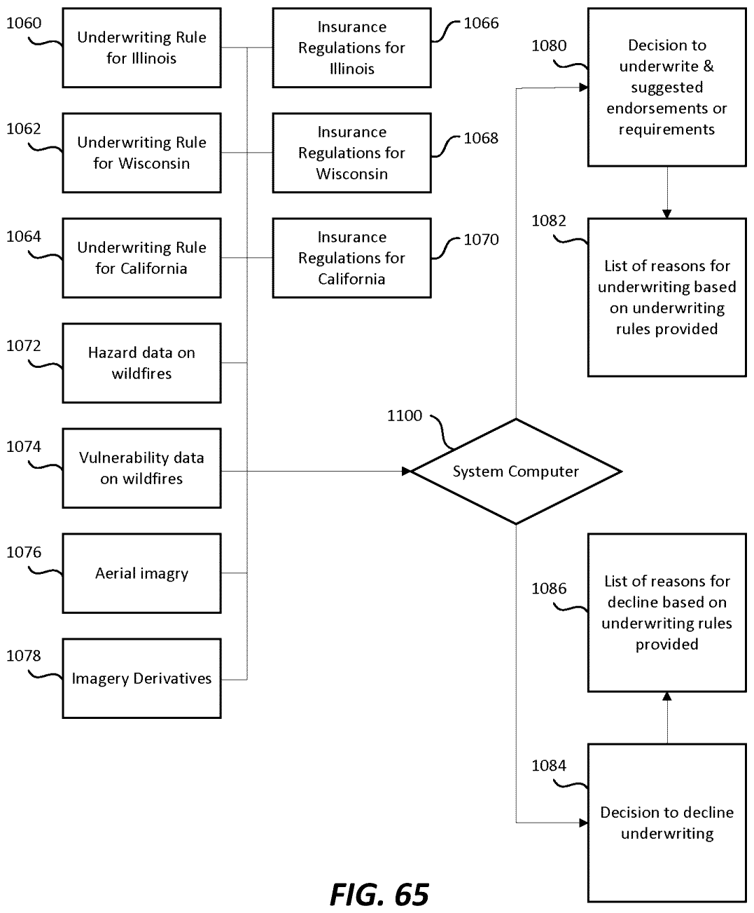

FIG. 65 illustrates one configuration of the system 1000 in which an evaluation as to whether to underwrite a property is automatically taken by the system 1000.

System 1000 receives various data that must be considered when determining whether a property meets the underwriting guidelines of a company. Some of the data that must be considered are the rules for various states (e.g., underwriting rules for the state of Illinois 1060, or underwriting rules for the state of Wisconsin 1062, or underwriting rules for the state of California 1064). In addition to the underwriting rules, insurance regulations for various states must also be considered (e.g., insurance regulations for the state of Illinois 1066, or insurance regulations for the state of Wisconsin 1068, or insurance regulations for the state of California 1070).

Additional data to be considered may include hazard data on wildfires 1072 and vulnerability data on wildfires 1074. Based on the geographic area of the address and historical information, a hazard score can be generated for the property. Likewise, based on the attributes of the property itself, including for example, construction materials used to construct the building(s) on the property, as well as the current maintenance and upkeep of the property, can have a large impact on a vulnerability score associated with the property.

Another category of data is aerial imagery 1076, which can be pulled and analyzed by the AI model. This aerial imagery could be pre-processed allowing for enhanced viewing of the property to identify risk factors that could raise or lower a vulnerability score associated with the property. For example, relatively large amounts of flammable materials on the property could increase the vulnerability of the property, whereas inflammable materials such as swimming pools, concrete surfaces or barriers could function to lower the vulnerability. A quantity of underbrush on the property could also positively or negatively impact the scoring of the property (i.e., for fire risk) and so on.

Also provided are imagery derivatives 1078 that can be considered by the system. The AI model can intake other structured and non-structured data beyond imagery and derive non-imagery input vectors on that data (i.e., assessor data, weather data, permit data, replacement cost data, claims data, and the like) associated with the property.

Additionally, it is contemplated that aerial imagery accessible by the system may be incomplete. In such cases, the system can utilize or leverage AI to process the image data and extrapolate from the information that is digitally available generating image vectors. Additionally, images can be enhanced via AI to provide additional data relating to the property, which could include identifying the types of materials used in construction, remediation performed on a property after an initial refusal, or any other process that can provide the system with more data and information on which to base a decision in accordance with the underwriting rules of the company.

All the above information is then received by system computer 1100, which then will automatically determine whether to underwrite the property, or recommend actions to be taken if insufficient information is available to make the decision. The recommendation could include approving or rejecting a request based on the analysis, or recommending to take additional action before making a decision to approve or reject the request. Further action may include at least one of requesting a site inspection, preparing an additional report, making an enquiry to the owner.

If the decision is to underwrite 1080, the system will include suggested endorsements or requirements. The system will then proceed to list reasons for the underwriting decision 1082, which will be based on the underwriting rules provided. Alternatively, the decision could be to decline to underwrite 1084. In this case, the system will then proceed to list reasons for declining underwriting 1086, which will be based on the underwriting rules provided.

In the example provided in FIG. 65, it is further contemplated that claim adjustment can be automated in a similar way. For example, a user can log in to system computer 1100, input or select property details, and submit a claim on a property. In such a situation, the system can then gather information from various sources, including, for example, aerial imagery of the property that provides both before and after incident property data, which may include image data, non-imagery data or both.

The system then gathers information from various sources (e.g., historical information on severe weather during the time frame of the claimed damage from various weather sources; or reports from agencies, such as police and fire, relating to the timing of the claimed damage) to provide corroboration relating to the claim and actual damage incurred at the property.

Still further, additional resources could be accessed for data relating to the costs associated with the claim. This could take into consideration the extent of the damage, the building materials needed, the geographic location that can correspond to labor costs, as well as the state and local regulations regarding clean-up and disposal of debris. All this information can be compared against the underwriting policy, to determine the extent of coverage and liability.

Various insurance laws and regulations of the jurisdiction in which the claim occurred would also have to be considered. It is possible that further information may be needed for the system to process the claim including a request for specific information from the claimant to be submitted, such as, for example, data relating to subrogation and whether additional or alternative insurance is available for the claim.

Intelligent document ingestion interface with real-time document parsing validation. The system includes an intelligent upload interface designed to handle underwriting rule documents efficiently and accurately. It provides immediate feedback, real-time visibility into processing status, and automated checks to ensure each file is valid and correctly classified before extraction begins.

Context file validation. As soon as a document is uploaded, the system scans its content to check if it contains extractable underwriting rules. Files that are missing key metadata or are unlikely to useful are flagged early, saving time and preventing unnecessary processing.

Automatic classification by region and product. Documents are automatically tagged with the appropriate state or region and line of business. If the system detects missing or conflicting information, the document is added to the review queue for confirmation.

Real-time processing queue. Users can see exactly which document are uploading, processing, or ready to extract. Status indicators keep the workflow transparent, while warnings (e.g., duplicate detection or metadata issues) help users resolve problems quickly.

Document readiness insights. Once a document is fully processed and validated, it appears in the “Ready” panel with a summary of detected rules, allowing users to proceed confidentially to extraction.

This interface lays the groupwork for accurate, scalable rule ingestion by validating, sorting, and surfacing document issues before extraction even begins.

Smart extraction review interface with linked source context and AI-prioritized validation workflow. The system includes an interactive extraction review interface that allows users to validate AI-suggested rules directly against the source documents they were pulled from.

It streamlines review by combining confidence scoring, inline editing, and real-time linking between source text and extracted logic.

Side-by-side rule and document view. Users can review each AI-extracted rule alongside the original source PDF, with both panels kept in sync. Clicking on a rule highlights the corresponding text in the document, and vice versa.

Confidence-based triage workflow. Every rule is assigned a confidence score based on factors like text clarity and algorithm certainty. Rules with low scores are surfaced first for review, helping teams focus on what needs human validation.

Bidirectional source-rule linking. Interactive links connect each extracted rule back to its origin in the document, making it easy to verify accuracy without switching context to manually searching.

Structured rule review panel. Each rule is displayed with is category (e.g., eligibility, coverage), confidence level, and quick actions to Edit, Confirm, or Reject. Filters let users sort by status or rule type for streamlined batch review.

Human-in-the-loop validation. Rules move to the next stage after human confirmation, ensuring only accurate, trusted logic enters the rule management workflow.

This interface brings AI and human review together in a single, transparent flow making rule extraction faster, more accurate, and fully auditable.

Context-aware rule review interface with hybrid AI-human workflows and real-time progress tracking. This system includes a dynamic rule management dashboard that helps users track, review, and manage underwriting rules with real-time visibility and AI-enhanced context. It brings structure and clarity to complex rule review workflows by combining automatic data extraction, visual status tracking, and intelligent filters.

Adaptive filtering by rule status. Tabs automatically update to reflect the real-time status of rules (e.g., Draft, Needs Review, Approved), helping users focus on what needs attention and move through workflow efficiently.

AI-enhanced rule data extraction. Each rule includes pre-filled metadata such as rule ID, name, logic, geographic scope, and confidence score, all generated by upstream AI extraction. This reduces manual effort and enables scalable triage.

Workflow progress tracking. A persistent progress has shown what percent of rules have been reviewed, alongside a counter showing how many are ready to publish. Each row includes a clear status indicator to support at-a-glance understanding.

In-line editing and navigation. Clicking on a rule opens preview panel with more detail and quick navigation between rules, streamlining the review process while keeping users in context.

Publish-readiness visibility. Rules that meet system criteria (e.g., reviewed and approved) are flagged for publishing, with a single action to move them forward.

This interface brings together human oversight and machine support in a unified workspace, making complex rule management more transparent, efficient, and scalable.

Contextual Rule Editor Interface. A contextual rule editor that allows a user to review, refine, and finalize underwriting rules extracted from source documents. It combines AI-suggested inputs, manual override capabilities, and dynamic logic configuration with collaboration tools, compliance tracking, and full version control.

AI-powered rule population. Fields such as rule name, logic, description, and applicable state/product are pre-filled based on AI extraction from source documents. Underwriters can freely edit, override, or enrich this information before final approval.

Linked logic and live data testing. Rules include configurable “If-Then” logic that links to live data sources (e.g., Nearmap® property attributes, third-party risk scores). A built-in test runner allows users to validate logic performance in real time before saving.

Collaborative commenting and tagging. Each rule supports in-line commenting and tagging of team members, enabling asynchronous collaboration, peer review, and assignment workflows. Comments are tracked per version for full traceability.

Definition builder with ontology integration. A dedicated “Definitions” tab links rule terms to both the Nearmap® ontology and customer-specific terminology libraries. The system proactively suggests terms that may need defining, highlights conflicts or inconsistencies, and enables one-click linking to standard or custom definitions.

Supporting documentation upload. Users can attach external documents (e.g., actuarial reports, regulatory PDFs, product specs) to any rule, preserving full context for future reviewers and auditors.

Rule source history and audit trail. A “Source and History” tab shows exactly where each rule came from, including document source, extraction date, and user modifications. An automated audit trail captures every edit, comment, and approval action.

Version control and rollback. Every rule version is stored, allowing users to compare changes over time and revert to a previous version if needed. This ensures safe iteration and compliance with regulatory audit requirements.

Priority and rule type tagging. Each rule is tagged with key metadata including line of business, state, rule type (e.g., eligibility, pricing), and business priority. These tags support workflow routing, filtering, and downstream automation.

A rule testing environment enables underwriters to simulate the impact of logic changes before deployment. It provides real-time visualization of how a rule will behave when applied to sample properties or data sets, helping users assess business outcomes and make data-driven decisions.

Sample data test settings. Users can configure parameters to preview how a rule will operate on specific property profiles or representative policy segments. Adjustments (e.g., thresholds, modifiers, logic variations) can be applied in real time.

Dynamic impact simulation. Once test settings are configured, users can run a scenario to instantly view predicted outcomes across key business metrics including expected loss, loss ratio, affected policies, and average premium impact.

Before versus after comparison. The impact panel clearly breaks down metric values before and after the rule change, showing absolute and percentage changes. This makes it easy to understand trade-offs and benefits of different rule configurations.

AI-generated recommendations. An embedded AI assistant provides guidance based on the test results, for example, suggesting whether a rule should be tightened, relaxed, or combined with another logic condition to optimize outcomes.

Sample set adaptability. Testing can be performed on a single property profile or scaled up to a full sample set helping users evaluate rule sensitivity and robustness at different data volumes.

Save or revert logic. After testing, users can retune to the rule editor or save the simulated logic directly ensuring a seamless feedback loop between experimentation and deployment readiness.

The system includes a structured rule creation interface that enable users to manually define underwriting rules or automatically prefill fields using AI-driven document parsing. This interface streamlines rule authoring, ensures data consistency, and supports downstream validation and deployment. The system key innovations include:
AI-assisted rule prefill: Uploaded documents are scanned using natural language processing to extract rule candidates, which automatically populate fields such as logic, data source, and classification.
Structured rule authoring: Users input metadata including product, state, rule type, and data item alongside freeform rule logic, ensuring both flexibility and standardization.
Integrated relationship mapping: New rules can be directly linked to related or overriding rules, supporting traceability and conflict detection.
Context-aware field population: Rules are defined in the context of the data source and attribute they rely on, enabling direct validation with connected systems.

They interface supports both immediate rule publication and submission to a review workflow maintaining control across varying levels of rule certainty.

A further step in the rule analysis flow is a rule publishing interface that gives users a clear summary of changes, projected business impact, and formal approval checkpoints before deployment. It enables confident, traceable publication of underwriting rules to production systems. Key innovation include:
Predictive impact analysis: Before publishing, the system forecasts changes in key metrics such as, approval rates and manual review rates, using historical data and simulated evaluation outcomes.
Change summary and audit log: Users are shown a breakdown of how many rules have been added, updated, or left unchanged. A detailed comparison of proposed versus existing logic is accessible for full auditability.
Formal approval confirmation: Built-in compliance checkboxes ensure rules are only published when users explicitly acknowledge the impacts and alignment with risk appetite.
Production-ready deployment: A single-click “Publish to production” workflow immediately activates the new rule set for future property evaluations.

This interface bridges the gap between technical rule logic and business decision-making, ensuring transparency, accountability, and operational safety.

The system includes an integrated property evaluation interface that allows underwriters to review automated recommendations and make final decisions based on a blend of AI, aerial imagery, and underwriting rules. It bring all relevant property, risk, and rule data into one workspace, with full transparency and override controls.

Unified property view with AI recommendation. The system aggregates data from imagery, property metadata, and rule evaluations to deliver a clear underwriting recommendation (e.g., Approve or Deny), alongside a confidence score and supporting rationale.

Interactive aerial imagery with overlays. Nearmap® imagery is combined with AI-detected attributes (e.g., roof condition, swimming pool presence, and the like) and custom overlays to give underwriters spatial context for each decision.

Rule-driven decision summary. One panel includes a breakdown of which underwriting rules were applied, what conditions were met, and the resulting overall risk score giving users transparency into how the decision was reached.

Property data and risk scores in context. Tabs provide additional access to historical assessments, flagged risks, rule-level checks, and raw property information, allowing underwriters to drill down into any aspect of the decision.

This interface enable confident underwriting by blending automation with expert review, ensuring every property decision is fast, explainable, and backed by high-quality evidence.

The system implements a novel continuous monitoring architecture that automatically correlates incoming data streams against the entirety of an insurance portfolio in real time, reducing the need for manual analyst intervention in initial risk detection. The system's distinctive approach includes:
Multi-source fusion: Proprietary integration of aerial imagery (including Nearmap® datasets), AI-generated location intelligence, weather prediction systems, risk assessment databases, and news content parsing.
Portfolio-wide correlation engine. Simultaneously analyzes new data inputs against all policies and properties within the portfolio, rather than conducting isolated property-by-property assessments.
Predictive notification triggering. Machine learning algorithms that identify emerging risk patterns before they manifest as claims, providing preemptive risk intelligence.

The system generates interactive notification elements containing embedded metadata that enables single-click navigation to dynamically constructed analytical reports.

Upon user interaction with the notification interface element, the system executes a novel real time report construction process that synthesizes data from multiple disparate sources into a unified analytical document. This automated assembly includes:
AI-generated executive summary. Natural language processing creates contextual explanations of detected patterns without human intervention.
Filtered portfolio segmentation. Automated identification and linking to affected policies/properties.
Quantitative impact modelling. Real time calculation of high-level exposure estimates and financial impact projections.
Geospatial visualization. Dynamic map generation displaying affected properties with risk overlay visualization and interactive drill-down capabilities.

The user can interactively explore how different factors affect their portfolio by adjusting parameters on the screen and immediately seeing updated results on the screen. These parameters include risk, probability, business rules, and the like. As the user adjusts inputs in real time, the resulting portfolio metrics are accompanied by a colored dot to indicated positive or negative changes or positions, enabling easier understanding of each change.

The system uses a floating AI chat interface on the screen that stays collapsed by default so save space while remaining easily accessible, and when users click on it, it expands to show the full conversation history. This creates a unique visual connection between the AI chat and the entire screen instead of being tucked away in a corner or sidebar, which established the idea that the AI assistants conversations relate to and influence the whole page rather than just one section. Users can interact with the AI assistant using everyday language such as asking questions, making requests, or suggesting “what if” scenarios and the system automatically adjust the relevant parameters in real time, letting the user immediately see how different strategies or approaches would play out as they chat with the AI. The bottom-center positioning reinforces that these conversational interactions affect the entire screen's functionality rather than just isolate parts of the interface, creating a seamless experience where natural language drives comprehensive system control.

The system provides a novel interface for delegating and supervising AI-driven tasks within an application. A user may initiate task delegation by assigning a task to AI. In response, the system generates a proposed action plan based on contextual data and presents it for user review. The user may approve the plan as-is, modify the proposed steps, or reject the plan entirely. Only after confirmation does the AI module begin executing the task.

The system further incorporates a persistent, application-wide popover panel that serves as a control and feedback hub for AI activity. This panel is accessible via a dedicated navigation icon regardless of the users current location in the application interface. The panel uniquely provides:
Real time progress tracking for ongoing AI tasks, updated dynamically as execution proceeds.
Live task management controls, allowing the user to pause, alter, or otherwise interview in active AI tasks without leaving the current workflow context.
A historical record of completed AI tasks, enabling post-task review and traceability.

This combination of delegated planning, user-editable execution steps, and centralized real time oversight via a persistent interface improves transparency and user agency when interacting with autonomous AZI systems, addressing limitations of conventional “black box” automation tools.

The system provides significant advantages to currently known systems for the following reasons.

1) More accurate risk assessment. As property conditions and characteristics change, property insights can get outdated quickly. With AI-derived risk factors based on frequently updated, high-quality imagery, accurate risk assessment decisions can be made powered by timely information.
AI-derived risk analysis is based on high-resolution vertical aerial imagery that's updated regularly.
130+AI-derived layers are provided to ensure a comprehensive risk assessment (which are provided under “Listing of AI-Derived Layers”.
The AI detections are converted into a Roof Spotlight Index and peril scores for easy and complete risk assessment.

2) Fast & accurate decision-making in workflow. Underwriting and claims processes are streamlined with relevant risk insights integrated into a company's workflows.

Easier and more accurate risk assessments lead to lower inspection, underwriting, and claim adjusting costs.
AI-derived risk analysis empowers virtual inspection that takes minutes instead of weeks.
Integration with key core systems like Guidewire® or DuckCreek® increases underwriting efficiency.
All AI detections and scores are available via API for rapid consumption and via External Data Warehouse for further analysis.
Flagging engine allows flagging of high-risk properties (low score), and empowers straight-through-processing of low-risk properties (high score) based on thresholds.
All AI detections are pre-processed and the delivery speed via API is under 1 second, ideal for quoting use case.
Pre-processed insights also increase the system's loading speed and overall efficiency.
Multiple delivery methods are used to optimize efficiency:
   Underwriting Efficiency: Core System integrations.
   Data Analysis Efficiency: EDW.
   Quoting Efficiency: API (pre-processed for rapid quoting).

3) Proactive communication with policyholders & agents. With comprehensive insights including the type, location, size, and confidence score of each AI detection, insurers can leverage these transparent AI insights to proactively communicate with policyholders and encourage mitigation steps to lower exposure to insurance companies and to lower premiums to policy holders.
Highlight of the AI detections on the user interface tells underwriters the type, location, and size of the issues.
Confidence score of the AI detections and scores.
Transparency empowers proactive communication and encourages mitigation steps as opposed to being only reactive to loss events.
Transparency also allows a user to actively visualize the data the insurer is considering in making decisions relating to the insured, allowing for more meaningful communication between the policy holder and the insurer.

4) Encourage Proactive Risk Mitigation. Both insurers and policyholders are equipped with the knowledge to take proactive steps, fostering safer and more resilient communities. For example, an insurer may want to mitigate risk, but a policy holder may also want to have access to data relating to their property allowing them to take steps to mitigate risk. The system can provide the insured with a powerful tool to help them understand the risks better and how to take necessary steps to lower risk whereas the AI-derived insights and image data can provide concrete feedback to insurers that mitigation steps have, in fact, been taken by the policy holders.

5) Portfolio Benchmarking. This allows insurers to look not only at their customers particular property being discussed/reviewed, but to get average scores of properties around the insured. For example, an insurance carrier has insured properties in the Cleveland area that average a risk score of X. The insurance carrier can determine what all properties in the area score, (i.e., an average of Y). This enables the insurance carrier to see the difference between X and Y to see if they are insuring properties that are either above or below the average risk values in the region.

Listing of AI-Derived Layers. The following comprises a listing of the 130+AI layers currently available in the system. While the following are provided as current layers, it is contemplated that additional layers will be added as functionality increases. For example, it is conceived that over 1,000 layers may be provided providing various insights to properties over a wide range of data sources. Property may comprise individually owned private property, or may comprise publicly owned property, such as, streets and traffic equipment (signs, signals, painting on roadways, crosswalks and the like). While the listing of layers includes an associated number, the numbering is not strictly sequential.

0. Natural body of water, which is often irregular in shape. Includes: Ponds. Lakes. River. Harbor. Ocean. Temporary water bodies (floods). Usage Notes: Confidence scores tend to be lower than other classes, so a lower threshold may need to be set rather than the usual 50% to pick up all the water bodies you want. Some larger water bodies (harbors, oceans) may exhibit holes a long way from the edges.

1. Swimming pool. Includes: Backyard swimming pools (square, round, “jellybean”, and the like) and large outdoor community swimming pools. Ocean swimming pools (with man-made structure). Swimming pools with a cover (soft or hard). Swimming pools occluded by trees. Above or in-ground pools.

2. Roof. Includes: Roof of a permanent structure such as a house, unit, commercial building, garage, large garden shed, carport. Rooftop gardens. Any material (tiles, corrugated iron, wood, concrete, and the like). Partially installed roofs-only the part which has been installed. Roofs that can be used for other purposes (for example, dining area), but are primarily designed to keep the weather out.

3. Solar panels. Includes: PV panels on houses, commercial buildings, street lights and on the ground.

4. Construction site. Includes: Demolished building site (bare) with ground prepared for construction. Partially constructed building (roof not yet installed). Part of a building being constructed (for example, roof repairs or extensions). A completed building undergoing repairs, extensions or renovations. Presence of cranes, trucks, scaffolding, and the like. Usage Notes: Confidence scores can be very low in parts due to the wide range of visual appearances of construction, so careful selection of a threshold to suit the use case is important. Areas are likely to be highly dependent on threshold choice.

5. Car. Includes: Semi-trailers. Construction vehicles. Motorbikes. Scooters. Bicycles. Campervans. Caravans. Trailers. Disassembled or rusted cars that cannot be driven. Usage Notes: Closely packed vehicles may be difficult to distinguish from one another, so the area of the cars is the best guide in a parking lot for number of vehicles.

6. Tarpaulin/Shade Cloth. Includes: Tarpaulins (on roof or suspended in air). Shade sails. Shade cloth. Awnings. Plastic sheeting on roof. Usage Notes: Because this layer combines both shade cloths and tarpaulins used for temporary repair, context is key. Presence on a building would usually indicate temporary repair to a roof. Presence off a building would usually indicate a shade cloth or sail.

7. Power Pole. Includes: Poles carry power lines, lights, fiber optic cables, mobile antennas, and other equipment, they can be large ones on highways, or small suburban ones, made of wood, metal, or composites. Usage Notes: The most natural analysis relies on identifying the centroid of each raster “blob” of pole. Analysis indicates that these centroids are on average within around half a meter from the actual pole base location in the image.

8. Medium & High Vegetation (>2m). Includes: Trunk, branches and leaves. Green or dry (including trees without foliage) vegetation. Climbers and creepers if they are higher than 2m. Usage Notes: The model picks up leaf off trees very effectively, but areas may be slightly reduced-so matching seasons is recommended for change analysis.

9. Low Vegetation (0.5m-2m). Includes: Trunk, branches and leaves. Bushes that are smaller than a tree, but more than just low ground cover. Hedges. Vegetation higher than 0.5 m, lower than 2 m. Green or dry vegetation. Climbers and Creepers if they are higher than (0.5m-2m). Usage Notes: The model picks up leaf off bushes very effectively, but areas may be slightly reduced-so matching seasons is recommended for change analysis. Confidence is lower than the Medium/High Vegetation layer, so it may need a lower threshold.

10. Very Low Vegetation (<0.5m). Includes: Things like plants in a garden bed. Vegetation lower than 0.5 m. Any condition, green, patchy or dry vegetation. Usage Notes: This layer tends to have quite low confidence scores, as small plants can be difficult to pick up clearly. It will pick up rough native grasses that 11-Lawn Grass does not.

11. Lawn Grass. Includes: A lawn (in any condition-green, brown, patchy). Regularly mowed or maintained in any form, ex: by grazing cattle, Lawn in a park, road, garden, private property. Natural form of lawn. Usage Notes: This layer tends to have strong confidence scores on well-maintained lawns.

12. Natural (soft). Includes: Natural soft surface without any vegetation, a barren land/area, could be any area such as a road, garden, park, play field, crop field, beach, construction sites where the mud is dug out etc. Usage Notes: Tends to mix with dead or poorly maintained grass-combining with Lawn Grass can allow you to identify poorly maintained lawn or identify areas of earth with no vegetation.

13. Natural (hard). Includes: Sometimes areas such as retaining walls, or on a waterfront, have deliberately paced rock that is effectively very large gravel. Includes rocks >10 cm. A sandstone path through a garden if the rock shapes are a “natural” style (e.g. various shapes of stepping stones, rather than a carefully laid path. Rocky outcrops in areas such as national parks, parks and beaches. Usage Notes: Relatively uncommon, but useful in particular situations.

14. Concrete Slab. Includes: Any flat surface area that is made up of concrete. Flat concrete roofs. Concrete roads and driveways. Usage Notes: Can show up on some roofs that are similar in appearance to concrete. Typical use would mask this out with the vectorized building layer.

15. Asphalt. Includes: Any surface that has black asphalt. Asphalted roofs, roads, driveways, car parks. Asphalt athletic courts. Usage Notes: Note that there is a high correlation with roads, however some asphalt surfaces are not roads (such as some basketball courts), and some roads have concrete or dirt sections. Combine with 17-Road (Drivable Surface) layer.

16. Power Line. Includes: Cables between power poles. Cable between poles and buildings if there is at least a pair of cables (single cables may not be detected). Cables above railway lines. Usage Notes: Simple vectorization is unlikely to be completely successful, as the lines can be broken where they are very difficult to see due to lighting or tree cover.

17. Road (Drivable Surface). Includes: Regular roads. Carparks. Painted islands. Driveways. Private roads. A track that has been made naturally due to repeated compression by car tires. Usage Notes: Take careful note that this is a drivable surface-so it deliberately includes car parks, driveways, dirt roads, etc. To get only public roads, you could subtract the driveway layer, and you′d mostly get that.

19. Tennis Court. Includes: Public or private tennis court. Any surface (e.g. grass, clay, cement), Multi-purpose courts. Tennis markings and other sport markings. Courts without nets. The space around the outside of the markings. Usage Notes: Tennis courts are an impervious surface, but they are also of interest in their own right, for understanding which land can be developed upon in future, availability of recreation in an area, etc.

20. Driveway. Includes: A driveway made of any surface, including cement, asphalt, grass and the like. Small driveways that only cross a curb before going into a garage. Tracks on dirt/grass made by repeated car travel between public road and a property. Usage Notes: This layer may be useful if combined with materials such as asphalt and concrete to determine the material of the driveway.

21. Residential Chimneys. Includes: Entire chimney ‘tower’, not just the pipes, Gas flue/vent, Light industrial/commercial chimneys on top of buildings (not stand alone cooling towers), where the chimney structure is small compared to the size of the building, and they look similar to chimneys on a residential home.

22. A/C Condenser Unit. Includes: A/C condenser units whether mounted on roof or otherwise visible next to building. Evaporative Cooling units.

23. Residential TV Antenna. Includes: Small antenna on building roofs. Small antenna in other places (on caravan roofs, or occasionally on the ground in e.g. a temporary setup).

24. Solar Hot Water. Includes: Tank and Panel Units with just 2 panels usually, and piping from the panels to a tank (whether the tank is visible or not). Fabric/flexible Panels that are at an angle, and you can see the curve in the fabric. These are typically 1m×3-4m, whereas PV panels are almost always 1m×2m. So solar hot water looks like “long” rectangles, Fabric/Flexible Sheeting similar to the above (flexible plastic pipes stuck together), but not divided into panels. Any other styles of solar hot water systems you encounter.

25. Translucent Roofing. Includes: A roof cavity deliberately designed to let in light, covered with a translucent material. This includes glass atriums, domes and many large areas of glass paneling in commercial buildings, as well as residential skylights. It includes a permanent greenhouse that is purely made of translucent glass or hard plastic.

26. Trampoline. Includes: Any shape and size of trampoline (rectangular or circular). Trampoline with or without net for safety. Trampoline in a backyard or in a front yard. Above ground or in-ground trampolines. Occluded trampolines.

27. Tile. Includes: Any tile roof regardless of material (we cannot distinguish between ceramic tiles, concrete tiles, or other material, only that they are tiles).

28. Shingle. Includes: Any shingle roof, regardless of shingle material (we cannot distinguish between wood, metal, laminated asphalt, or any of the numerous shingle materials). Usage Notes: This layer may be useful if other raster analysis is already being performed, and the precise area and location of the roof material is needed.

29. Metal. Includes: Any metal roof, regardless of whether it is smooth, corrugated (wobbly), or with distinct ridges.

30. Hip. Includes: Hip roof in any configuration including complex hip roofs. Pyramid Hip, Intersection Hip, Hip and Valley.

31. Gable. Includes: A gable roof in any configuration including complex gable roofs. Includes ‘box gable’ because you can't distinguish gable from box gable using overhead imagery.

32. Dutch Gable. Includes: Standard gables. Dormer windows.

33. Flat Roof (Deprecated). Includes: Any kind of flat roof, made up of any material. Partial flat roofs in multi-storied buildings.

36. Gambrel. Includes: Barns often have gambrel roof shape, but different building types can also have this shape.

37. Turret. Includes: Full round turrets. Partial turrets (e.g. on the front of the first example below).

53. Tree Overhang. Includes: Dead trees/trees with no leaves. Refer to the definition of Vegetation.

54. Light Pole Base. Includes: Street lights, flood lights (for lighting of parks, ovals). Any vertical pole with light attached. Power Poles (but only if the power pole also has a light attached). Traffic light poles (but only if the traffic light pole also has a regular street light attached). Usage Notes: The most natural analysis relies on identifying the centroid of each pole. Analysis indicates that these centroids are on average within around half a meter from the actual pole base location in the image.

69. Pedestrian Crossing. Includes: Partially occluded crossings, e.g. where a car is covering a part of the crossing. Pedestrian crossings which are also speed bumps.

74. STOP Marking. Includes: Stop signs on poles. Markings intended for cyclists or pedestrians. The solid line in front of the STOP marking.

75. Raised Carpark. Includes: Driveways, ramps or access roads to the car park. Areas designed for walking within the car park. Walls or barriers within the car park. Multi-story car parks (entire building is car park) and roof top car parks (lower levels are used for purposes other than parking).

76. Raised Structure. Includes: Structures that are not made for humans to inhabit such as water tanks, silos, large statues, and the like. Ramps up to or between buildings. Roads, bridges, and overpasses that require support.

78. Wheeled Construction Vehicles. Includes: Purpose-built construction vehicles with wheels that are currently located at a construction site. Usage Notes: Construction Sites are complex, involving many stages and sub-types. The presence of wheeled construction vehicles may be a useful indicator of active construction and excavation work (rather than dormant sites, or those in the later stages).

79. Fixed, unwheeled cranes. Includes: Unwheeled construction cranes are typically indicative of active construction sites with medium to large projects. They are rarely used in residential settings and are used on commercial and industrial buildings and other projects.

80. Building Under Construction. Includes: Buildings with parts at least 1.5m above ground level that are incomplete. Both residential and commercial/industrial buildings. Usage Notes: This layer helps refine the state of a construction site in two ways-the physical location (it is constrained to the actual building, not the entire site), and the stage (initial preparatory work including foundations are ignored). The most common cause of error will be the inclusion of structurally damaged roofs and buildings, as it can be difficult to visually distinguish between e.g., exposed rafters due to damage, and due to active construction work.

81. Structural Damage. Includes: Structural damage caused by catastrophic events (such as storms). Structural damage caused by long term degradation to the point of failure. Supporting Roof Condition Confidence Statistic (RCCS). Usage Notes: Structural damage is most useful to assess buildings after a catastrophic event-however it can also detect buildings that are run down to the point of no longer being habitable. The expectation is that a roof with structural damage must be urgently repaired to keep the building habitable.

82. Roof with Temporary Repair. Includes: Tarpaulins of various colors and other temporary roof repair materials. Supporting Roof Condition Confidence Statistic (RCCS). Usage Notes: This layer can be used to track the repair and recovery process after a catastrophic event, as structurally damaged roof shifts to temporary repair, then construction and ultimately a fully recovered community. The most common error is a roof under construction which has plastic sheeting such as sarking installed, but the roof external material such as tile or shingle is not yet in place.

83. Roof Ponding. Includes: Parts of flat roof that are discolored and/or “bubbled” due to long-term water damage. Parts of a flat roof with visible puddling of water. Supporting Roof Condition Confidence Statistic (RCCS). Usage Notes: Roof ponding is a common slowly degrading form of damage for flat roofs, most commonly on commercial and industrial buildings. The confidence and area of ponding can be used to measure a change in severity over time (as both confidence scores and area will increase with the amount and strength of the staining).

84. Roof Rusting. Includes: Rust on metal roofs of any type. Supporting Roof Condition Confidence Statistic (RCCS). Usage Notes: Having roof rusting as a separate layer to other types of damage allows finer grained estimation of repair costs and remaining usable life. As with other roof damage, the confidence and area of rusting can be tracked over time to monitor changes.

85. Tile or Shingle Staining. Includes: Discoloration and staining on tiles. Discoloration and staining on shingles. Supporting Roof Condition Confidence Statistic (RCCS). Usage Notes: Discoloration and staining of tiles and shingles can be an indicator of the age and state of repair of a roof. It is unlikely to require emergency repair, however increasing confidence and area of discoloration over time can indicate a degradation of roof quality.

86. Residential Satellite Dish. Includes: Small satellite dishes on residential building roofs. Clusters of small satellite dishes on blocks of flats and the like. Small satellite dishes in other places (on caravan roofs, or occasionally on the ground in e.g. a temporary setup. Any satellites used for communications on earth (small and medium).

105. Leaf-off Vegetation. Includes: Deciduous trees in autumn or winter. Bushfire impacted trees. Hurricane impacted trees. Trees and bushes with partial leaf off (such as due to storm or disease). Dead trees. Deciduous shrubs and saplings without leaves. Damaged trees without leaves. Fallen trees without leaves. Trees with a few remaining dead leaves.

106. Junk and Wreckage. Includes: Legal rubbish dumps. Illegal dumping. Any man-objects “out of place” (such as office furniture in a pile in front of a house, or an abandoned vehicle). A building that has been damaged so badly that it no longer has a clear building structure. Parts of buildings strewn around by e.g. a hurricane. Parts of construction sites where there are piles of demolition rubble, or mixed offcuts of construction materials. Piles of waste in an open skip. Usage Notes: Official Waste Management Sites. Post Catastrophe Surveys: There is likely to be a lot of junk from destroyed buildings and property after catastrophic events like floods and hurricanes. Construction sites: Particularly a poorly maintained or abandoned construction site can have piles of construction rubbish.

107. Vegetation Debris. Includes: Uprooted trees. Broken/downed branches. Piles of green waste (for example, during the gardening process). Piles of leaf litter and dropped branches on roofs. Burnt leftovers of trees that are no longer standing.

108. Damaged Asphalt. Includes: Cracking (small or large). If the cracking is extensive, the whole road area with damage is included. If there are a small number of cracks on a stretch of otherwise uncracked asphalt, only the cracks are included. Potholes (any size), often caused by excessive rain on weakened asphalt.

109. Letters and Numbers. Includes: Painted messages on roofs and tarps. Messages written in the sand at a beach. Writing in advertising/signs. Writing as part of painted road signs. Letters and numbers. Speed limit signs (just a number by itself). Signs that have a single letter (e.g. “B” for bus stop or something).

110. Unmaintained Swimming Pool. Includes: Pools containing green or brown water. Pools where the water is murky, or not uniform in color. This is an early sign of an unmaintained pool. Pools where the water surface is completely covered with algae. All types of swimming pools with signs of unmaintained water-in ground, above ground, and the like. Pools not completely covered where you can see evidence of water not suitable for swimming.

111. Circular Manhole Cover. Includes: Round manholes in public roads (both the lid and the metal ring). Manhole covers on footpath.

112. Tires. Includes: Any tires in piles, or individually that have been discarded or stockpiled.

113. Wooden Decking. Includes: Unroofed wooden decks attached to a house. Wooden decking around swimming pools. Wharfs and jetties made of wood.

114. Dormer Window. Includes: Dormer windows. Wall dormers.

116. Natural Pervious Surface. Includes: Hard/compact dirt and gravel. Pervious surfaces not at ground level such as a rooftop garden. Synthetic grass such as Astroturf.

117. Hard Surface. Includes: Tree overhang on hard surfaces, as long as you are confident the surface is covered with one of the materials mentioned in the definition (e.g., part of a road with tree overhang). Courtyards. Unroofed decks. Area around a swimming pool, provided it is made of a hard-surface material. This must exclude the area inside the pool. Building tops that are designed for walking on such, as roof-top courtyards and raised carparks.

119. Building. Includes: Buildings under construction where the entire building is not habitable yet. Permanent roofs built to provide protection against the weather, but do not provide an enclosed space. For example, carports (including attached and detached carports), veranda, picnic shelters, bus stop, and the like. Buildings missing walls. Roofed and unroofed seating areas in sporting arenas. Attached decks without roofs and walls. Attached balconies, patios, and verandas. Water towers. Monuments that are buildings, and buildings with monuments on them.

120. Linear. Includes: Faded or damaged linear pavement markings. Linear pavement markings in any color (e.g., white, yellow, green, blue). Linear pavement markings that go over manhole covers. Markings in car parks. Linear pavement markings on airport taxiways. Paint on raised road platforms, (e.g., pedestrian islands, or roundabouts).

121. Arrow. Includes: Faded or damaged arrows. Arrow pavement markings in any color (e.g. white, yellow, green, blue). Pavement markings that go over manhole covers. Markings in car parks. Arrow markings on airport taxiways. Arrow markings on footpaths and raised structures on roads (e.g., arrows marking on refuge islands).

122. Block Symbol. Includes: Faded or damaged symbols. Symbols that cover or partially cover manholes. Block symbol pavement markings in any color (e.g., white, yellow, green, red). Tactile paving for communicating to the visually impaired. Block symbol markings in car parks and airport taxiways. Speed limit and route markings on roadways. Block symbol markings on footpaths, road curbs, or raised parts of the road such as refuge islands. Usage Notes: The purpose of this class is NOT to identify the use of the lines, in the case of pedestrian crossings. There is an existing Pedestrian Crossing class for that purpose.

123. Block Character. Includes: Faded or damaged character symbols. Characters that can be identified as text or numbers, even if the exact word or number cannot be identified. Character symbol pavement markings in any color (e.g., white, yellow, green, red). Character symbol markings in car parks and airport taxiways. Character symbols that cover or partially cover manholes.

124. Painted Lane. Includes: Solid band of paint indicating a bus, bike, commuter lane or toll road. Painted airport taxiway shoulders. Painted lanes in any color (e.g., white, yellow, green, red). Painted lanes that fully or partially cover manholes.

126. Missing Roof Tile or Shingle. Includes: Space on a roof where a piece of roof covering material is missing or completely dislodged from. Portion of roof underlayment exposed by a partially missing broken tile or shingle. Supporting Roof Condition Confidence Statistic (RCCS).

127. Roof with Permanent Repair. Includes: New shingles on existing sections of an older shingle roof. New tiles on existing sections of older tile roof. New metal panels on sections of an existing metal roof. Supporting Roof Condition Confidence Statistic (RCCS).

128. Zinc Staining. Includes: Areas of a roof with indications of zinc staining. Supporting Roof Condition Confidence Statistic (RCCS).

131. Atmospheric Occlusion-Opaque. Includes: Thick clouds or layers of water vapor, smoke, fog, or smog. Airborne dust and sand particles (haze).

132. Atmospheric Occlusion-Translucent. Includes: Thin clouds or layers of water vapor, smoke, fog, or smog. Airborne dust and sand particles (haze).

133. Building with Structural Damage. Includes: Buildings damaged by fire, treefall, wind, or other events. Areas on completed buildings missing significant material layers, such as a hole. Temporary repairs such as tarps and boarded up areas are signs that a building has structural damage.

137. Damage by Tree. Includes: Standing buildings with fallen/broken trees on top of them. Punctures or holes in building materials caused by trees. Roof with significant branch or tree debris on it.

138. Structural Loss. Includes: Foundations or basements exposed by the forced removal of sheltering materials. The site was formerly occupied by a building, whether wreckage has been cleared. Collapsed, imploded, or razed buildings of all sizes and shapes. Parts of buildings that have collapsed or were otherwise destroyed. Rubble, such as building debris in the original structure's location.

147. Ballasted. Includes: A top layer of stone or rock pieces on a flat roof.

148. Modified Bitumen (Mod-Bit). Includes: Modified bitumen-covered roof areas, including areas patched with the same material. 3-foot wide black rolled roof sheets of modified bitumen.

150. PVC/TPO. Includes: Roof systems made from one or more membrane sheets. Roofs covered with Polyvinyl chloride (PVC) or Thermoplastic (TPO) materials.

151. EPDM. Includes: Roofs currently containing a rubber membrane covering material.

152. Wood Shake. Includes: Wood shake and wood shingle roof covering materials applied to a roof.

153. Woody Vegetation. Includes: Trees, shrubs, woody vines. Bamboo. Fallen trees and tree stumps.

154. All-in Vegetation. Includes: Land and visible water-based plant life. Succulents. Rooftop vegetation. Potted plants.

197 Boat. Includes: Motorized and non-motorized vessels for personal use, from kayaks to speedboats. Boats that are located on land or water.

199. Roof Debris. Includes: Piles of leaves collected on any roof type.

200. Yard Debris. Includes: Many objects that cannot be identified mixed together in a pile.

201. Duct. Includes: Pipes. Rooftop walkways. HVAC units attached to ducts.

202. Dumpster. Includes: Covered or uncovered dumpsters of various sizes or colors.

203. Exposed Roof Deck. Includes: Visible areas of wood boards on a roof.

204. Fire Pit. Includes: Fire pits of any shape.

206. Grain Bin. Includes: Silos. Grain bins converted to houses that no longer store grain.

207. Heavy Machinery. Includes: Any wheeled heavy machinery. Lawnmowers. Bulldozers. Tractors. Forklifts. Cement mixers.

208. HVAC. Includes: HVAC units on roofs and on the ground.

211. Missing Asphalt Shingles. Includes: Area of an asphalt shingle roof where the shingles have gone missing.

212. Nonwooden Construction Material. Includes: Plastic and PVC pipes. Metal pipes and rebar. Cement pipes. Long-rectangular pieces of metal. Bricks.

214. Roof Patching. Includes: Surface patching. Seam patching.

214. Patio Furniture. Includes: Outdoor furniture in a yard or occupied rooftop.

217. Pipe. Includes: Pipes of any length and diameter installed on a roof comprising a conduit for liquids.

218. Playground. Includes: Swings. Slides. The structural part of the equipment plus any attached items.

219. Active Ponding. Includes: Areas on a flat roof with active ponding (standing water).

222. Roof Equipment. Includes: Metal boxes on a roof used to enclose equipment. Metal enclosures around HVAC units or other roof objects.

225. Clay Tile. Includes: Clay roof tiles.

228. Slate. Includes: Natural stone roof shingles on a pitched roof.

230. Built Up. Includes: Hot asphalt or built up roofs.

233. Roof Coating. Includes: A flat roof with roof coating on it.

240. Parapet. Includes: Parapets are only found on flat or bowstring truss roofs

241. Mansard. Includes: A roof that is flat on top and sloped on at least two sides

243. Jerkinhead. Includes: Half-hipped or clipped gable roof feature.

247. Quonset. Includes: Quonset roofs in any different conditions, including damaged roofs. Quonset roofs with a slight point at the peak. Greenhouses.

249. Bowstring Truss. Includes: Bowstring truss roofs.

250. Roof Walkway. Includes: Level and stepped roof walkway areas.

255. Shipping Container. Includes: Metal shipping containers.

256. Silo. Includes: Silos with or without a top.

257. Skylight. Includes: Both small skylights (seen on houses) and large glass atria (seen on large commercial buildings). Clear or opaque skylights. Flat or dome shaped. Fiberglass panel skylights.

259. Roof Staining. Includes: Green or black roof stains. White or yellow roof stains. Chimney soot stains. Mineral salt wash-off.

262. In Lanai Swimming Pool. Includes: A swimming pool enclosed by a lanai.

262. Above Ground Swimming Pool. Includes: Above-ground swimming pools.

265. Covered Swimming Pool. Includes: Swimming pool with a cover on it.

266. Debris in Swimming Pool. Includes: Debris in a swimming pool.

267. Empty Swimming Pool. Includes: Completely empty pools. Half-empty swimming pools. Pools with small puddles of water in them.

270. Trailer. Includes: enclosed/covered trailers. Mobile homes. Recreational vehicles/caravans. Truck beds. Boats.

273. Vent. Includes: All types of roof vents. Ridge vents. Roof turbine. Pipe vent. Powered Attic vent. Box vent. Off ridge vent. Galvanized steel vent. Gas flues. Cupola vent.

276. Wooden Pallet. Includes: Pallets made from wood, usually square or rectangular in shape.

277. Worn Shingles. Includes: Wear on asphalt roof shingles such as: Buckling or warped shingles. Lifting and curled shingles. Granule loss and general shingle deterioration.

280. Cracked Pavement. Includes: Any type of cracks (crocodile, longitudinal, block cracking) on any type of pavement (concrete or asphalt).

281. Disintegrated Pavement. Includes: Potholes. Asphalt raveling.

282. Repaired Pavement. Includes: Repaired cracks, potholes and other pavement maladies.

283. Exposed Underlayment. Includes: Small, medium, and large areas of exposed underlayment.

283. Significantly Stained Pavement. Includes: Puddles of stagnant water and oil stains on pavement.

297. Miscellaneous Roof Object. Includes: Rooftop billboards. Large appliances (not covered by another roof objects class). Decorative objects.

298. Greenhouse. Includes: Greenhouses of any material (glass, plastic). Greenhouses with damaged or missing plastic.

320. Building Lifecycle. Includes: Roof. Translucent Roofing. Building. Building with Structural Damage. Building with Structural Loss.

1084. Leaf-off Tree Overhang. Includes: Parts of a roof covered with leaf-off tree overhang.

1085. Low Vegetation (0.5m-2m) Overhang. Includes: Parts of a roof covered with bushes and other vegetation between 0.5 and 2m in height.

1086. Very Low Vegetation (<0.5m) Overhang. Includes: Parts of a roof covered with vegetation lower than 0.5m, but excluding short grass. Includes long (unmaintained) grass, and other low plants.

1087. Power Line Overhang. Includes: Parts of a roof covered with suspended cables that carry power, running in parallel to at least 1 other cable (excludes single cables).

1088. Junk and Wreckage Overhang. Includes: Parts of a roof covered with any junk or rubbish manufactured by humans and now discarded from its original use. Rubbish tips, abandoned vehicles, illegal dump sites, construction waste, garbage floating in the ocean and on beaches, wreckage after a catastrophe, and the like.

1089. Vegetation Debris Overhang. Includes: Parts of a roof covered with any natural debris because of storms, flooding, or other reasons where vegetation is uprooted or damaged.

1191. Flat. Includes: A roof or a part of a roof that is flat.

1193. Medium and High Vegetation with Woody Vegetation. Includes: Trunk and branches. Green or dry vegetation. Trees without foliage. Climbers and creepers if they are higher than 2m. Tall trees that have fallen including: Trees, shrubs, sub-shrubs of all sizes; Woody vines of all sizes, such as bougainvillea; Broad leafed and needle-leafed varieties. Broadleaf woody vegetation will have wide, flat leaves, such as oak, maple, and elm trees. A needleleaf is a long, thin, needle-like leaf found on pine, spruce, and fir.; Bamboo; Palm trees; Rose bushes; Woody vegetation with and without leaves and needles (leaf off); Fallen trees and tree stumps in place; Fallen tree on a building.

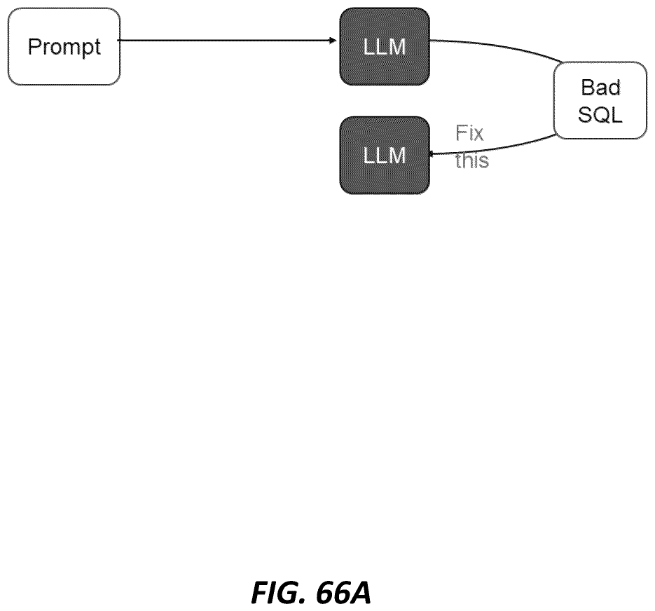

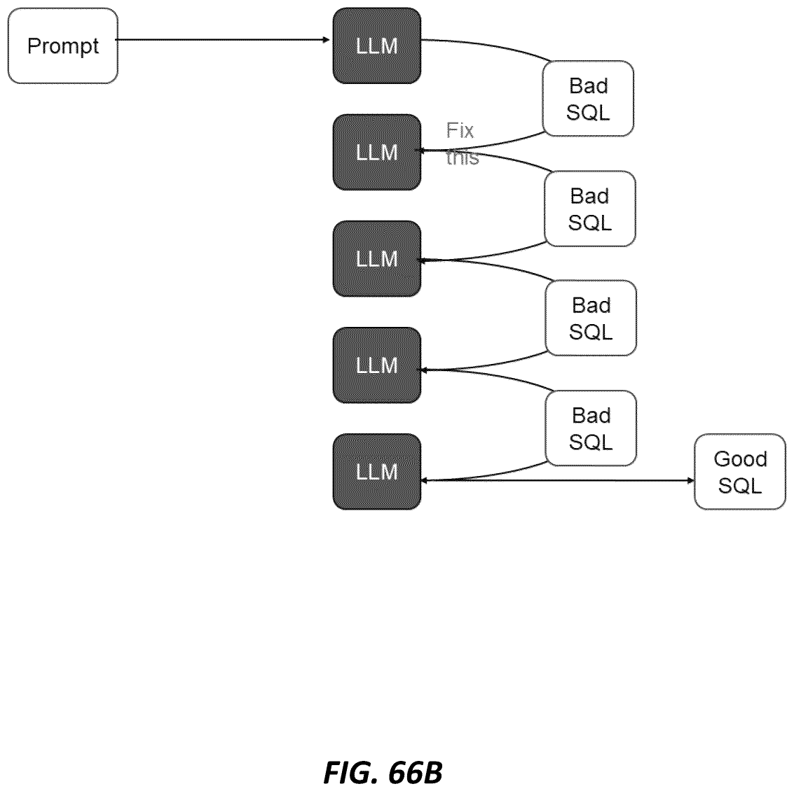

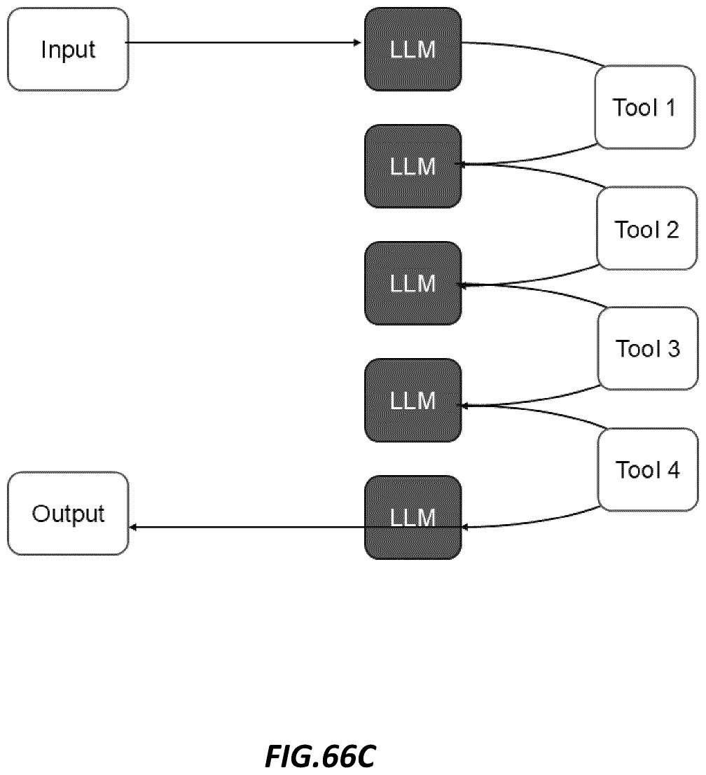

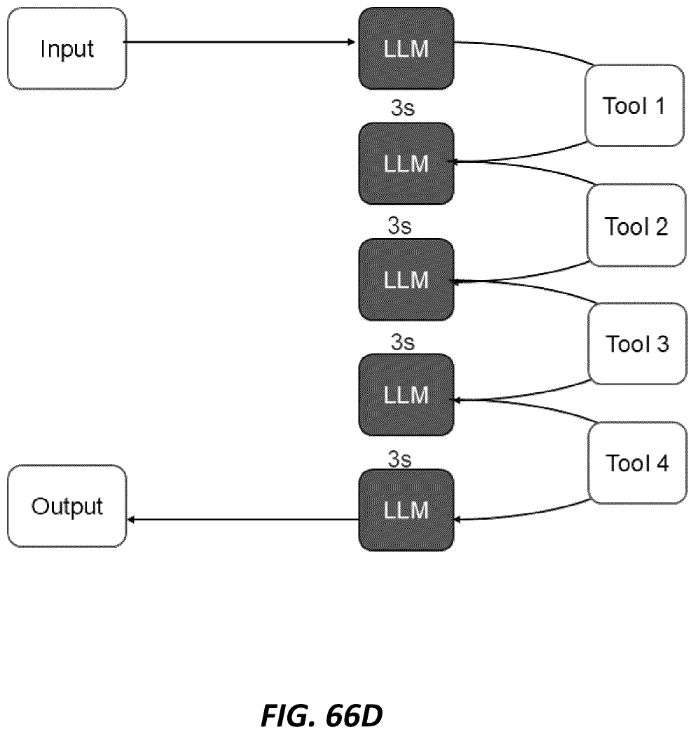

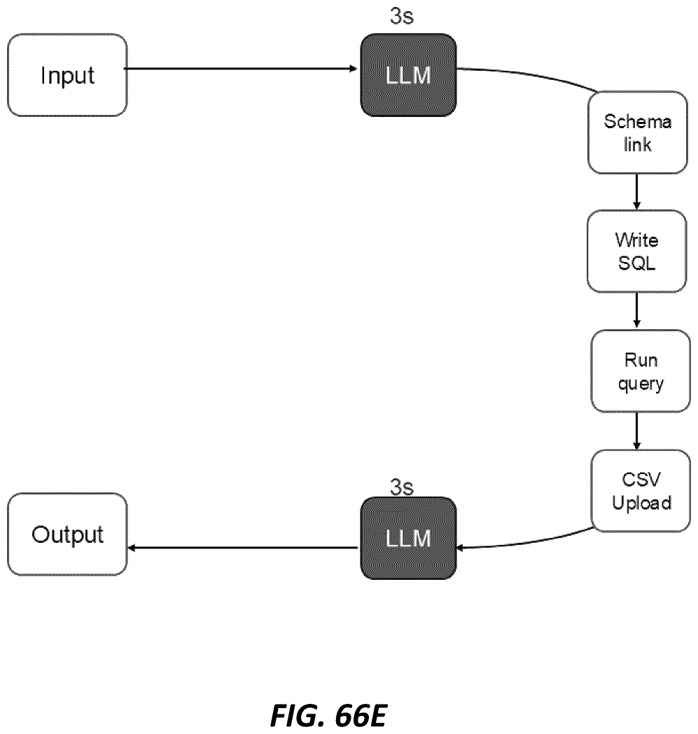

Referring now to FIGS. 66A-66D, various flow diagrams are illustrated that illustrate how speed increases for the AI model were achieved. An example of multi-prompting is provided. A user may enter a prompt to an AI module (e.g., a Large Language Model (LLM)). When an LLM is asked something, it is expected that an answer will be provided, such as a Structured Query Language (SQL). If a bad answer was provided, you go back to the LLM and ask it to fix the SQL (FIG. 66A). Hopefully after several iterations, a good answer (SQL) is provided (FIG. 66B). However, this can cause significant delays. A better LLM can help mitigate this problem.

Alternatively, pipelining could be used. This refers to how LLMs interact with the world using tools (i.e., tool use). The user can define the tool and configure the running of the tool. For example, it could be a “get weather” tool, which would require the user to give a location. From this, the LLM will provide feedback regarding the tool that will be used and then confirm the use. The tool could alternatively comprise a Structured Query Language (SQL) generation tool.

An issue arises with pipelining when multiple tools are used by the LLM as shown in FIG. 66C. This can cause significant delays as illustrated in FIG. 66D (e.g., 3 Seconds each time call the main LLM agent). Accordingly, to address this problem, an approach taken by the current system is to chain the tools together as illustrated in FIG. 66E. With this approach the two sections of query generation (first part-SQL query and second part-the SQL query is run against the database) are shown in a chained approach. This has resulted in a significant speed increase for the current model.

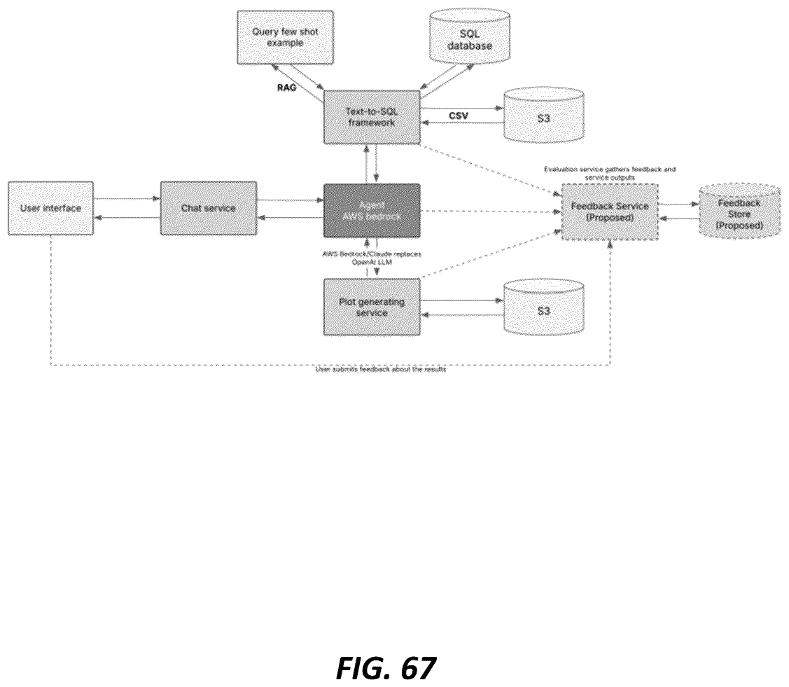

Referring now to FIG. 67, a block diagram is shown of the system for gathering the property information and modeling of property detections is depicted, which is suitable for implementing the above process illustrated in FIG. 66E.

Chat API. OpenAI is used to create a chatbot. The API key for OpenAI is generated with a proprietary service account. The Chat API follows the workflow to respond to user queries as described below.

The workflow comprises three primary tools: Txt-to-SQL, CSV generation, and Plot generation. One methodology involved four key steps: schema linking, classification/decomposition, SQL generation, and self-correction.

Referring to FIG. 66B, the problem of generating multiple bad SQLs was illustrated. In this case, a lag of 3 seconds may be experienced to fix each bad SQL (however, the delay could exceed 3 Secs.), where in this case, the process takes 15 seconds due to the bad SQLs.

In another implementation, the framework comprises three steps: schema linking, SQL generation, and self-correction. The self-correction step is only triggered when the initial

SQL query execution fails, so in many cases, the process involves only the first two steps. To enhance the accuracy of the framework, dynamic few-shot in-context learning has been integrated. This approach involves storing a small set of examples for schema linking and SQL generation in memory using FAISS. These examples are dynamically retrieved and injected into the prompt for each step, ensuring more precise and contextually relevant SQL generation.

To safeguard against potential prompt injection attacks (e.g., unauthorized DELETE or INSERT queries), the generated SQL queries are executed using a read-only account. This approach ensures that while the system generates queries dynamically, it adheres strictly to data access policies, maintaining the integrity and security of the database.

The CSV Generation process mirrors the Txt-to-SQL steps, with an additional operation where the Agent executes a tool to generate and store the CSV file in an S3 storage. Once the file is securely stored, the Agent provides the S3 storage location, enabling the frontend to generate a temporary uniform resource locator (URL) for customers to download the CSV file.

Plot Generation involves code generation. The Agent is tasked with generating Python code to create plots based on the data retrieved from the Txt-to-SQL framework. The Bokeh library is utilized for this purpose, as Bokeh supports both Python and JavaScript, making it highly versatile. The executed Python code produces Bokeh JavaScript Object Notation (JSON) data, which is then stored in the S3 storage. The frontend uses this JSON data to visualize the plots generated by the model, ensuring a seamless and interactive experience for the end user. All chat history and intermediate steps may be stored in a chat history storage.

Provisioning API. The provisioning API is designed to generate and refresh materialized views for specific client organizations. It follows a structured approach, generating a schema for each client organization using the naming convention genie_client_org_{client_org_id}. The materialized views are created based on data from the property_grade and partner_connect. In configuration, permit data is stored in these views. This API operates in the background, and progress is tracked and logged in an insurance_genie.provision_history table, ensuring that the state of the provisioning process is accurately recorded and can be monitored as needed. To enhance security, this endpoint uses a dedicated read-write account that is strictly reserved for this API. This approach is implemented to prevent any potential prompt injection attacks or other security threats via the chat API, ensuring that the integrity and security of the database are maintained.

Evaluation. The evaluation of the model primarily focuses on the accuracy of its text-to-SQL query generation. Given the high cost associated with using GPT models, this evaluation is conducted selectively. Specifically, it is only run manually when a new version of the model is ready for deployment.

The primary goal of this evaluation is to ensure that the accuracy of text-to-SQL query generation remains around 90%. This accuracy benchmark is crucial for maintaining the reliability of the system in providing correct and relevant data in response to user queries.

By limiting the frequency of these evaluations, operational costs are managed while still ensuring that each new deployment meets accuracy requirements. This approach allows for balancing cost-efficiency with performance reliability, ensuring that the model continues to deliver high-quality responses to users.

It should be noted that a User Interface (UI) is implemented for the Provisioning API that allows a user to interact with the provisioning API endpoint. This UI also includes functionality to monitor the status of the provisioning process, ensuring that users can easily track and manage the deployment of the model app. Additionally, a Cron job is used to periodically refresh the schema of existing client organizations. This ensures that the data remains up-to-date and accurate for all users. Still further, the model incorporates Hazard Hub data, which is essential for enhancing the app's functionality and providing more comprehensive property insights to users.

It is further contemplated that due to the accuracy of LLM's code generation, a plotting tool may be used instead of using code generation. An interface and functions that can be viewed as a dashboard based on useful questions or user-defined questions is provided.

Model Functional Requirements. It is contemplated that the model's functional requirements would include at least the following: 1. The system can query the database correctly and display results in the format of the user's choosing >95% of the time. 2. The system can uptake data from a carrier's underwriting rules and answer questions. 3. The system can display tabular data. 4. The system can generate CSV or other formats for user downloads. 5. The system can use a map plotting service to display: a) Points data, b) Aggregated cluster data, and c) Heatmaps. 6. The system can display data in charts: a) Bar charts/Stacked Bar, b) Pie Charts c) Whisker plots d) Line charts. 7. The system answers “I don't know the answer”, when it doesn't have the information to answer. 8. The system does not reveal any SQL code to users, no matter how hard they try to get it. 9. The system doesn't allow itself to get hijacked with ridiculous prompting. 10. The system can maintain a separation of customer data. This is partially done with individual customer databases. 11. The system can collect feedback loops (reports on good/bad answers): a) identifying who/when/what has been identified as a good/bad response, b) ability to fine-tune based on this feedback to minimize instances of bad answers. 12.

The system is consistent in its responses, (e.g., if ask the same question in two different chats on the same day, get the same data) and would include transparency to understand, for example, thresholds used by the system for providing an answer (e.g., the prompt, “how many properties include a significant amount of debris?” where the answer provided will depend on the threshold set by the system equating to “significant”). 13. Customer usage (of the customers who are allowed to use tools): a) Length of chat sessions before terminating. b) Number of inquiries it requires to give a user the answer(s) they're looking for. c) The frequency in which a user is using chat. 14. The number of repeat sessions per user (frequency metric).

Additionally, for continual improvement of the LLM, it is important to: 1) log all LLM chains, 2) find errors (or good examples) whether manually or LLM-as-a-judge, 3) add to the dataset, and 4) add to the prompt.

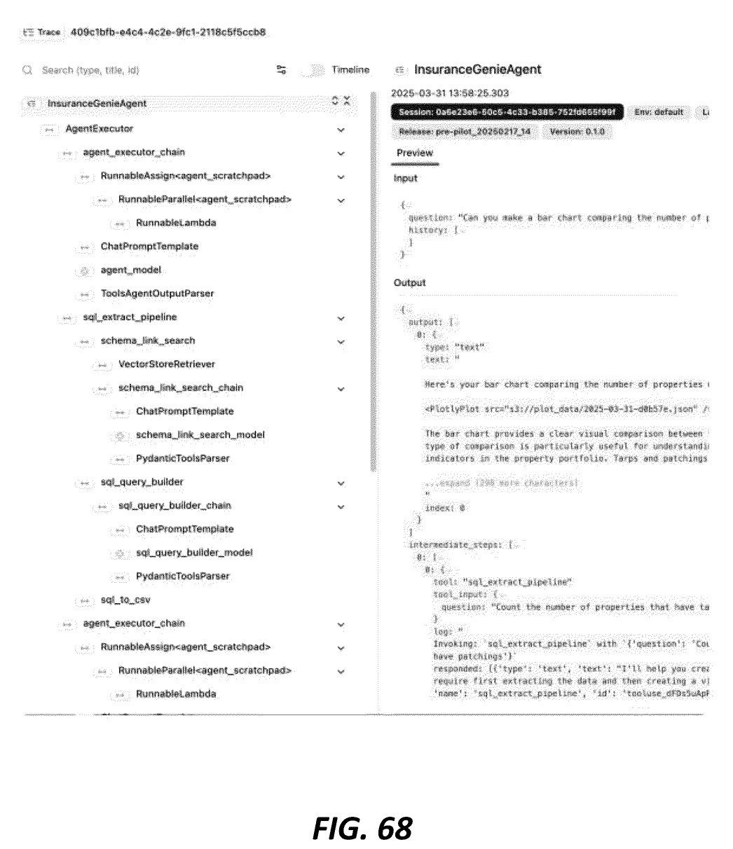

FIG. 68 illustrates the logging of LLM chains. As can be seen there are spans and traces and inputs and outputs for the spans and tracers. From this, in order to continually improve the LLM, it is important to find places where the LLM had a good result or errors. This could be done manually or by another LLM used to pull out those examples.

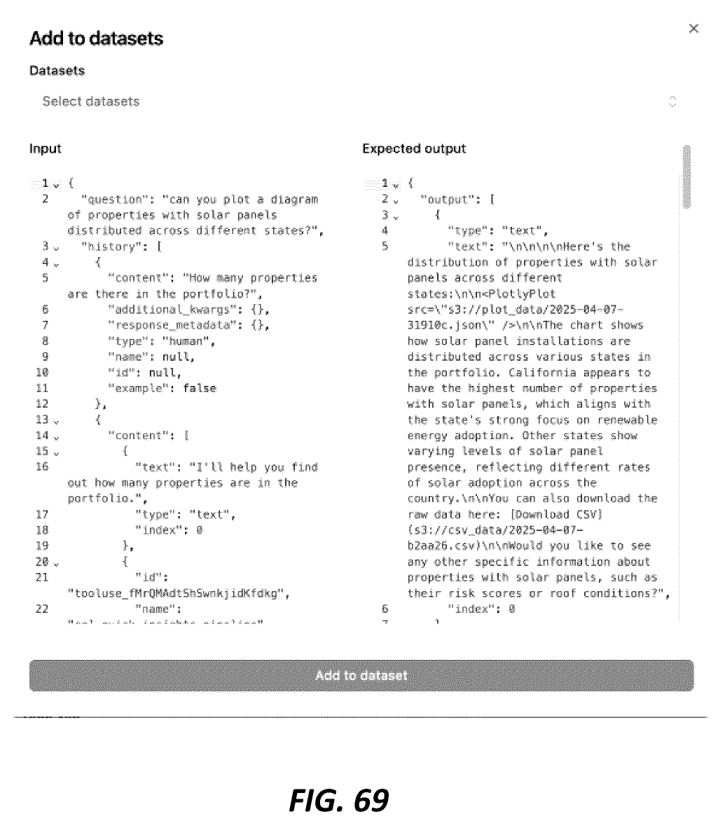

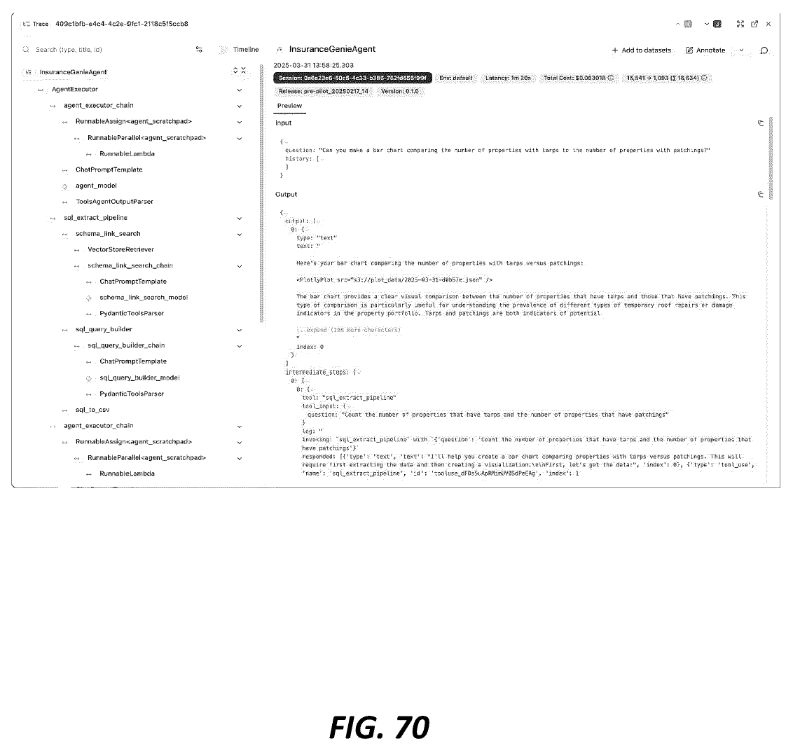

FIG. 69 illustrates adding a dataset where the feature facilitates saving a trace. Once a number of these are saved (e.g., these are good examples of what you should do if you get a particular type of query), they can be added to the prompt. This achieves the function of effectively having a data engine. Rather than just simply collecting data, particular examples are selected as good responses to further train the LLM in the direction it is desired to go.

For any LLM output, adding few-shot prompts can direct the LLM towards the desired outcome. More importantly, this enables the construction of an LLM Data Engine where real-world failure cases can be fixed and fed back into the system to solve future problems.

The model uses an LLM engineering platform (e.g., LangFuse) for observability and Amazon Web Services (AWS) Bedrock for storing prompts. This repo stores prompts in the assets directory and provides wrappers around the AWS Command Line Interface (CLI) to sync them to AWS Bedrock (see cli.py). Prompts should be formatted so that they can utilize few-shot examples. NOTE: the best practices for including few-shot examples may vary from model family (e.g. Claude vs OpenAI) to model family.

LangFuse provides a mechanism for managing datasets and adding individual spans to the dataset. A span contains an input and an output, which are added as the input and expected_output fields of the dataset item as illustrated in FIG. 70.

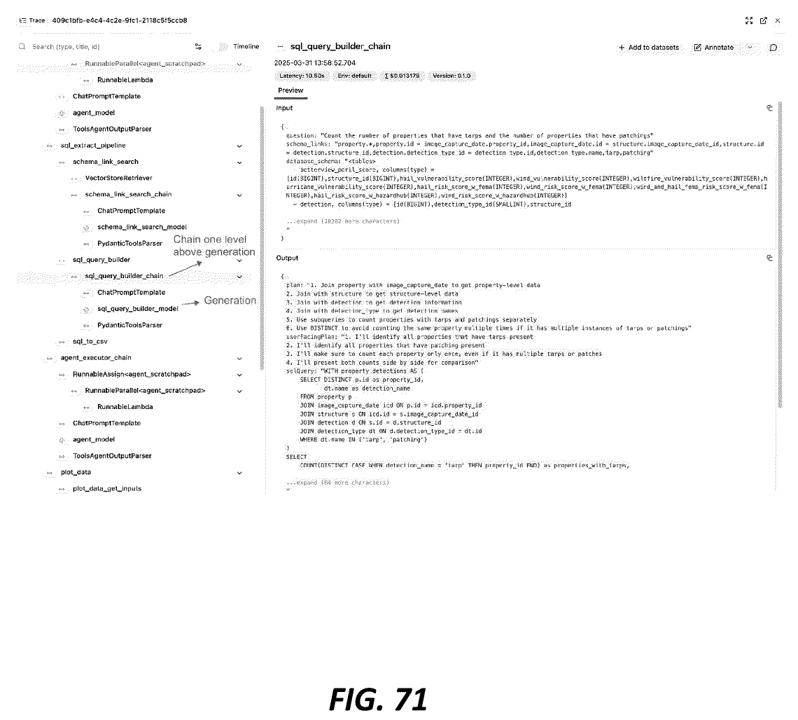

The values of the input and output will change depending on which span is selected. Determining the correct span to add to the dataset is based on the specific dataset. However, since the few shot examples are intended to show the LLM what sort of output it should generate for a given prompt, the spans one level above the Generation spans are often the correct ones to add. (FIG. 71).

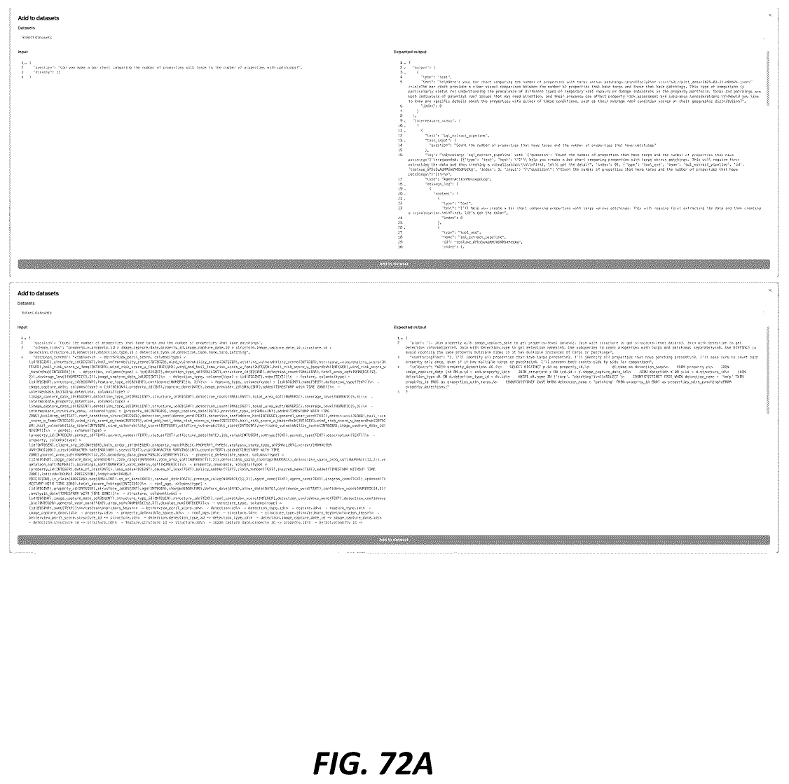

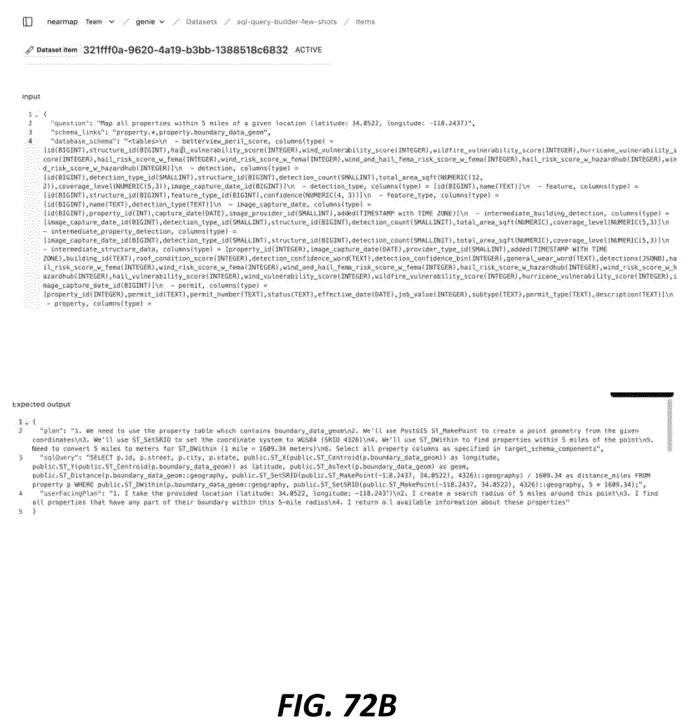

Clicking on the Add to datasets button allows adding the currently selected span to any datasets the user may specify. As noted, the final dataset item will vary based on which span is added. (FIG. 72A). Few-shot examples may need to be cycled in and out of datasets due to things like schema changes with the tool inputs or outputs. Furthermore, it is beneficial to add examples that the model originally got wrong to the few-shot examples. As such, the dataset items may need to be edited. Fortunately, this can be done directly via the LangFuse UI. (FIG. 72B).

The model code provides a Loader class (refer to the companion document) which facilitates pulling few-shot examples from the LangFuse Dataset. There may be more few-shot examples than are practical to include in the prompt, so a Retrieval-Augmented Generation (RAG) setup is used to retrieve the most relevant examples and add them to the prompt template. The current stage uses an in-memory vector store, but this can be extended to support external vector stores.

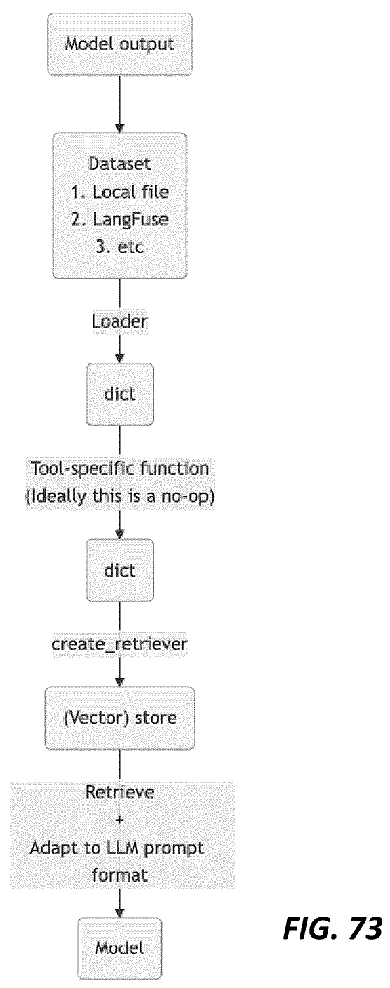

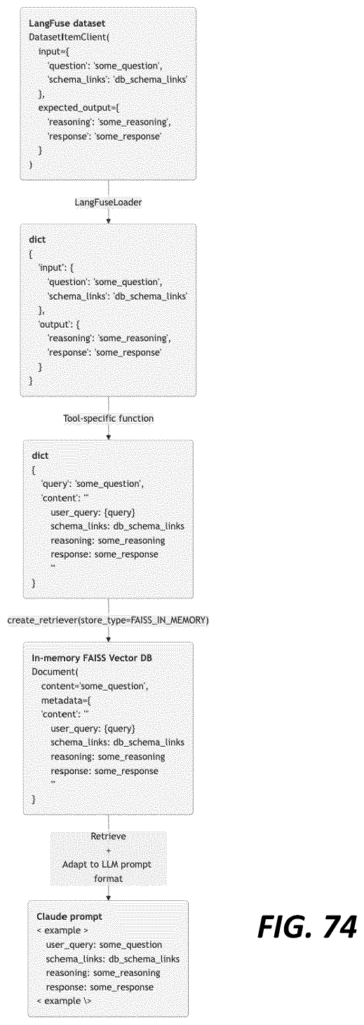

LangChain offers many vector store integrations, including AWS services like OpenSearch. The ETL process could be split out into its own set of scripts or a cron job to pre-load examples from the LangFuse dataset into the store. The AI model would have to be configured to connect appropriate partitions of the loaded examples in the store. Workflows for managing datasets and adding individual spans to the dataset are illustrated in FIGS. 73 & 74.

Explainability is also important for the LLM. It effectively allows the user to understand the criteria the LLM is using to make decisions. In the example of asking the LLM to list properties in a geographic area that have a “high fire risk”, the answer will depend on how the LLM determines what “high” means. This can be complicated because there are multiple criteria that need to be analyzed and then weighted to provide an answer. Transparency in the criteria will help to provide explainability. For example, in the high fire risk query, the model may be XML-tag based: <tool>Querying database<\tool> and <plan>I will find all properties with an RSI less than 50<\plan>. Outputs for plan and text are sequential. This reasoning could be provided in the chat window, or in a pane on the side, in a series of drop-down menus, or the like.

The following are various examples of queries that can be input into the model with various responses and outcomes.

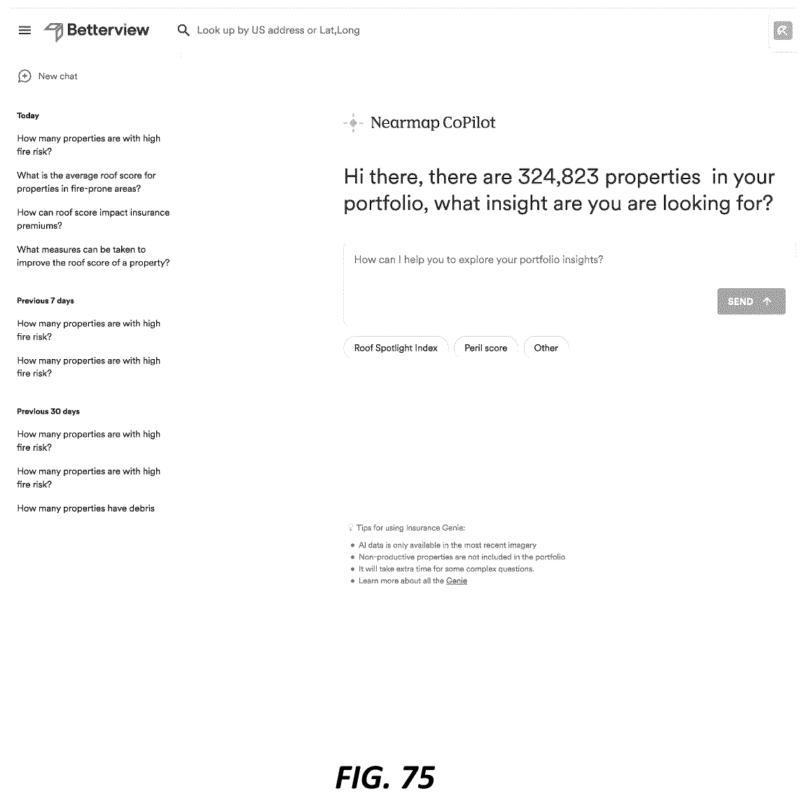

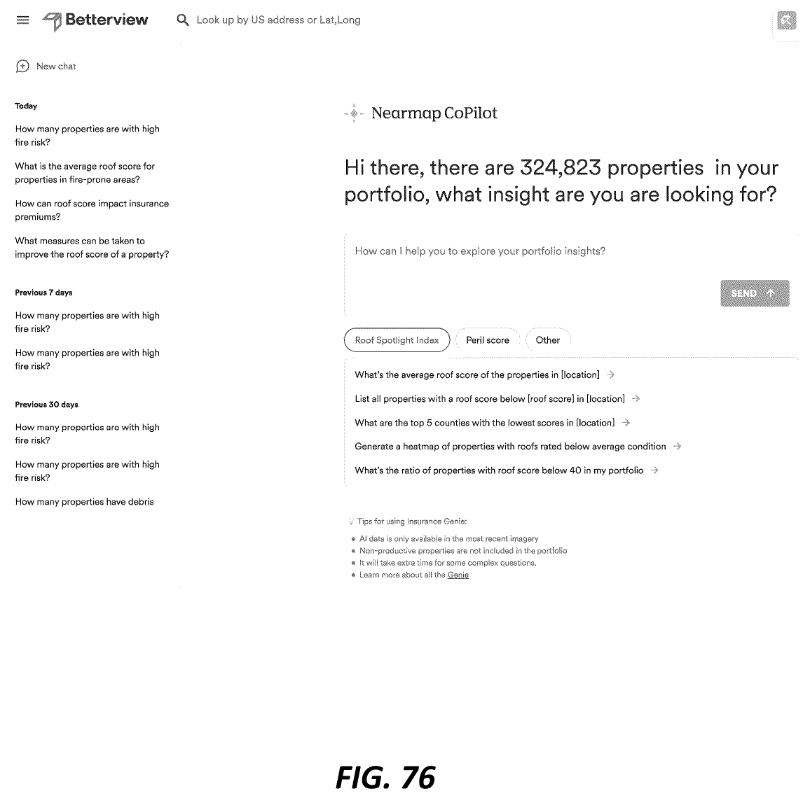

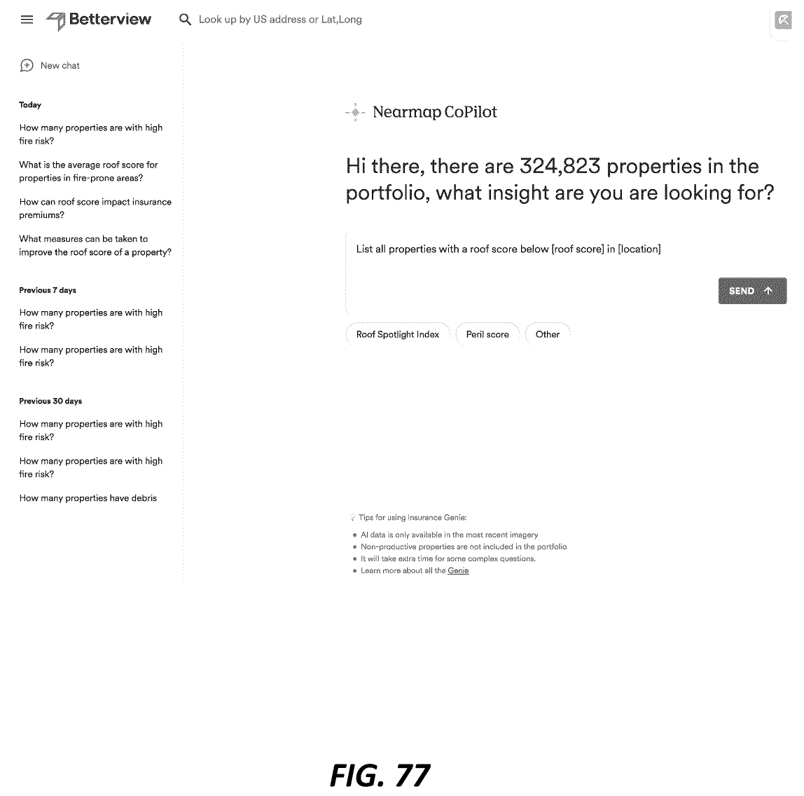

FIG. 75 comprises a landing page where the model highlights the number of properties in the portfolio and asks what insights the user is looking to obtain. There are several prelisted data categories the user could select including: “Roof Spotlight index”, Peril Score” and “Other”. FIG. 76 shows that the user has selected the “Roof Spotlight index”, which functions to preload a series of additional data categories as shown. FIG. 77 shows the user has now selected one of the additional data categories (e.g., “List all properties with a roof score below [roof score] in [location].

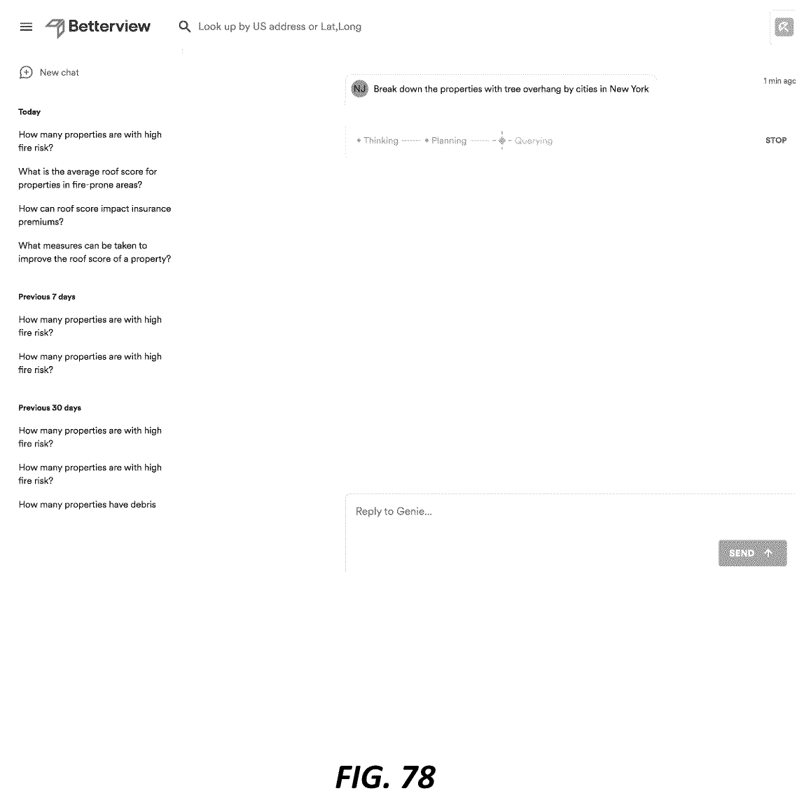

FIG. 78 illustrates a screen shot where the query “Break down the properties with tree overhang by cities in New York”. The AI model includes previous queries from “Today”, the “Previous 7 days” and “Previous 30 days” that can be selected by clicking on the preloaded query.

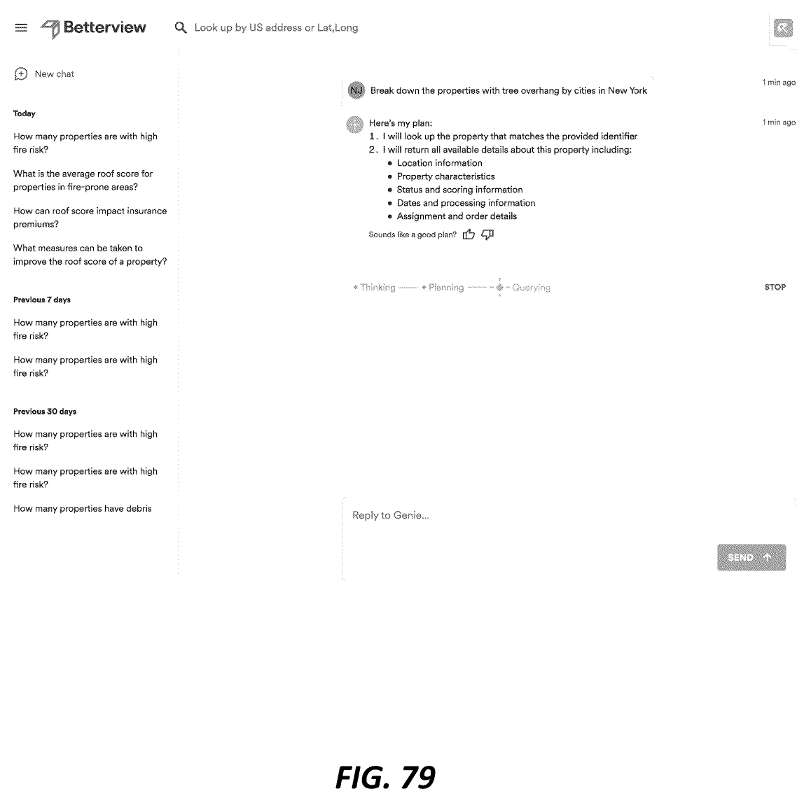

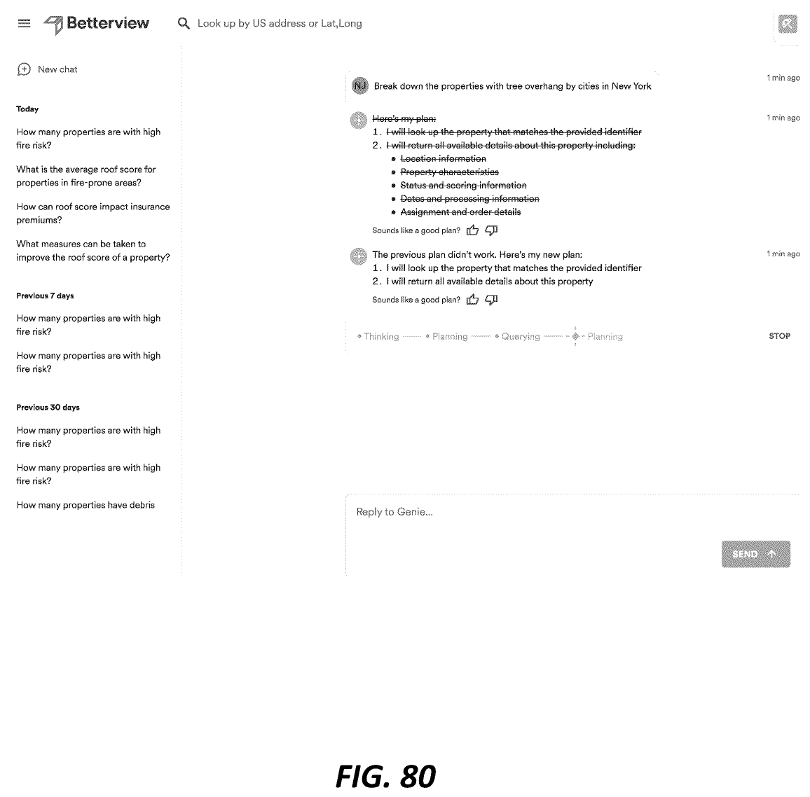

FIG. 79 illustrates a response where the model can provide a plan of how it will go about trying to provide an answer to the query presented in FIG. 78. FIG. 80 illustrates that the model communicates the previous plan did not work and a new plan is generated to obtain an answer to the query.

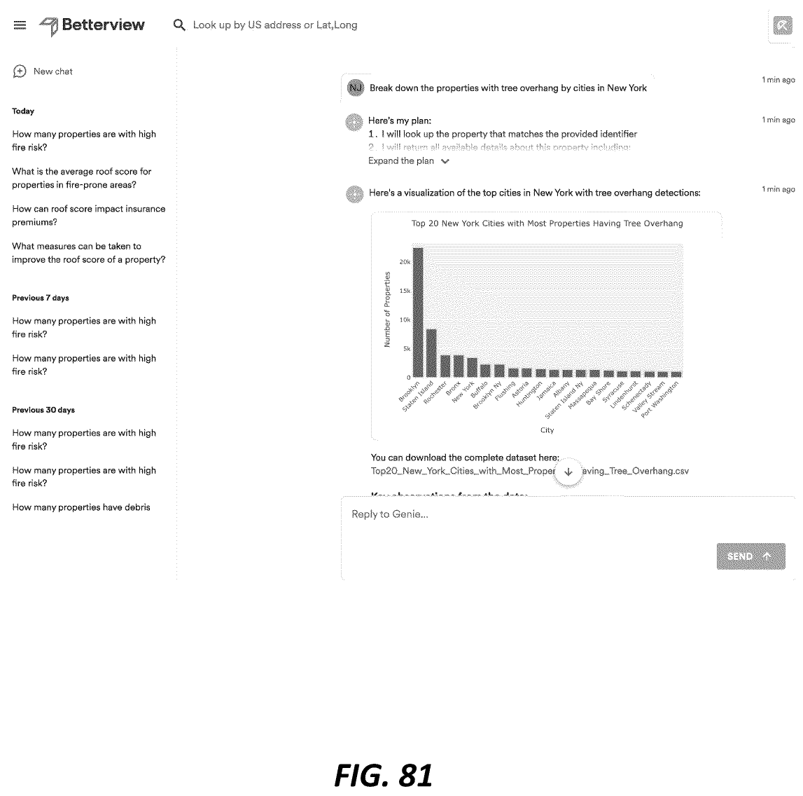

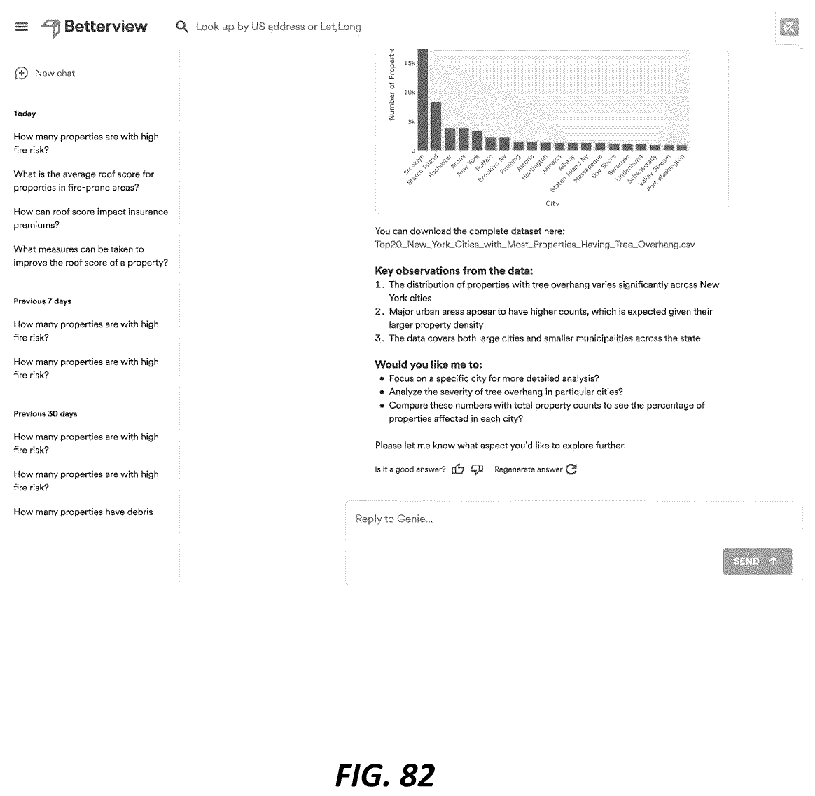

FIG. 81 illustrates a bar graph illustrating the Top 20 New York cities with most properties having tree-overhang listed by city from most (Brooklyn) to least (Port Washington) of the top 20. FIG. 82 provides additional information with key observations from the data. The model then presents additional questions for the user to consider relating to the data presented.

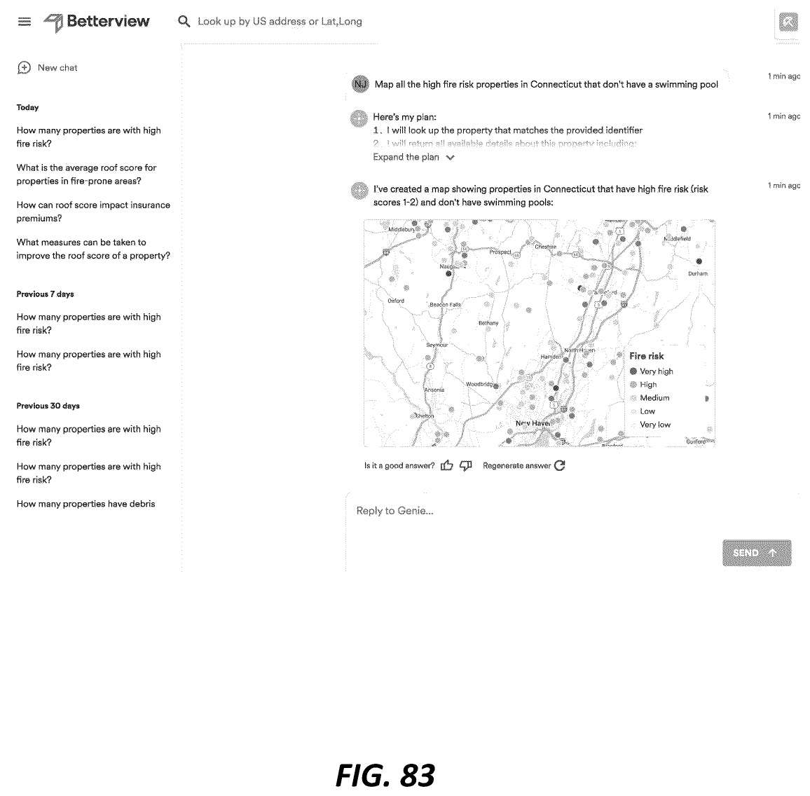

In another example, FIG. 83 shows an example of querying properties in

Connecticut with high fire risk that do not have a swimming pool. As can be seen, the AI model will present its plan and shows a plot illustrating all the locations that fit the criteria. In particular, the model allows for direct feedback, which can be used to help the LLM learn.

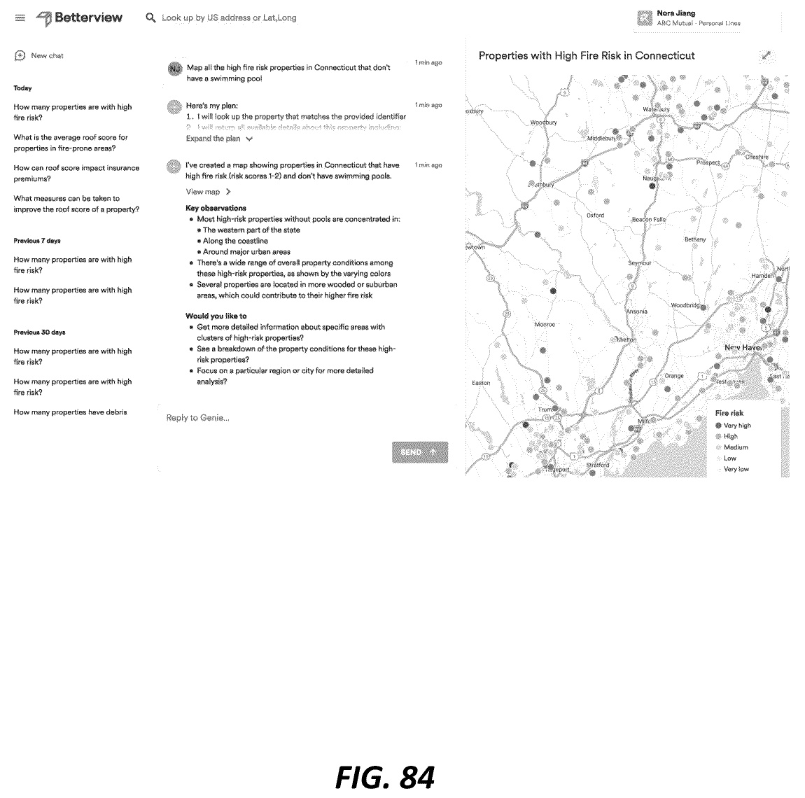

FIG. 84 shows the example from FIG. 83 with additional information relating to key observations and AI model then presents additional questions for the user to consider relating to the data presented.

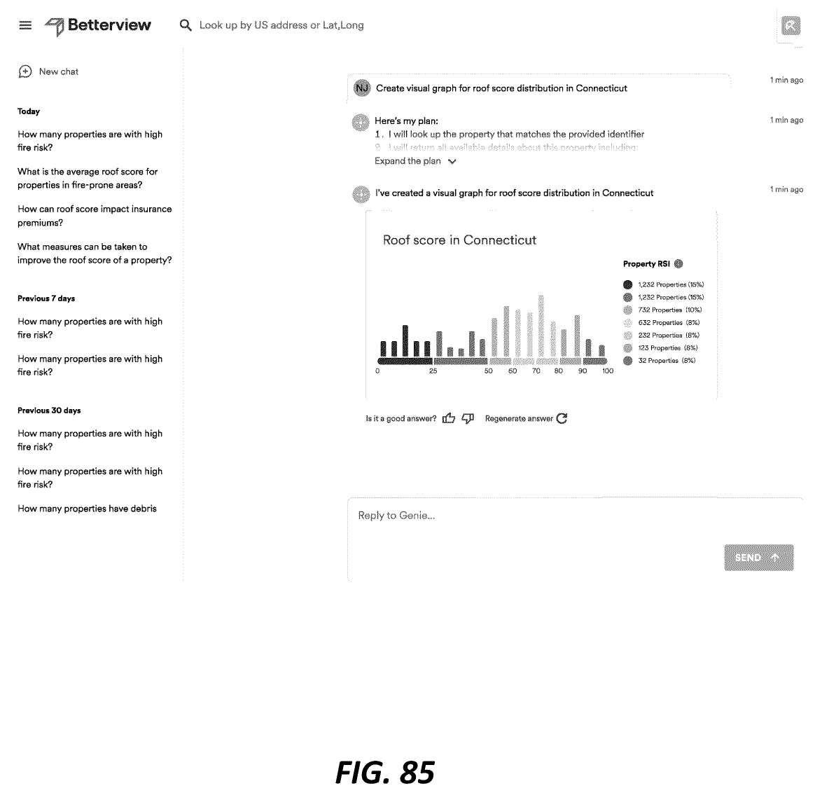

FIG. 85 shows a different query where the input query requests the model to create a visual graph for roof score distribution in Connecticut, which is depicted in the screen shot is various distributions broken down by category.

Model Database. The database for the model is built from a database with hierarchy (AI model+Ontology). The model may use an independent database or a previously created database. An independent database provides the following benefits:
A. Redundancy. Having a separate database means more reliability and safety.
B. Decoupling and isolation. Genie and BV operations will not affect each other.
C. Latency. DB will be in the same region and VPC peered, so networking will be optimized, minimizing the latency from the model backend app to DB.
D. Completeness. The backend app setup and deployment has been finalized and only component left is DB providing a quicker production time.
E. Clear separation of domains and responsibilities. AIPE team will own and operate the model stack and be responsible for ensuring up time.
F. Scalability. An independent database can be scaled according to the model's specific needs without negatively impacting the database.
G. Optimized performance. Database configuration can be specifically tuned for the model's query patterns.
H. Security isolation. Having a separate database creates stronger security boundaries, limiting potential attack surfaces.

Prompt Catalog. In the existing applications, prompts were embedded directly within the code. This approach posed several challenges:
Difficult Sharing: Since the prompts were tied to the codebase, it would not facilitate re-use and consistency of common prompts across different apps.
Limited Version Tracking: While prompt changes were tracked in Git, this method only captured the code-level changes, not allowing for an efficient comparison between different versions of prompts.
Lack of Flexibility: Changes to prompts were not easily isolated, and there was no. central repository to manage them independently.

To address these issues, the current model separates the prompts from the code and implements a Prompt Catalog as a central store. The new approach offers several benefits:
Versioning: Prompts will now be versioned individually, allowing us to track and compare changes between different versions of the same prompt easily.
Centralized Storage: The Prompt Catalog will serve as a single source of truth for all prompts, making it easier to manage, share, and retrieve prompts across different parts of the application
Improved Collaboration: With prompts stored independently, sharing them with other teams or environments becomes simpler and more efficient.

By centralizing prompts in the Prompt Catalog, streamlining can be achieved for management of prompt versions, improve collaboration, and ensure better control over prompt updates across the model. Langfuse was selected and offers a good user experience in managing prompts through their UI alongside its observability features.

While the present disclosure has been described with reference to one or more exemplary embodiments, it will be understood by those skilled in the art that various changes may be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method of generating semantic predictions corresponding to pixels of an input image, executing on a computer having a network connection, the method comprising the steps of:
providing a first Convolutional Neural Network (CNN) by:
selecting a sampling factor, s,
defining a mask that corresponds to a grid of pixels positioned s pixels apart from each other and centered on a single pixel of the grid of pixels,
defining an input image crop size based on the extent of the mask,
defining a first CNN that processes image data shaped according to the input image crop to generate semantic predictions for pixels corresponding to the grid of pixel locations of the mask,
receiving a training image comprising image pixels,
generating a training image crop according to the input image crop size,
receiving target semantic labels for the training image,
generating a grid of target semantic labels for the training image crop corresponding to the grid of pixels of the mask,
processing, using the first CNN, the training image crop to generate a grid of output semantic predictions for the training image crop corresponding to the mask pixels of the training image crop,
determining a difference between the target semantic labels and the output semantic predictions, and
adjusting parameters of the first CNN to reduce a difference between the target semantic labels and the output semantic predictions,
providing a second CNN according to weight tensors and an architecture of the first CNN, the second CNN including modified convolution layers, wherein a last convolution layer has a stride that is reduced by dividing a scaling factor f, and all convolution layers after the last convolution layer are dilated by multiplying the scaling factor f,
receiving with the second CNN the input image that comprises pixels, and
generating with the second CNN semantic predictions for the input image that is at a higher pixel density than the mask.

2. The method of claim 1, wherein the last convolution layer has a stride that is 2, the method further comprising the step of reducing the stride of the last convolution layer to 1.

3. The method of claim 2, further comprising the step of selecting an input image crop size of the input image that is a multiple of the sampling factor, s plus 1.

4. The method of claim 1, wherein the second CNN is trained to generate unnormalized logit scores as the output.

5. The method of claim 4, further comprising the steps of:
training the first CNN by learning a coefficient of a linear function that scales the logit output of the first CNN using a target mask; and
adding a linear scaling layer to the end of the first CNN where the coefficient of the linear scaling layer is set to a coefficient of the second CNN.

6. The method of claim 5, wherein the target mask only contains known values for a reduced pixel density grid of locations, and the input image crop has a location that is selected to maximally align an output mask with known values in the target mask.

7. The method of claim 6, wherein the second CNN comprises a calibration model, the method further comprising the steps of:
training the first CNN at a first resolution;
reducing the resolution of input images to the first CNN by down sampling the images at the first resolution;
training a second CNN using the down sampled images;
generating a hybrid resolution model by combining first resolution and reduced resolution feature maps;
wherein the first resolution feature map is generated by processing the image at the first resolution and the reduced resolution feature map is generated by processing a down sampled version of the image; and
training at least an additional learnable function to generate logit scores from the combined feature maps.

8. The method of claim 7, wherein the pixel density of first resolution model and the reduced-resolution model is increased to generate feature maps at a higher pixel density.

9. The method of claim 8, wherein the reduced-resolution feature map is up-sampled so that alignment of first resolution and reduced resolution feature maps is maintained.

10. A system for generating semantic predictions corresponding to pixels of an input image, executing on a computer having a network connection, comprising:
a computer having a network connection, the computer having software executing thereon adapted to:
provide a first Convolutional Neural Network (CNN) by:
selecting a sampling factor, s,
defining a mask that corresponds to a grid of pixels positioned s pixels apart from each other and centered on a single pixel of the grid of pixels,
defining an input image crop size based on the extent of the mask,
defining a first CNN that processes image data shaped according to the input image crop to generate semantic predictions for pixels corresponding to the grid of pixel locations of the mask,
receiving a training image comprising image pixels,
generating a training image crop according to the input image crop size,
receiving target semantic labels for the training image,
generating a grid of target semantic labels for the training image crop corresponding to the grid of pixels of the mask,
processing, using the first CNN, the training image crop to generate a grid of output semantic predictions for the training image crop corresponding to the mask pixels of the training image crop,
determining a difference between the target semantic labels and the output semantic predictions, and
adjusting parameters of the first CNN to reduce a difference between the target semantic labels and the output semantic predictions,
provide a second CNN according to weight tensors and an architecture of the first CNN, the second CNN including modified convolution layers, wherein the convolution layers has a last convolution layer and the last convolution layer has a stride that is reduced by dividing a scaling factor f, and all convolution layers after the last convolution layer are dilated by multiplying the scaling factor f,
said software receiving with the second CNN the input image that comprises pixels, and
said software generating with the second CNN semantic predictions for the input image that is at a higher pixel density than the mask.

11. The system of claim 10, wherein the last convolution layer has a stride that is 2, wherein said software is adapted to reduce the stride of the last convolution layer to 1.

12. The system of claim 11, wherein said software is adapted to select an input image crop size of the input image that is a multiple of the sampling factor, s plus 1.

13. The system of claim 10, wherein the second CNN is trained to generate unnormalized logit scores as the output.

14. The system of claim 4, wherein said software is adapted to:
train the first CNN by learning a coefficient of a linear function that scales the logit output of the first CNN using a target mask; and
add a linear scaling layer to the end of the first CNN where the coefficient of the linear scaling layer is set to a coefficient of the second CNN.

15. The system of claim 14, wherein the target mask only contains known values for a reduced pixel density grid of locations, and wherein the input image crop has a location that is selected to maximally align an output mask with known values in the target mask.

16. The system of claim 15, wherein the second CNN comprises a calibration model, said software is adapted to:
train the first CNN at a first resolution;
reduce the resolution of input images to the first CNN by down sampling the images at the first resolution;
train a second CNN using the down sampled images;
generate a hybrid resolution model by combining first resolution and reduced resolution feature maps;
wherein the first resolution feature map is generated by processing the image at the first resolution and the reduced resolution feature map is generated by processing a down sampled version of the image; and
train at least an additional learnable function to generate logit scores from the combined feature maps.

17. The system of claim 16, wherein the pixel density of first resolution model and the reduced-resolution model are increased to generate feature maps at a higher pixel density.

18. The system of claim 17, wherein the reduced-resolution feature map is up-sampled so that alignment of first resolution and reduced resolution feature maps is maintained.
